(19) United States
(12) Patent Application Publication
(10) Pub. No.: US 2006/0282288 A1
(43) Pub. Date: Dec. 14, 2006

(54) Methods of providing a patient with aesthetic improvement procedures

(75) Inventors: Michael S. Rodriguez, New York, NY (US); Richard Rakowski, West Palm Beach, FL (US); Kelly Charron, Boynton Beach, FL (US)

Correspondence Address: PATTON BOGGS LLP, 8484 WESTPARK DRIVE, SUITE 900, MCLEAN, VA, 22102, US

(73) Assignee: Klinger Advanced Aesthetics, Inc., Norwalk, CT (US)

(21) Appl. No.: 11/443,102

(22) Filed: May 31, 2006

Related U.S. Application Data
(63) Continuation-in-part of application No. 10/863,856, filed on Jun. 8, 2004.
(60) Provisional application No. 60/533,731, filed on Dec. 31, 2003.
(60) Provisional application No. 60/778,899, filed on Mar. 6, 2006.
(60) Provisional application No. 60/795,156, filed on Apr. 27, 2006.

(51) Int. Cl. G06Q 10/00; G07G 1/00; G06Q 50/00

(52) U.S. Cl. 705/2; 705/10

(57) ABSTRACT

The invention relates to methods of providing a patient with aesthetic improvement procedures having two consultations. Aesthetic improvement information is obtained from the patient. Individual providers of aesthetic improvements are consulted a first time. A second consultation is conducted with multiple of the aesthetic improvement providers to provide an aesthetic improvement plan having recommendations that the are compatible with one another. The methods may also include adding the assessment and the results to a dynamic database. The methods may also include performing second diagnostic tests on the aesthetics of the patient after performing the aesthetic improvement procedure, performing a second consultation with the individual provider, the individual provider supplying an assessment of the results of the improvement procedure, and adding the assessment and the results to a dynamic database.

This application is a continuation-in-part of application Ser. No. 10/863,856, filed Jun. 8, 2004, which claims the benefit of U.S. Provisional Application No. 60/553,731 filed Dec. 31, 2003. This application also claims the benefit of U.S. Provisional Application No. 60/795,156, filed Apr. 27, 2006, and U.S. Provisional Application No. not yet assigned, filed Mar. 6, 2006.

### FIELD OF THE INVENTION

The present invention generally relates to systems and methods for measuring and improving the aesthetics of a user's appearance (i.e., the level or degree of beauty or attractiveness of a user's face and body).

### BACKGROUND DESCRIPTION

Under current market practice, a user who desires to improve their physical appearance can do so only in a fragmented and step-by-step manner. Current market practice involves specific (appearance improvement) domain providers (e.g., hair stylists, hair colorists, makeup artists, aestheticians, plastic surgeons, cosmetic dermatologists and cosmetic dentists) who are capable of providing aesthetic improvement services only in their own areas of expertise and have little or no knowledge of the other (highly interdependent) domains in the aesthetics arena, and as such are not able to provide an integrated plan or capability to optimize a user's appearance improvement. By way of example, if a user desires to understand how to optimally maximize their physical appearance, they may be required to consult with, among others, a plastic surgeon, a hair stylist, a nail technician, and a make-up artist. Each of these providers is likely to have different overall view of how that user should look both within and outside their areas of expertise. As a result, the user is faced with having to interpret each of these differing views.

Furthermore, in the current marketplace, user and appearance improvement providers can assess the results of an aesthetic improvement procedure only by subjective methods. In other words, the process of assessing what should be done to improve a user's appearance is driven by the provider rather than the user. In sum, the current market practice is fragmented, subjective and driven by the provider.

Additionally, in the current market practice, cosmetic dermatology procedures are conducted without the use of needed standardized information for providers to be able to assess and repeat the procedures and/or the aesthetic improvement results they are intended to create.

Analysis of the aesthetics market shows that consumers desire an aesthetic platform that delivers measurable benefits from use of a product brand, an end-to-end convenient delivery system for aesthetic procedures, medical grade skin care products, peace of mind about the quality and safety of services and product, and a facility that combines high quality procedures, professionals and client service and care. There was not, however, such an aesthetic platform on the market. There is therefore a need for a new business model specifically developed for the user aesthetics improvement market that addresses the objectivity, i.e., “measurability” of appearance improvement and provides a holistic solution for the integration of disparate domains. The inventors therefore created an aesthetic procedure plan that is supported by documented protocols to delivery high differentiated processes that the inventors believe delivers consistent quality, superior results, safety, and high level of client experience.

### SUMMARY OF THE INVENTION

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

An embodiment of the present invention provides a method of providing a patient with an aesthetic improvement procedure comprising obtaining information from the patient regarding the aesthetic improvements desired by the patient; performing first consultations with individual providers of aesthetic improvements for recommendations; performing at least one second consultation with a plurality of the individual providers; and developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another.

Another embodiment of the present invention provides a method of aesthetic improvement comprising obtaining patient information regarding desired aesthetic improvements; performing first consultations with individual providers of aesthetic improvements for recommendations; performing at least one second consultation with a plurality of the individual providers; and developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another; consulting an aesthetic improvement provider for recommendations; performing diagnostic tests on the patient; choosing at least one aesthetic improvement procedure; performing the aesthetic improvement procedure; assessing the results of the aesthetic improvements in an integrated and objective manner; and adding the assessment and the results to a dynamic database, wherein the dynamic database is updated as new data is generated.

Another embodiment of the present invention provides a method of improving the aesthetics of a patient comprising obtaining patient information from a patient survey; performing first diagnostic tests on the aesthetics of the patient; performing a first consultation with at least one individual provider of aesthetic improvement; performing at least one second consultation with a plurality of the individual providers; developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another; consulting a database which analyzes the results of the first diagnostic test in an integrated and objective manner; providing at least one aesthetic improvement procedure; performing the aesthetic improvement procedure; performing second diagnostic tests on the aesthetics of the patient after performing the aesthetic improvement procedure; performing a second third consultation with the individual provider, the individual provider supplying an assessment of the results of the improvement procedure; and adding the assessment and the results to a dynamic database, wherein the dynamic database is updated as new data is generated.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates an embodiment of the invention in which a user consults with a concierge;

FIG. 2 illustrates an aspect of the invention namely, the integrated consultation process;

FIG. 3 illustrates an embodiment of the invention in which a user obtains a comprehensive diagnostic analysis;

FIG. 4 illustrates an embodiment of the invention using a retrospective outcomes approach;

FIG. 5 illustrates an embodiment of the invention using a prospective outcomes approach;

FIG. 6 illustrates an embodiment of the invention using a procedure to create repeatable results in cosmetic dermatology delivery services; and

FIG. 7 illustrates an embodiment of the invention demonstrating the consistency and repeatability of a cosmetic dermatology procedure.

FIG. 8 is a flow diagram of a method according to an embodiment of the invention.

FIG. 9A is a flow diagram of an embodiment of the invention, the aesthetic procedure.

FIG. 9B is another portion of the flow diagram of the embodiment of the invention illustrated in FIG. 9A.

FIG. 10A is a portion of a flow diagram of another embodiment of the invention, the aesthetic procedure.

FIG. 10B is another portion of the flow diagram of the embodiment of the invention illustrated in FIG. 10A.

FIG. 11A is a flow diagram of another embodiment of the invention, aesthetic procedure with client adding services during appointment.

FIG. 11B is another portion of the flow diagram of the embodiment of the invention illustrated in FIG. 11A.

FIG. 11C is another portion of the flow diagram of the embodiment of the invention illustrated in FIG. 11B.

FIG. 12 is a flow diagram of another embodiment of the invention.

FIG. 13A is a portion of a flow diagram of another embodiment of the invention, a facial.

FIG. 13B is another portion of the flow diagram of the embodiment of the invention illustrated in FIG. 13A.

FIG. 14 illustrates one method by which a face may be broken into zones by an electronic mask.

FIG. 15 illustrates one method by which a face may be broken into zones by an electronic mask.

FIG. 16 illustrates one method by which a face may be broken into zones by an electronic mask.

FIG. 17 illustrates one method by which a face may be broken into zones by an electronic mask.

FIG. 18 illustrates one possible layout of treatment rooms of a business location.

FIG. 19 illustrates a graphical user interface of a software system used to analyze a client Skin State and smile.

FIG. 20 illustrates a portion of the graphical user interface of the software system of FIG. 19, instructions for the client.

FIG. 21 illustrates a portion of the graphical user interface of the software system of FIG. 19, client survey.

FIG. 22 illustrates a portion of the graphical user interface of the software system of FIG. 19, client survey.

FIG. 23 illustrates a portion of the graphical user interface of the software system of FIG. 19, summary of parameters to be measured.

FIG. 24 illustrates a portion of the graphical user interface of the software system of FIG. 19, skin sebum measurement.

FIG. 25 illustrates a portion of the graphical user interface of the software system of FIG. 19, skin sebum measurement.

FIG. 26 illustrates a portion of the graphical user interface of the software system of FIG. 19, skin elasticity.

FIG. 27 illustrates a portion of the graphical user interface of the software system of FIG. 19, skin elasticity.

FIG. 28 illustrates a portion of the graphical user interface of the software system of FIG. 19, client average elasticity score.

FIG. 29 illustrates a portion of the graphical user interface of the software system of FIG. 19, skin hydration.

FIG. 30 illustrates a portion of the graphical user interface of the software system of FIG. 19, skin hydration.

FIG. 31 illustrates a portion of the graphical user interface of the software system of FIG. 19, client average hydration score.

FIG. 32 illustrates a portion of the graphical user interface of the software system of FIG. 19, client photograph instructions.

FIG. 33 illustrates a portion of the graphical user interface of the software system of FIG. 19, client instructions.

FIG. 34 illustrates a portion of the graphical user interface of the software system of FIG. 19, parameters to be measured.

FIG. 35 illustrates a portion of the graphical user interface of the software system of FIG. 19, UV spot results.

FIG. 36 illustrates a portion of the graphical user interface of the software system of FIG. 19, client instructions for tooth whiteness analysis.

FIG. 37 illustrates a portion of the graphical user interface of the software system of FIG. 19, tooth whiteness measurement.

FIG. 38 illustrates a portion of the graphical user interface of the software system of FIG. 19, tooth whiteness measurement.

FIG. 39 illustrates a portion of the graphical user interface of the software system of FIG. 19, client average tooth whiteness score.

FIG. 40A-C illustrates a portion of the graphical user interface of the software system of FIG. 19, total client results.

FIG. 41 illustrates the graphical user interface of a software system to assist the client in determining ideal eyebrow shape and color.

FIG. 42 illustrates a portion of the graphical user interface of the software system of FIG. 41, current client eyebrows.

FIG. 43 illustrates a portion of the graphical user interface of the software system of FIG. 41, eyebrow style.

FIG. 44 illustrates a portion of the graphical user interface of the software system of FIG. 41, eyebrow style.

FIG. 45 illustrates a portion of the graphical user interface of the software system of FIG. 41, eyebrow style.

FIG. 46 illustrates a graphical user interface of a software system to assist the client in finding the ideal tooth shade.

FIG. 47 illustrates a portion of the graphical user interface of the software system of FIG. 46, desired tooth shade.

FIG. 48 illustrates a portion of the graphical user interface of the software system of FIG. 46, before and after tooth shade.

FIG. 49 illustrates a portion of the graphical user interface of the software system of FIG. 46, tooth-whitening recommendations.

FIG. 50 illustrates a graphical user interface of a software system viewed through the client portal.

FIG. 51 illustrates a portion of the graphical user interface of the software system of FIG. 50, login page.

FIG. 52 illustrates a portion of the graphical user interface of the software system of FIG. 50, client appointment times.

FIG. 53 illustrates a portion of the graphical user interface of the software system of FIG. 50, client lookup.

FIG. 54 illustrates a portion of the graphical user interface of the software system of FIG. 50, client information and itinerary.

FIG. 55 illustrates a portion of the graphical user interface of the software system of FIG. 50, client history.

FIG. 56 illustrates a portion of the graphical user interface of the software system of FIG. 50, client photos.

FIG. 57 illustrates a portion of the graphical user interface of the software system of FIG. 50, product recommendations.

FIG. 58 illustrates a portion of the graphical user interface of the software system of FIG. 50, client consent forms.

FIG. 59 illustrates a portion of the graphical user interface of the software system of FIG. 50, client consent form.

FIG. 60 illustrates a portion of the graphical user interface of the software system of FIG. 50, client photo session.

FIG. 61 illustrates a portion of the graphical user interface of the software syster of FIG. 50, client photograph morphing.

FIG. 62 illustrates a portion of the graphical user interface of the software system of FIG. 50, client photographs.

FIG. 63 shows a process for a skin state evaluation.

FIG. 64 shows a process for a nurse practitioner evaluation.

FIG. 65 shows a process for treatment documentation.

FIG. 66 shows a system for spa treatments, such as, but not limited to facials, waxing and massages.

FIG. 67 shows a brow shaper process.

FIG. 68 shows a screenshot of an administrative home.

FIG. 69 shows a screenshot of a location search list that may include store number, district, region and state location details to search under.

FIG. 70 shows a screen shot of a location detail.

FIG. 71 shows a screenshot of a client search list.

FIG. 72 shows a screenshot of a client detail page.

FIG. 73 shows a screenshot of a client analysis detail.

FIG. 74 shows a screenshot of a product search list.

FIG. 75 shows a screenshot of a product detail.

FIG. 76 shows a screenshot of a user search list.

FIG. 77 shows a screenshot of a user detail.

FIG. 78 is a schematic of a preferred infrastructure setup.

### DESCRIPTION OF EXEMPLARY EMBODIMENTS

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above. Reference will now be made in detail to the invention, examples of which are illustrated in the accompanying drawings.

Historically, there has been a belief on the part of both users and providers of aesthetic improvement services that an assessment of an individual's physical appearance is more subjective, i.e., in the eye of the beholder, rather than objective, i.e., quantifiable by measurable data. In an exemplary embodiment of the invention, a process for evaluating an aesthetic improvement by objective standards is provided. This embodiment serves to move the evaluation of “beauty” from the realm of the subjective more towards the objective and permits the quantifiable assessment of both a user's pre-procedure appearance and the improvement of the user's appearance following one or more aesthetic improvement procedures.

As used herein, the term “aesthetic improvement” or “aesthetic improvement procedure” involves the influence, involvement and integration of nine key contributing user face and body appearance improvement domains namely:

Plastic surgery for facial and body improvements that remove, change or influence an aesthetic issue (e.g., unattractive facial or body feature) or enhance skin quality or enhance an existing facial or body feature;

Cosmetic dermatology for skin-related improvements to either remove, change or influence an aesthetic issue (e.g., unattractive facial or body feature) or enhance skin quality or enhance an existing facial or body feature;

Cosmetic dentistry for smile-related improvements that focus on the color, structure and symmetry of a user's teeth;

Hair styling for the improvement of a user's hair style (specifically the shape, length and degree of curliness/straightness) as it relates to a user's face and body shape and color;

Hair coloring for the change or improvement of a user's hair color (specifically covering age-related grayness, providing enhanced facial appearance with a color change or using highlights to improve a user's overall facial appearance);

Facial aesthetics for the improvement of non-medical facial related issues, e.g., eye brow shaping, facial treatments, facial hair removal and blackhead removal;

Makeup artistry for facial and body improvements to either remove, change or influence an aesthetic issue (e.g., unattractive facial or body feature) or enhance an existing facial or body feature through the most effective use application, or matching coloration of, foundations, mascara, lipstick, and other forms of makeup;

Fashion and eyewear consultation for optimizing a user's appearance by selecting ideal materials, colors and shapes of clothes and eyewear for their specific (skin, eye or hair) coloring and body and face shape; and

Nail care for optimizing the appearance of a user's feet and hands by lengthening, cutting, shaping and coloring the nails on a user's hands and feet.

Body treatments, such as massage, body wraps, body scrubs, and body masks.

An aspect of the invention is to provide a user with the ability to objectively measure the results of one or more specific aesthetic improvement procedures. An exemplary embodiment of the invention provides one or more methods of measuring the outcome, i.e., results of an aesthetic improvement procedure.

As used herein, the term “user” refers to an individual who is interested in having one or more aesthetic improvement procedures performed on their face, body or both. The term “user” is also intended to refer to an individual who is the recipient of one or more aesthetic improvement procedures. The terms “user,” “consumer,” “patient,” and “client” have been used interchangeably herein.

As used herein, the term “outcome” can be divided into two segmentations. First, a retrospective outcome involves informing a user of their specific outcome as a result of a completed aesthetic improvement procedure. Second, a predictive/prospective outcome, which involves informing a user of the outcome they can individually and specifically expect in advance of a procedure being performed on them.

An embodiment of the invention provides a method of measuring an outcome of an aesthetic improvement procedure retrospectively, wherein one or more aesthetic improvement procedures are performed on a user followed by a comparison of the user's appearance after the performance of the one or more procedures to the user's appearance before the performance of any procedure. User appearance, both before and after the performance of one or more aesthetic improvement procedures is assessed by using one or more user appearance assessment tools.

Another embodiment of the invention provides a method of measuring an outcome of an aesthetic improvement procedure prospectively, wherein a user who is desirous of undergoing one or more aesthetic improvement procedures, engages in one or more consultations with a concierge, diagnostician, nurse practitioner, aesthetician, or other following which, one or more aesthetic improvement procedures are recommended to the user. The user is further provided with a predicted appearance outcome for the specific aesthetic improvement procedures recommended to the user. This predicted outcome is based on appearance improvement data collected for prior users, as stored in a population's outcome database, which have undergone the specific or substantially similar procedures desired by the present user.

An exemplary embodiment of the invention provides an objective and standardized framework for outcome measurement to the aesthetics improvement market. Another aspect of the invention is to provide improved levels of comfort, safety and peace of mind to a user before, during and following the administration of an aesthetic improvement procedure, compared to current market practice.

Another aspect of the invention is to improve consistency of cosmetic dermatology/aesthetician procedures by “recording” medical interventions using standardized electronic medical record interface functionality so that subsequent interventions can be repeated or improved. The desired repeatability and consistency is obtained by employing practices that are analogous to the types of practices currently employed in the field of dentistry. For example, in the case of consumable aesthetic services including, but not limited to, botulinum toxin injections (BOTOX™), soft tissue fillers and laser treatments, certain key protocol domains may be followed, which will provide an optimal degree of consistency and predictability of a user's aesthetic improvement results. Additionally, this aspect of the invention provides precise guidance to the medical professional through delivery of the service. The guidance is preferably provided by a “best practices” protocol provided to the medical professional by accessing a dynamic database (described in more detail below).

Further, it is contemplated that the aesthetic procedure performed may be any procedure that alters the look, appearance or self-confidence of the client. In addition to the aesthetic procedures discussed above, other aesthetic procedures may be available, including, but not limited to, hair extensions, facials, exfoliation, facial or body wraps, paraffin treatment, massages, chemical peels, permanent make-up, dermabrasion, microdermabrasion, waxing of the face or body, reflexology, nail extensions, aqua baths, tanning booths, artificial tan application by spraying or lotion, holistic relaxation techniques, phytocosmetic treatment, pigmentation treatment, breast enhancements and reductions, laser resurfacing, eye, brow, breast, body and face lifts, nose contouring, tummy tucks, cheek/chin implants, mole removal, correct facial or body symmetry, body sculpting, hair replacement, and Restylane™.

An aspect of the invention provides the ability to predict the outcome of a dermatology procedure based on prior results/outcomes that have been compiled in a database.

Some embodiments of the invention provides the integration of the various aesthetic improvement domains using a solution platform that uses a single systems integrator, i.e., a “concierge,” to drive and supervise a user's aesthetic improvement. In other embodiments of the invention, the various aesthetic improvement domains may be performed by multiple staff members or a single staff member with more than one title.

The invention may be used to aid users in improving the aesthetics of their face or body. That is, based on user-specific information, the invention may provide a user with aesthetic improvement advice, such as recommended cosmetic enhancement procedures or any one or more of available aesthetic improvement domains. The recommended procedures may complement (physically, physiologically, psychologically, biologically, and/or aesthetically) one another. The recommendation of complementary procedures may not only be a function of the selection of a particular aesthetic improvement procedure, but may also be a function of personal characteristics of the user. Based on a selection of cosmetic dermatology, facial skin tone, hair color and eye color, a method consistent with the invention may, for example, identify a recommended level or type of make-up artistry. Appearance improvement domains include, but are not limited to, plastic surgery, cosmetic dermatology, cosmetic dentistry, hair styling, hair coloring, facial aesthetics, make-up artistry, fashion and eyewear consultation and nail care. Additional appearance improvement domains include basic skincare regimen, prescription products, aesthetic services, and hair loss.

In an embodiment of the invention, information is received from a user regarding one or more of the user's facial and body features and the aesthetic improvements they wish to have performed. The reception of the user-specific information may be performed using one or more of a network, oral communication, visual communication, written communication, physical data carrier, and/or any other means capable of conveying information.

The user-specific information may be organized into categories, such as personal information, identifications of user-sought improvements, lifestyle, behavioral, personal preferences, etc. Personal information may include demographics, skin and body conditions (e.g., skin type, skin texture, skin tone, wrinkles, hair color, hairstyle, hair condition, eye color, etc.), age, facial features, purchase history, cosmetic color, allergy information, climate information, lifestyle information, product preferences, fashion preferences, prior purchases, and prior expressed interests. It should be noted that the term “user-specific information” is not necessarily related to any particular user. In this regard, the present document uses the term subject-specific information interchangeably with the term user-specific information and neither term is necessarily tied to a particular individual engaging in a particular activity.

Consistent with the invention, a method may also include accessing a database containing information reflecting relationships between categories of user-specific information and aesthetic improvement advice. The purpose of accessing such a database is to ascertain the relational basis between the user-specific information and the advice sought by specific users. Preferably, the database also includes a warehouse of “Best Practices”. That is, a specific treatment protocol that has been judged optimal by a panel of medical and/or aesthetic experts. The protocols are outcome based and proven to be efficacious, safe, and exhibit high client satisfaction. Preferably, the database is populated with a therapeutic delivery tool. The therapeutic delivery tool is a software product designed to aid the input of best practices case studies into the expert system database.

In an embodiment of the invention, one or more user appearance assessment tools may be used to assess user appearance. These tools include, but are not limited to, a concierge who serves as a single point of contact for a user seeking aesthetic improvements, an integrated consultation process, a feature-related flip chart, a diagnostic room, a diagnostician, a self-perception questionnaire, an electronic photograph system, an electronic image database, an electronic system for electronic image morphing, a user satisfaction survey, a beauty analysis system, a wrinkle measurement system, a tooth whiteness measurement system, an expert panel measurement tool, a beauty blueprint report, client summary report, and an outcomes measurement report.

In certain embodiments of the invention, one or more user appearance assessment tools are undertaken by or performed on the user before the performance of one or more aesthetic improvement procedures. In certain aspects of the invention, an initial user appearance assessment is conducted prior to the performance of any aesthetic improvement procedures. In certain aspects of the invention, a user appearance assessment is conducted at the conclusion of one aesthetic improvement procedure and prior to the commencement of another. In other aspects of the invention, a final user appearance assessment is conducted following the performance of all aesthetic improvement procedures recommended to and/or desired by a user.

An embodiment of the invention provides a user with a “concierge”, i.e., a single systems integrator to drive and supervise a user's aesthetic improvement. For example, a user meets with a concierge, a trained professional who is the user's primary contact during the aesthetic improvement process, and provides user-specific information to identify the user's appearance-related issues, concerns and needs. This process results in the identification of all the user's aesthetic needs (hair, eyes, lips, overall face, overall skin, legs, buttocks, breasts, arms, legs, stomach/abs, neck/back) that are articulated from the user's point of view. This is followed by a detailed user-concierge discussion or consultation about each of the areas identified by the user and how they tie together to impact the user's overall appearance. In alternate embodiments of the invention, some or all of the above steps may be automated with software and not require a concierge.

A method consistent with the invention provides a comprehensive aesthetic diagnostic analysis. In certain aspects of the invention, the aesthetic diagnostic analysis includes, but is not limited to, assessment of skin quality, facial feature symmetry (including dental symmetry), teeth color quality, and aging analysis. Further, in some embodiments, an integrated provider analysis and review session is conducted by the concierge, aesthetician/nurse practitioner with all of the relevant aesthetic providers (plastic surgeons, cosmetic dermatologists, cosmetic dentists, hair stylists, hair colorists, make-up artists and/or fashion/image consultants) to review the data collected during the diagnostic analysis. Here, the concierge serves as a central distribution and collection agent for the user's aesthetic assessments and provider inputs and mediates the aesthetic improvement processes desired by the user. It is, however, further contemplated that in other embodiments, a medical professional, such as a technician, dermatologist, nurse practitioner, physical assistant, physician, and the like, serves as the concierge. In these embodiments, the medical professional serves as the central distribution and collection agent.

A method consistent with the invention also provides a comprehensive aesthetic diagnostic analysis that does not contain a concierge. Here, the aesthetic diagnostic analysis includes, but is not limited to, assessment of skin quality, facial feature symmetry (including dental symmetry), and teeth color quality. In other embodiments, to complete the aesthetic diagnostic analysis, the client follows instructions from an electronic or paper display. Therefore, the aesthetic diagnostic analysis system is preferably completely self-directed and involves minimal contact with other persons. Indeed, it is contemplated that the embodiments without a concierge may include a stand-alone kiosk or computer diagnostic station. In these embodiments, the client would approach the station and follow directions presented on the display. The directions may include requests for client information, instruct the client on when and how to use any diagnostic probes, and instruct the client to move to a digital photography area for photos. Further, it is contemplated that the station would provide an analysis consistent with the invention. For instance, it is contemplated that a software system is connected to the station such that the software system may use information from the database to analyze the diagnostic prove and/or photography information, perform complex algorithms to compare the client information to peer information from the database, update and/or alter information stored in the database, and make recommendations for product usage or aesthetic procedures. For example, when a user skin checkup occurs, the skin checkup information for the user is sent by a communication means from the local, user site to a remote, dynamic database that contains user and peer information. The software system connected to the database then compares the skin checkup information from the user to the information from other users having the same general gender, age, and skin type. The comparison information is sent by a communication means to the user site. The comparison information may show that the user skin condition is below, at, or above average as compared to their peer group.

In an embodiment of the invention, a feature-related flip chart may be used to allow a user to identify their needs and concerns. The chart utilizes pictures of facial and body features and describes the issues and concerns that the user has with particular facial and body features. In alternate embodiments of the invention, the flip chart is implemented with software rather than using an actual flip chart.

Consistent with some embodiments of the invention is a diagnostic room where a user can optionally participate in one or more of the following: meet with a diagnostician, fill out a self perception questionnaire, have a standardized electronic photo taken, undergo a skin measurement and analysis using a skin diagnostic analysis system, undergo a wrinkle measurement analysis using a wrinkle measurement system and a teeth whitening analysis using a teeth whitening measurement system. A diagnostician is a trained professional who assists the user with one or more of the above-identified activities. In certain aspects of the invention, the concierge also fulfils the role of the diagnostician.

Consistent with the invention, the concierge engages in a first consultation with individual aesthetic improvement providers. These providers include, but are not limited to, a plastic surgeon, a cosmetic dermatologist, a cosmetic dentist, a hair stylist, a hair colorist, a facial aesthetician, a make-up artist, a facial specialist, a fashion and eyewear consultant, and a nail care professional. The providers utilize the diagnostic data acquired to assess which procedures inside their own domain will have the maximum appearance improvement impact on the user. Following the first consultation between the concierge and the aesthetic improvement providers, the concierge and user choose the relevant aesthetic improvement providers who will provide the aesthetic improvements to the user.

After obtaining individual input from the providers, the concierge engages in a second consultation with all of the relevant providers to integrate the improvements sought by the user on behalf of an optimized whole. The primary purpose of the second consultation is to optimize the overall aesthetic improvement of the user by ensuring that the individual improvements recommended by multiple providers are compatible with one another and do not create an adverse outcome for the user. For instance, a specific improvement recommended by a plastic surgeon, e.g., a nose reduction procedure, which would provide an aesthetic improvement to the user on its own, may be incompatible in conjunction with an improvement recommended by an eye wear consultant, i.e., eye wear selection is incompatible with the shape of the user's nose following the reduction procedure.

Following the second consultation with the relevant aesthetic improvement providers, the concierge develops a detailed aesthetic-improvement plan for the user, which describes all of the proposed interventions/improvement procedures in the appropriate sequence by prioritizing the recommended procedures for maximum improvement, minimum cost, minimum invasiveness, maximized comfort and maximum convenience.

An example of an electronic photograph system that may be used in an embodiment of the invention is the Canfield system (www.canfieldsci.com), although other comparable systems or methods may be used in place of the Canfield system. The electronic photograph system facilitates assessing the visual changes that occur from aesthetic improvement procedures by standardizing “before” and “after” images of the user's face and body.

In certain embodiments, the electronic photograph of the user is morphed to take into account the changes that aesthetic improvement procedures will create on the user. The images generated using the electronic photograph system are stored in a database and organized and categorized to allow a level of standardization so that a user's “before” image may be compared to the “before” images of one or more prior users who have undergone similar aesthetic improvements. The electronic photograph database would also allow the comparison of a user's “after” image to the “after” images of one or more prior users who have undergone the same or substantially similar aesthetic improvements. This capability allows a diagnostician to drive the process of morphing software manipulation so that potential users may be able to view actual images of a previous user before and after the administration of one or more aesthetic improvement procedures. This methodology differs from the traditional use of idealized imagery, which does not reflect an actual case performed on a prior user.

An embodiment of the invention provides a user with an opportunity to complete a user satisfaction survey and a standardized attitudinal survey, which measures self-esteem and satisfaction with the body image before and after the performance of one or more aesthetic improvement procedures. These two survey tools permit a diagnostician to measure the user's satisfaction and dissatisfaction with specific features on the user's face and body. The survey tools further allow (i) a diagnostician to recommend one or more aesthetic improvement procedures to the user based on the user's responses to the survey, and (ii) provide the enterprise with an ability to measure specific satisfaction outcomes from the procedures themselves.

In other embodiments of the invention, a user satisfaction survey is also performed after the performance of one or more aesthetic improvement procedures. The post-procedure survey permits a diagnostician to assess a user's satisfaction and dissatisfaction with the results of the aesthetic improvement procedures performed on the user.

An example of a beauty analysis system that may be used in an embodiment of the invention is the Marquardt system, although other systems or methods may be used in place of the Marquardt system. U.S. Pat. No. 5,867,588 and U.S. Pat. No. 5,659,625 disclose and claim the Marquardt beauty analysis system, and are filly incorporated by reference herein.

An example of a wrinkle measurement system that may be used in an embodiment of the invention is the Lemperle system, developed by Dr. Stefan Lemperle. However, other systems or methods may be used in place of the Lemperle system, including but not limited to, the Visia system and Canfield system, which measure skin wrinkling, skin pore size, UV damage of skin and skin consistency.

Consistent with the invention, an expert panel measurement may be employed in an embodiment of the invention. This tool will provide an assessment of the aesthetic improvement provided to a user as a result of one or more procedures on an objective measurement scale, for e.g., a scale of 0-5, and thereby provide standardized and measurable outcomes on both an individual and a population basis.

In an embodiment of the invention, a panel of experts comprising at least one concierge, who serves as the contact point for a user, and one or more aesthetic improvement providers meet to discuss the types of aesthetic improvement procedures that a user would benefit from, based on user-specific information.

In other aspects of the invention, a panel of experts and at least one concierge participate in a review process after the performance of one or more aesthetic improvement procedures on the user, based on the results of user feedback and post-procedure satisfaction surveys. Optionally, the review process can be conducted online.

In an embodiment, a method may optionally include providing and/or performing one or more aesthetic improvement procedures to a user. Provision of the procedures is performed using a “concierge” system, i.e., a solution platform that uses a single systems integrator to drive and supervise a user's aesthetic improvement. Then embodiments of the invention provide multiple operators and a single, central client management system.

One embodiment of the invention provides a system and method that combines multiple aesthetic and/or medical practices into an integrated system. An aspect of the invention provides a method of providing a patient with an aesthetic improvement procedure comprising: obtaining information from the patient regarding the aesthetic improvements desired by the patient, consulting with individual providers of aesthetic improvements for recommendations, developing a comprehensive aesthetic improvement plan, performing the recommended aesthetic improvement procedures and assessing the outcome of the aesthetic improvements in an integrated and objective manner.

A method consistent with the invention provides the user with the recommended aesthetic improvement procedures. Preferably, a trained user of a system of the present invention, typically a nurse practitioner, enters the patient's desired area of improvement into software to query the expert system. More preferably, the trained user also takes diagnostic measurements of the area to be improved and enters this data into the query software as well. Preferably, the expert system matches the patient data with one or more successful prior case studies and recommends an aesthetic improvement procedure (or procedures) based on the previous successful case studies. More preferably, the expert system matches the patient data with a treatment protocol identified as a best practice. The best practices outcome of the expert system is based on actual test data and scientific analysis rather than subjective opinion.

In an embodiment of the invention, a post-procedure aesthetic diagnostic analysis is performed on the user in order to gather quantitative improvement metrics. In addition, self-reported user satisfaction data is obtained and combined with the outcomes of an aesthetic review panel to assess, capture and quantify aesthetic improvements as a result of the procedures performed.

An embodiment of the invention allows a user to identify aesthetic issues and needs as part of a single solution delivery capability that is facilitated by a comprehensive and integrated user-driven system that brings together disparate and disconnected procedures and inventions into a single/holistic solution for the user. Preferably, comprehensive integrated user-driven system includes a centralized data repository.

An embodiment of the invention provides a quantitative database of metric data that quantifies the user's appearance before and after the performance of one or more aesthetic improvement procedures and provides an objective measurement of appearance improvement. This permits the assessment of beauty to be moved from a subjective to an objective realm and permits the quantifiable assessment of a user's appearance before and after the performance of one or more aesthetic improvement procedures.

In some embodiments, one or more databases of the current invention are remote, dynamic databases. Generally, a dynamic database is one in which the data within may be easily changed or updated. For instance, one can use a software system to access information from a dynamic database via a network and upload information from the database to the software system. If the information stored in the database changes, the software system connected to the database will also change accordingly and automatically without human intervention. The software system may update the user's information in the dynamic database on any time bases, including, but not limited to, an event driven, minute-by-minute, hourly, daily or weekly basis.

The dynamic database is preferred to the static database because the dynamic database allows a software system to input more information about users, the aesthetic treatment desired by the users, the outcome of the treatment, and other compatible information. As the amount of data for one or more parameters increases, the algorithm in the software system becomes more robust and accurate at calculating what aesthetic treatment/procedure best suits the user's set of criteria.

In addition, the dynamic database may include a dynamic expert system that can be used to provide a patient with at least one recommendation on performing an aesthetic improvement procedure. Actual case studies involving aesthetic improvement procedures are submitted to a panel of experts in the appropriate field. The judgments of the experts are added to a database of case studies. In conventional, static expert systems, the database is never or infrequently updated. In contrast, the system of the present embodiment of the invention is constantly updated with new case studies. That is, as each new aesthetic improvement procedure is performed, it is evaluated and added to the database. In this manner, the expert system database is continually updated, thereby improving the accuracy and robustness of the system. Preferably, all of the new aesthetic improvement procedures are added. In some aspects of the invention, the experts judging the case study may deem a particular case an outlier and chose not to enter the case into the expert system database.

Further, it is contemplated that the panel of experts can review improvements to current procedure protocols or new procedure protocols to determine the efficacy, safety, cost and expense, ability of the procedure to improve an aesthetic characteristic, and the like. Based upon their review, the panel of experts decide if the amended or new protocol should be recommended and/or performed at one or more business locations. The amended or new protocol may then be added to or removed from the database. The aesthetic protocols are therefore continually updated, improving the safety and efficacy of the recommended procedures.

The database may contain specific information on each user. User information may include, but is not limited to, name, address, birth date, sex, ethnicity, checkup history, skin tone, lifestyle questions, skin concerns, or a mix thereof. Skin concern information may include, but is not limited to, skin type, skin reaction to specific skincare products, acne history, preferred skin products, and over-the-counter prescription skin products. Lifestyle questions may include, but is not limited to, if the user is pregnant or breast-feeding; if the user takes vitamins or supplements; smoking history; teeth augmentation such as the veneers, implants, caps, bonding, dentures; frequency and type of beverages consumed, and gum sensitivity. Behavioral and personal preferences may also be included.

It is also contemplated that the user information may include data from the user's past and current skin checkup and smile checkup. It is further contemplated that the user information may include, but is not limited to, medical and aesthetic information concerning plastic surgery, cosmetic dermatology, cosmetic dentistry, hair styling, hair coloring, facial aesthetics, make up artistry, fashion and eyewear consulting, nail care information, and the like. The data may be in any form, including but not limited to, text, photographs, and graphically represented data.

The database may also contain information reflecting the relationship between categories, or parameters, of user-specific information and information from the user's peer group. In some embodiments, it is contemplated that a software system is connected to the database such that the software system may use information from the database, perform complex algorithms to compare user and peer information from the database, and update and/or alter information stored in the database. For example, when a user skin checkup occurs, the skin checkup information for the user is sent by a communication means from the local, user site to a remote, dynamic database that contains user and peer information. The software system connected to the database then compares the skin checkup information from the user to the information from other users having the same general gender, age, and skin type. The comparison information is sent by a communication means to the user site. The comparison information may show that the user skin condition is below, at, or above average as compared to their peer group.

In some embodiments, the software system connected to the database can compare any type of user information, or parameters, to other peer users or non-peer users, including but not limited to, imagery such as photographs, bitmaps, and jpeg; birth date; geographical location; sex; ethnicity; checkup history; skin tone; probe analysis data; skin analysis data; body type and shape; skin state results from previous and current skin checkups; results from previous and current smile checkups; lifestyle questions; skin concerns; and the like. The number of different parameters that can be compared is limited by the memory type. Preferably, the software is enabled to recognize long bite lengths to allow for 64 different parameters that can be recorded and compared. However, it is contemplated that there may be more parameters.

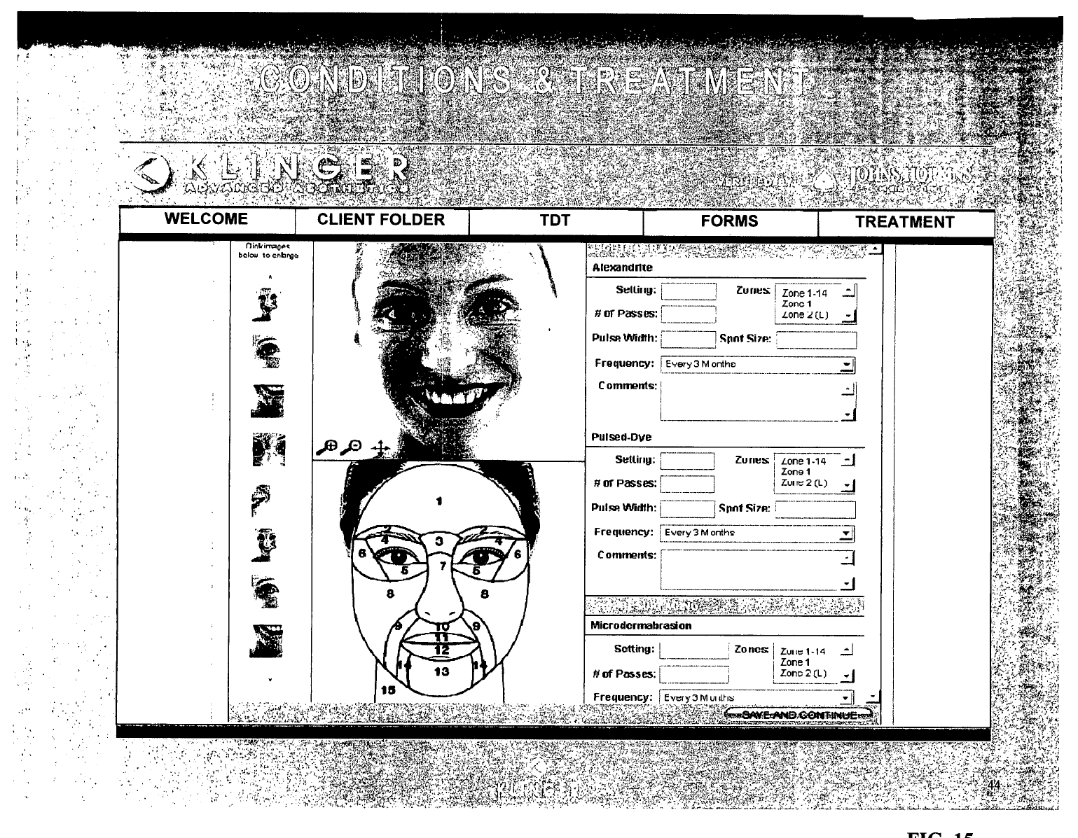

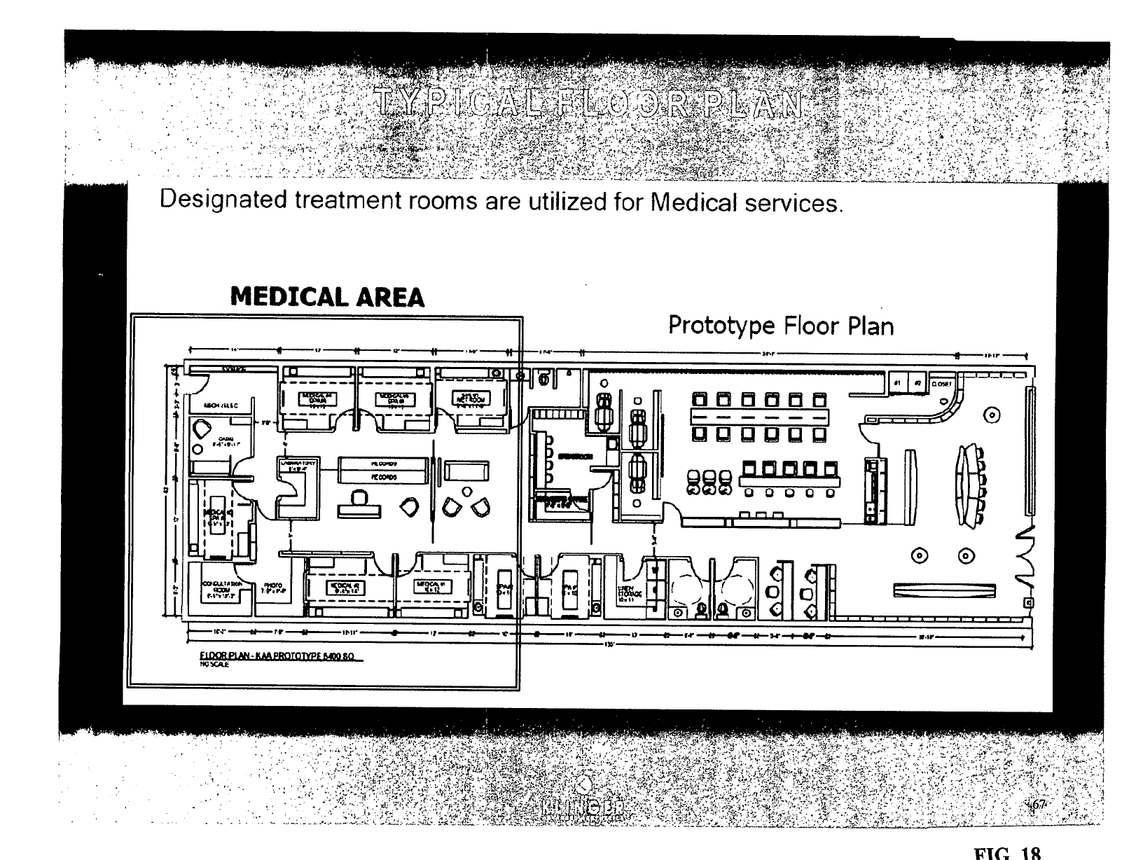

In some embodiments, the software system is enabled to break a photo up into target zones by drawing an electronic mask on the electronic photo of the frontal, side, or other view of the user's face or body. The electronic mask allows assessment of a user's features to find, for example, whether the user's upper lip is ideally proportioned relative to the rest of the user's face. The electronic mask also allows for the software to analyze the parameters of the zones separately as opposed to measuring the parameters of the entire face. For example, FIG. 14-17 for different ways a face can be broken into zones.

In one embodiment, a photo is broken into target zones by drawing an electronic mask on the electronic photo of a user. It is contemplated that the software system is capable of determining the facial shape, volume and symmetry by any means, including use of the electronic mask. The user, concierge, or other medical professional may then select a zone that they want analyzed. The user interface displayed may vary by the zone selected. For instance, if the zone is the forehead, then the user page may request the user, concierge or other medical professional to determine forehead conditions such as transverse frown lines, brow ptosis, glabella frown lines, eyebrow asymmetry and pigmentation. The user, concierge or other medical professional may then select a treatment option, the treatment options recommended by the expert system. If the zone is the nose, then the user page may request that the conditions of the dorsum, tip type, nasal base and pigmentation be determined. Again, the user interface may display treatment options. If the zone is the upper eye area, then the conditions of the symmetry, aperature and redundant skin may be determined. If the zone is the lower eye area, then the conditions of the symmetry, apparent lip laxity, wrinkling, excess skin, dark circles, fat and tear trough may be determined. If the zone is the outer eye area, then the conditions of the wrinkles and symmetry may be determined. If the zone is the cheek, then the conditions of the wrinkling, orange peel, fat pad height, jowl presence and pigmentation may be determined. If the zone is the chin, then the conditions of the symmetry, wrinkling, chin recession and depth of fold may be determined. If the zone is the lips, then the conditions of the wrinkling, vermillion border depletion, philtrum depletion, downturn of lip corners, commisures, upper and lower lip volume may be determined. If the zone is the neck, then the conditions of the wrinkling, platsysmal banding, neck lipsdystrophy and transverse lines may be determined.

The user interface (UI) may also be used by the user to show the concierge or other medical professional the areas the client wants treated. It is also contemplated that the concierge or other medical professional may be able to draw on the user photo, with or without the electronic mask drawn thereupon, to show the client what zones they recommend treatment and what treatment is recommended. It is further contemplated that the treatment options may include injectables, light therapy, skin resurfacing, surgery, cosmetic/medical products, prescriptions, and supplements. Moreover, the software system may be used to determine the condition and/or recommend a treatment option.

It is further contemplated that the software system be enabled to make multiple types of comparisons between a user and his/her peers. For instance, in one preferred embodiment, the software creates a feature count score by summing the count of one parameter that is being measured within a certain zone of the body or face. In another preferred embodiment, the software creates an absolute count by taking the feature count and controlling for the area in the mask that the zone takes up. For example, the absolute count would find that one cheek zone may take up, 14% of the electronic mask. In another preferred embodiment, the software calculates a percentile score by comparing the user to their peer group. The results of the comparison may be displayed in any form. Preferably, the graphical display is a bar ranging from 1 to 100 and a marker, such as an arrow, bar or dot, to show where the user falls within this range. The numerical number that determines what constitutes below, at, or both average can also be set by the administrator. Further, the numerical number may be automatically determined by the software system. It is further contemplated that the numerical number may change as more information about the users is added to the database. The comparison of the user to their peer group can occur for any type of measurement, including but not limited to, digital photography analysis, film photography analysis, medical probe analysis, diagnostic skin probe analysis, x-ray analysis, MRI analysis, laser 3-D scanning, or a mix thereof.

In some embodiments, the software system may include a method for an administrator to log into the software system from a site that is remote from the software system and/or dynamic database. Further, it is contemplated that the administrator can access information such as the diagnostic history of one or more users, the days and hours of one or more business locations, the details of all of the users that have undergone one or more aesthetic improvement procedures at the business location, and the number of new, repeat, and total users that have frequented one or more business locations. It is also contemplated that more than one administrator at each business location can access the software system. Therefore, the administrator may be able to view the other administrator's personal information and permission settings, view administrator detail, adds new administrators, and edit administrator permissions.

Other information and functions that the administrator may access includes, but is not limited to: view statistics on user usage; search for users based on criteria such as age, gender, ethnicity, etc.; add, edit, or delete users; summarize activity at one or more business location, view reports on usage of probes and other aesthetic measurement tools; view and/or edit online help functions; view proof of concept to weigh products towards certain aesthetic results; assign administrators to predetermined roles; report how long one aesthetic improvement session takes; view graphical representation of trends in reports; report number of sessions on average length each session takes; breakdown reports based on various criteria; view the diagnostic environment performance; add, edit, or delete questions that are asked of the user; and view session demographic reports. The session demographic reports may include, but is not limited to, reports that showed a breakdown in aesthetic improvement procedures by age, ethnicity, climate sound, skin tone, skin state, elasticity, hydration, fine lines, visible spots, pores, texture, and UV damage. Further, it is also contemplated that the administrator can edit profile ranges.

In some embodiments, the software system is flexible configurable in that the architecture of the software and database may be modified to allow for the addition or deletion of any type of data analysis and data, including addition or deletion of probes, medical procedures, and aesthetic procedures. It is further contemplated that the administrator can add, edit, or delete products that are recommended at one or more business locations. Further, the software system may be used to develop distribution channel specific programs, settings and configurations. The software system may also be used to develop “branded” versions of products.

The software architecture may be any architecture that performs one or more contemplated embodiments. For instance, in one contemplated architecture, the probes and/or camera are coupled to local hardware interface components by a communication means. The local hardware interface is then coupled to one or more local business components, which are coupled to a UI. The UI may comprise local components, local process components, remote components, remote process components, or a mix thereof. The user may interact with the UI for any reason, including inputting or requesting information. The UI is coupled by a communication means to the business components, which is coupled to data access components. The data access components can then access one or more data sources/databases. It is further contemplated that one or more components can be combined, or the order of the coupling may be altered, to best comply with the purpose of the architecture. Further, it is also contemplated that various components of the system may be mobile. For example, users of the system may be issued mobile test kits and laptop computers. These users could then provide services to clients who could not easily visit a clinic.

Further, it is contemplated that the network topology may be any which best complies with the software architecture and hardware configuration. In one example, the client computers or terminals are networked via an Internet gateway to a firewall. The firewall may then be connected to an IP Load Balancer, which has the to load-balance incoming IP network requests across a farm of servers. An IP Load Balancing cluster may be one server, or a group of servers behind a pair of redundant routers. The IP Load Balancer requests from the Internet to a pool of servers. The servers may be, for example, web servers, SQL servers, and the like. The servers provide the critical services to the end-user while the router balances the load to these servers. It is also contemplated that the client computers are terminals access an Internet gateway via private network. This private network may further include, for example, a web server. Further, the topology may include one or more development or production servers.

In addition, it is contemplated that the architecture and/or topology may be altered at any point to improve manageability of source code and version control, improve scalability, flexibility and stability.

It is also contemplated that one or more databases of the current invention are static databases. A static database is a database consisting of “information-based relationships”, one that is rigorously structured to facilitate retrieval and update in terms of inherent relationships. This creates a static environment wherein the locations of the related records are already known.

The exchange of information, or communication means, mentioned in any of the previous embodiments may occur by any means, including but limited to, internet, intranet, extranet, WAN, LAN, satellite communication, cellular phone communications, communications on a motherboard, and the like. Furthermore, the exchange of information, or communication means, may include simple message communications, remote procedure calls or other distributed application messages, Web Messaging, Web Services, MSMQ, MQ Series, XML messages, file transfers, or the like. It is also contemplated that the exchange of information, or communication means, may include direct network communications using a communication protocol such as TCP/IP, IPX, RFC 793, or another standard or proprietary communication protocol.

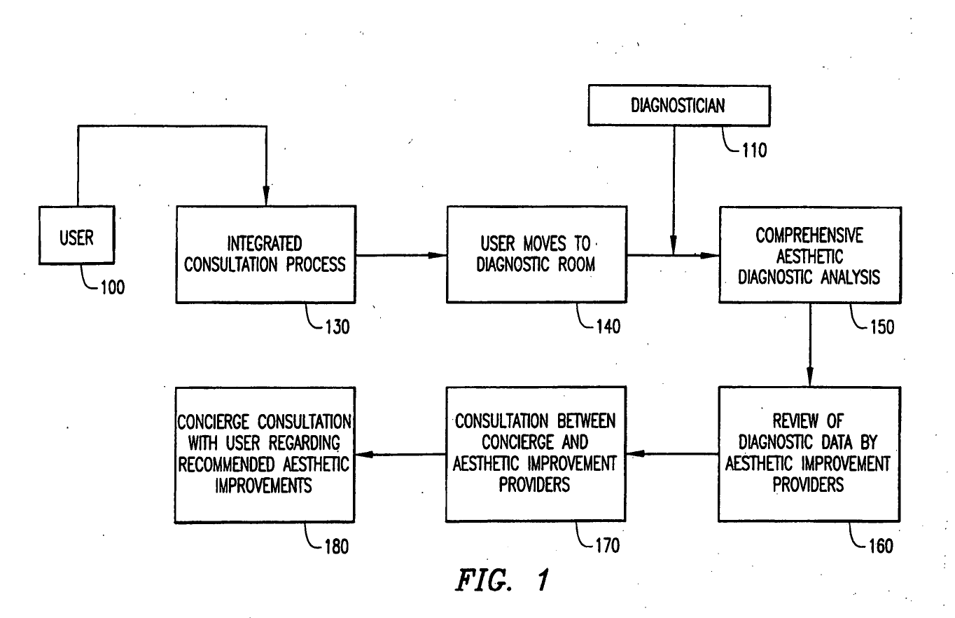

FIG. 1 illustrates an embodiment consistent with the methods of the invention. Consistent with this embodiment, a user, i.e., client or patient, (100) meets with a concierge (120), a highly trained professional, and becomes engaged in an integrated consultation process (130). During the consultation process, the user informs the concierge of their aesthetic improvement issues, and the concierge informs the user of all nine aesthetic improvement domains in a comprehensive fashion. For example, the concierge could separately inform the user of salon-related aesthetic improvement domains like the use of a hair stylist, a hair colorist, a facial aesthetician, a make-up artist, or a fashion consultant, as well as medically related aesthetic improvement domains such as, plastic surgery, cosmetic dermatologist or a cosmetic dentist. Following the consultation process (130), the user moves to a diagnostic room (140) and meets with a diagnostician (110). The diagnostic room is a specially designed and outfitted room located inside a medical, salon or spa facility, where a user utilizes one or more user appearance assessment tools in the presence of a diagnostician (110). The diagnostician performs a comprehensive aesthetic diagnostic analysis (150) on the user including, but not limited to, administering a self-perception questionnaire, taking an electronic photo of the user's face, conducting a beauty analysis on the user's face, conducting a wrinkle analysis on the user's face and conducting a teeth whiteness measurement. The collected diagnostic data is reviewed by relevant aesthetic improvement providers (160) who consult with the concierge regarding recommended aesthetic improvement procedures (170) and their compatibility with one another. A draft recommended aesthetic improvement plan is then formed. The concierge then consults with the user (180) and provides the user with information regarding recommended aesthetic improvements as well as the draft aesthetic improvement plan specifically designed for the user. The steps 160, 170 and 180 may be repeated as necessary to achieve a final comprehensive aesthetic improvement plan for implementation.

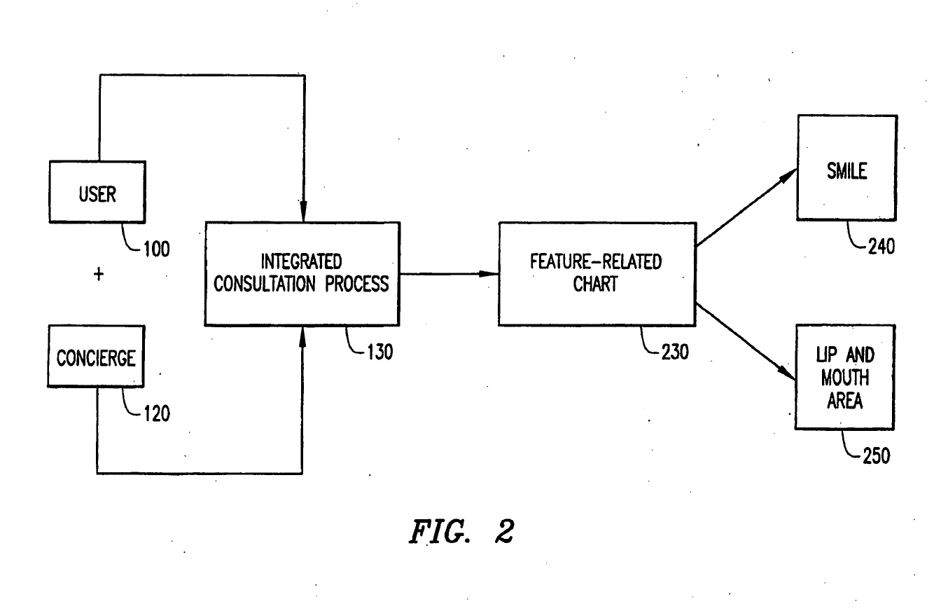

FIG. 2 illustrates an embodiment of the invention in which the consultation process (130) between a user, i.e., client or patient, (100) and a concierge (120) includes the use of a feature-related flip chart (230) that utilizes pictures of a user's facial and body features with descriptions of specific issues related to each of the facial and body features. For example, one of the features that may be considered is the user's smile (240). With respect to this feature, the issues to be considered include, but are not limited to, tooth color, tooth shape, tooth size, crooked teeth, missing teeth, uneven smile, gum problems and quality of breath. Another feature that could be considered is the user's lip and mouth area (250). With respect to this feature, the issues to be considered include, but are not limited to, lip size, lip shape, laugh lines, wrinkles, unwanted hair, comers of the mouth, lip color and skin texture. Other facial features such as eye shape, eyebrows, chin, jowls, cheeks, nose, and the like can be evaluated using the chart. Additionally, body features such as chest, arms, waist, hips, thighs and the like can be similarly evaluated using the feature-related flip chart.

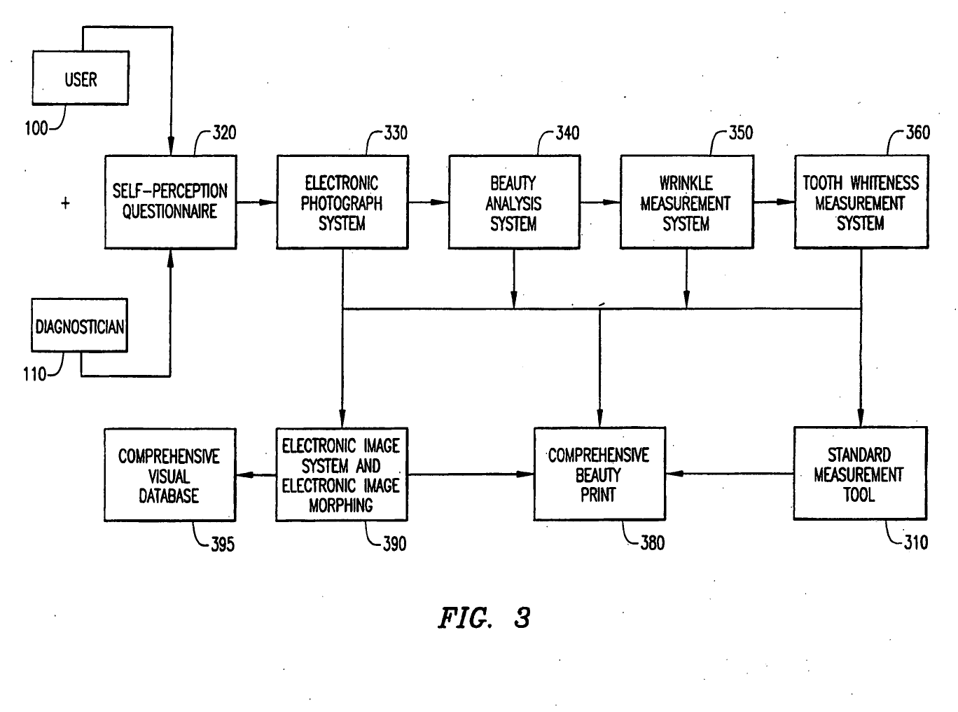

FIG. 3 illustrates an embodiment of the invention that utilizes one or more user appearance assessment tools to assess a user's, i.e., client's or patient's, appearance either before or after the performance of one or more aesthetic improvement procedures. In the illustrated embodiment, a user (100) consults with a diagnostician (110), who employs specific user appearance assessment tools to evaluate the user's appearance. The user appearance assessment tools employed in the illustrated embodiment are a self perception questionnaire (320), which is used to measure a user's satisfaction and dissatisfaction with specific features of their face, body and self image; an electronic photograph system (330), which facilitates the assessment of visual changes that occur from aesthetic improvement procedures by standardizing “before” and “after” user photos; a beauty analysis system (340), which measures the symmetry of the features on a user's face and then “draws” (using a mask overlay) an ideal feature symmetry of each facial feature to provide guidance to the relevant aesthetic improvement providers; a wrinkle measurement system (350), which visually rates the degree of user skin wrinkling in the forehead, eyes, lips, ear area and chin; a tooth whiteness system (360), which measures the whiteness level of a user's teeth; a standardized measurement tool (370), which is similar to the self perception questionnaire (320), but is provided to the user after the performance of one or more aesthetic improvement procedures; and, a comprehensive beauty blueprint (380), which is provided to the user both before and after the performance of one or more aesthetic improvement procedures and includes the results of any diagnostic assessments conducted as well as a post-procedure review by a panel of aesthetic experts. Images from the electronic photograph system may be morphed to take into account the changes that aesthetic improvement procedures will create on the user (390) and stored in a comprehensive visual database (395).

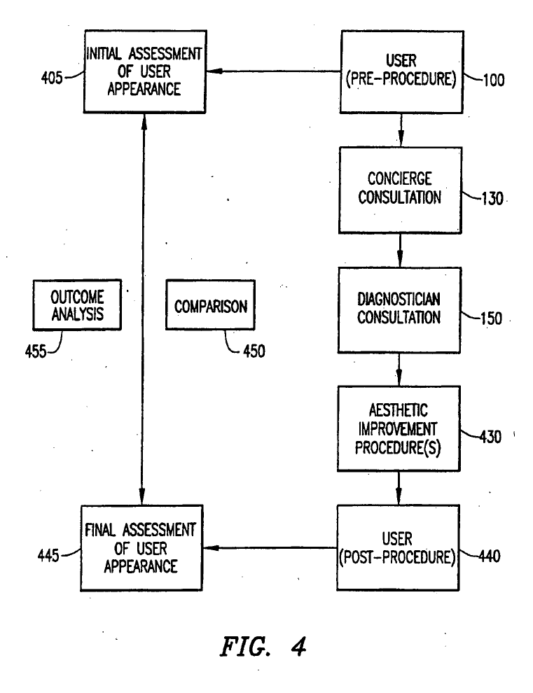

FIG. 4 illustrates an embodiment of the invention that provides a user, i.e., client or patient, with a method of retrospectively measuring the outcome of one or more aesthetic improvement procedures. A user (100) undergoes, in order, a pre-procedure user appearance assessment (405), where one or more user appearance assessment tools are applied to the user to generate a user appearance profile prior to the performance of any procedure; a concierge consultation (130), where the user informs the concierge of their aesthetic improvement issues, and the concierge informs the user of all nine aesthetic improvement domains in a comprehensive fashion; a diagnostician consultation (150), where a diagnostician performs a comprehensive aesthetic diagnosis on the user including, but not limited to, administering a self perception questionnaire, taking an electronic photo of the user's face, conducting a beauty analysis on the user's face, conducting a wrinkle analysis on the user's face and conducting a teeth whiteness measurement; and finally, one or more aesthetic improvement procedures (430). The aesthetically improved user (440) is subjected to a user appearance assessment (445) using one or more user appearance assessment tools. The user appearance assessment (445) of the aesthetically improved user is compared (450) to the initial user appearance assessment (405) to provide the user with a retrospective outcome analysis (455).

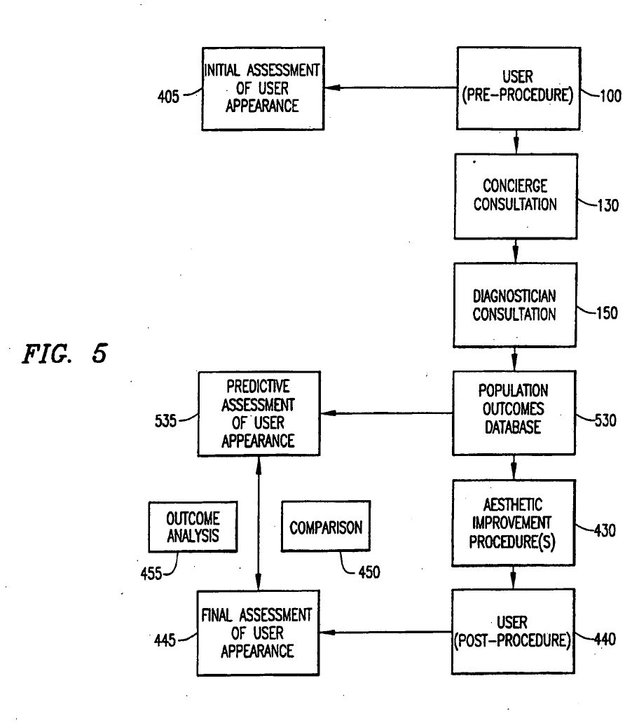

FIG. 5 illustrates an embodiment of the invention that provides a user, i.e., client or patient, with a method of prospectively measuring the outcome of one or more aesthetic improvement procedures. A user (100) undergoes, in order, a pre-procedure user appearance assessment (405), where one or more user appearance assessment tools are applied to the user to generate a user appearance profile prior to the performance of any procedure; a concierge consultation (130), where the user informs the concierge of their aesthetic improvement issues, and the concierge informs the user of all nine aesthetic improvement domains in a comprehensive fashion; and, a diagnostician consultation (150), where a diagnostician performs a comprehensive aesthetic diagnosis on the user including, but not limited to, administering a self perception questionnaire, taking an electronic photo of the user's face, conducting a beauty analysis on the user's face, conducting a wrinkle analysis on the user's face and conducting a teeth whiteness measurement. The aesthetic diagnostic data collected is correlated with pre-existing data in a population outcomes database (530). The database (530) contains objective measurements/data of improvements in prior users who have undergone one or more of the same or substantially similar aesthetic improvement procedures performed on the user (100). After the user's aesthetic diagnostic data has been correlated to the data in the outcomes database (530), a predictive assessment of the user's appearance is generated (535). Following the predictive assessment of the user's appearance, the user undergoes one or more aesthetic improvement procedures (430). The post-procedure user (550) is subjected to a user appearance assessment (555). The user appearance assessment (445) of the aesthetically improved user is compared (540) is compared to the predictive user appearance assessment (535) and analyzed (545) to ascertain the similarities between the predicted outcome (535) with the actual result (445).

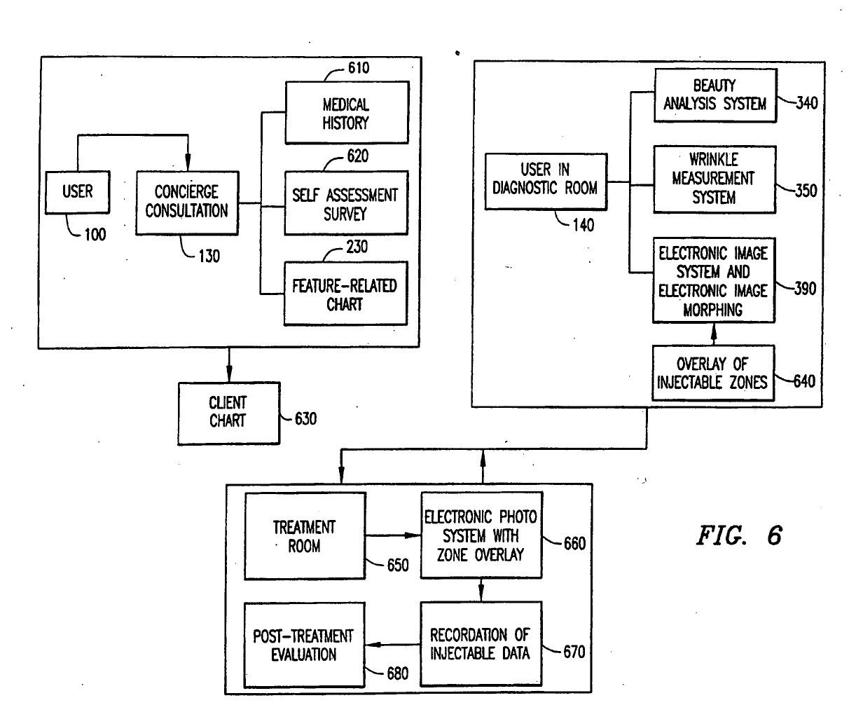

FIG. 6 illustrates an embodiment of the invention using a procedure to create repeatable results in cosmetic dermatology delivery services. A user, i.e., client or patient, (100) participates in a consultation with a concierge (130). During the consultation (130), the concierge collects information from the user pertaining to the user's medical history (610). In addition, the user (100) completes a self-assessment survey (620) and completes a feature-related chart (230). The results from the user's medical history (100), self-assessment survey (620) and feature-related chart (230) are compiled into a client chart or user chart (630). The user moves to a diagnostic room (140) where a diagnostician performs a skin state analysis (340), wrinkle measurement (350), electronic imaging and electronic image morphing (390). In the electronic imaging step (390), standardized photos of the user are taken. In the wrinkle measurement step (350), a wrinkle assessment of the user's face is taken for the target areas identified by the user. In the beauty analysis step (340), an electronic mask is generated and placed over the electronic photos of the user's face. A zone map of the target areas for intervention (for e.g., BOTOX™ injections and/or administration of soft tissue fillers) is overlaid on the electronic photos of the user (640). The user has a pre-treatment consultation with a physician. The user moves to a treatment room (650). A medical professional reviews the electronic photo of the user with the overlaid zones (640) and enters data into the zone areas of the electronic photo in accordance with the treatment to be administered. A physician administers the specific treatment (for e.g., BOTOX™ injections and/or administration of soft tissue fillers) in accordance with the data obtained from the zone-overlaid photographs, which is recorded (670). A post-treatment evaluation (680) of the user is conducted. The evaluation includes a review of potential adverse reactions following the administration of the treatment.

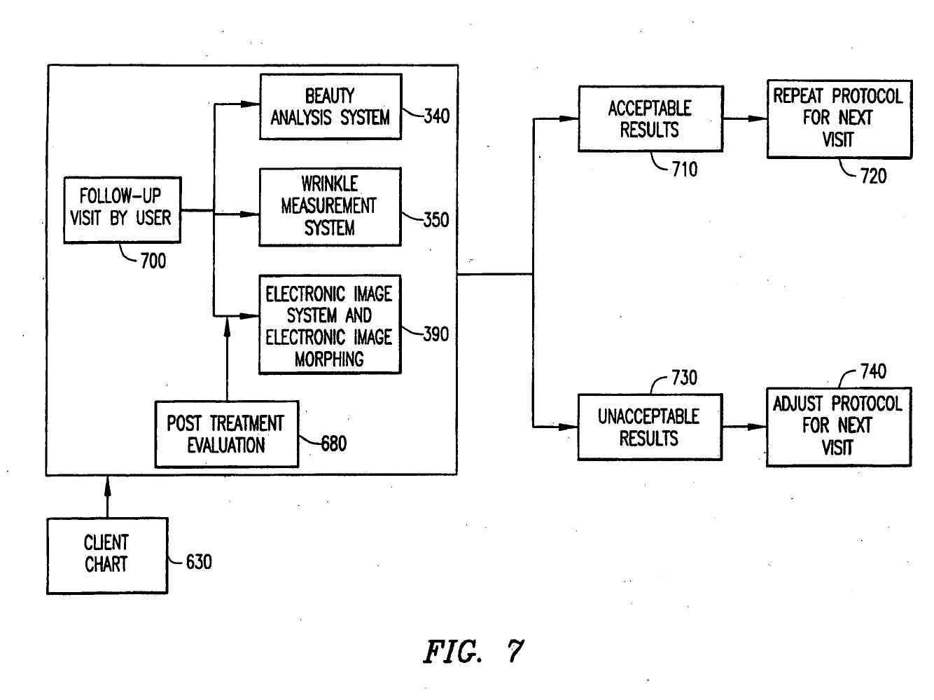

FIG. 7 illustrates an embodiment of the invention demonstrating the consistency and repeatability of a cosmetic dermatology procedure. A user, i.e., client or patient, (100) undergoes a cosmetic dermatological procedure in accordance with the methods set forth in FIG. 6. After the passage of time following the treatment, the user returns for a follow-up visit (700). A skin state procedure (340), wrinkle measurement procedure (350), and electronic imaging and electronic image morphing (390) procedure is conducted on the user. In addition, the post-treatment evaluation data (680) of the user is also reviewed. All of the information is compiled in the user chart or client chart (630). The information gathered during the user's follow-up visit to ascertain the acceptability of the results to the user and the medical provider, either a physician or a nurse practitioner, which administered the treatment. If the results are acceptable (710) to the user and physician, the treatment protocol may be repeated during the user's next visit (720). If the results are unacceptable either to the user or to the physician (730), the treatment protocol is adjusted prior to or during the user's next visit (740).

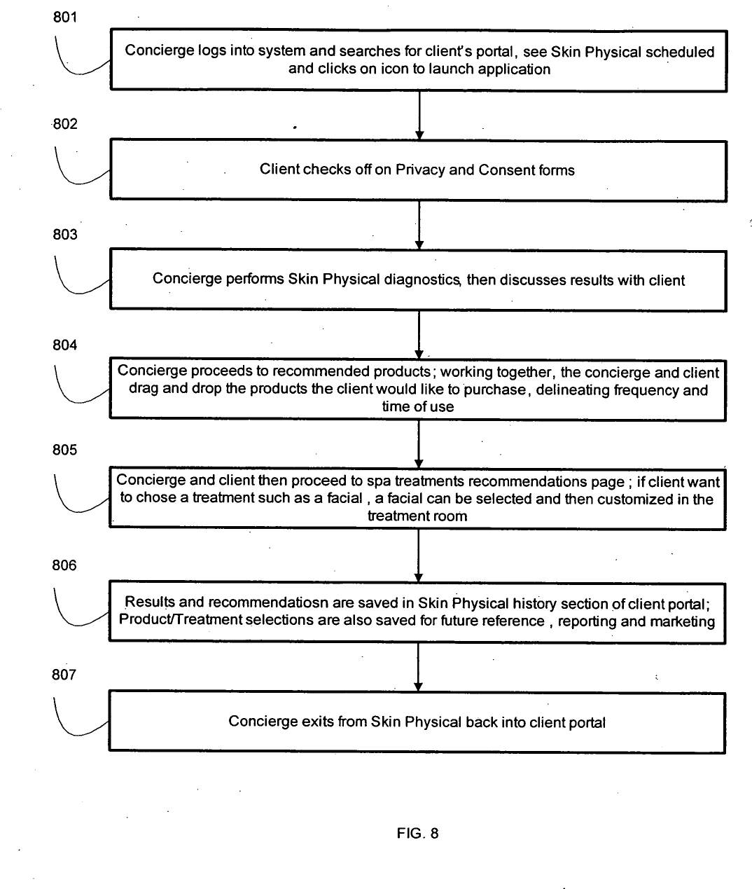

FIG. 8 illustrates an embodiment of the invention in which the concierge performs a skin state. In step 801, the concierge logs onto the system and searches for the client's record. The concierge sees that a skin state is scheduled and clicks an icon to start the process. This brings up a privacy form. In step 802, the client checks off on the privacy consent form. In step 803, the concierge performs Skin state diagnostics and discusses the results with the client. The results of the skin state diagnostics and the discussion with the client are inputted by the concierge into the expert system. In step 804, the concierge accesses a screen in which the expert system recommends products based on the Skin state and the discussion. Additionally, in this step the concierge and the client select products/services the client would like to purchase. Further, the frequency and time of use of the products are added. In some embodiments, the expert system may also indicate if the client is a candidate for one or more medical procedures.

In step 805, the concierge and the client proceed to the next page, the spa treatments recommendation page. The client may select a spa treatment, for example, a facial. Furthermore, the spa treatment may be customized for the client. In step 806, the results and recommendations are saved in the Skin state history section of the client's record. Additionally, the Product/Treatment sections are saved for future reference, reporting, and marketing. In stepped 807, the concierge exits from the Skin state portion into the main section of the client record.

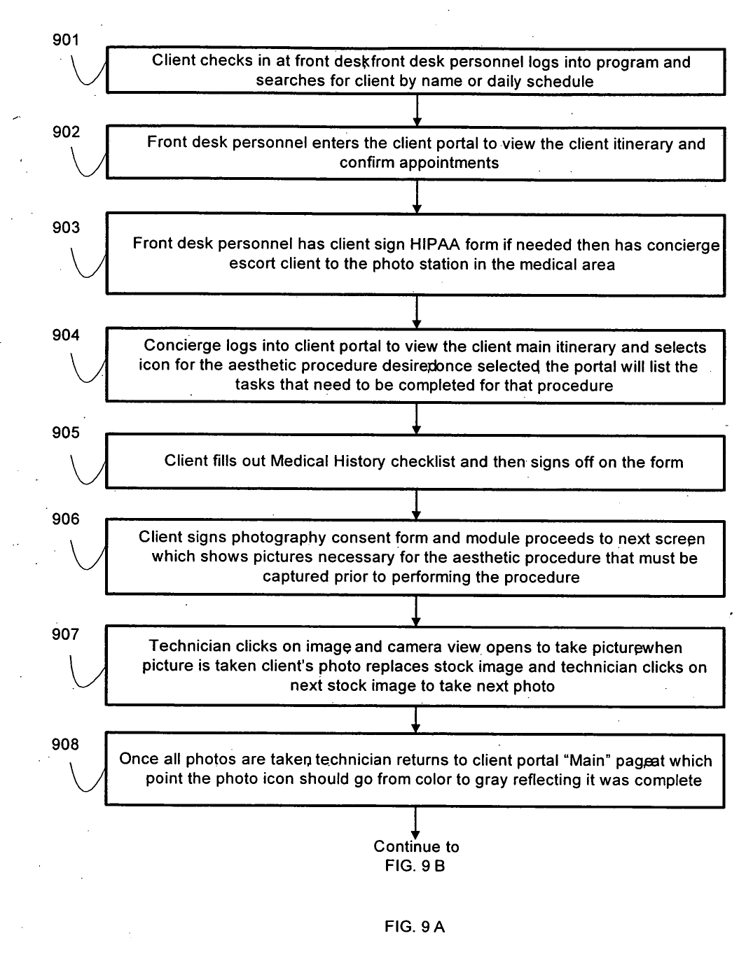

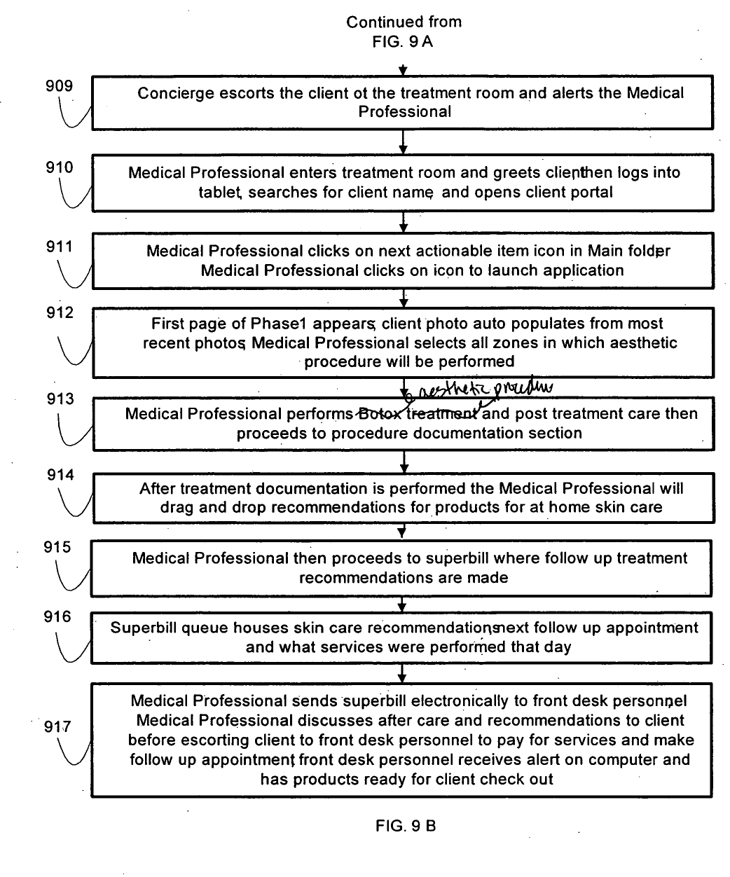

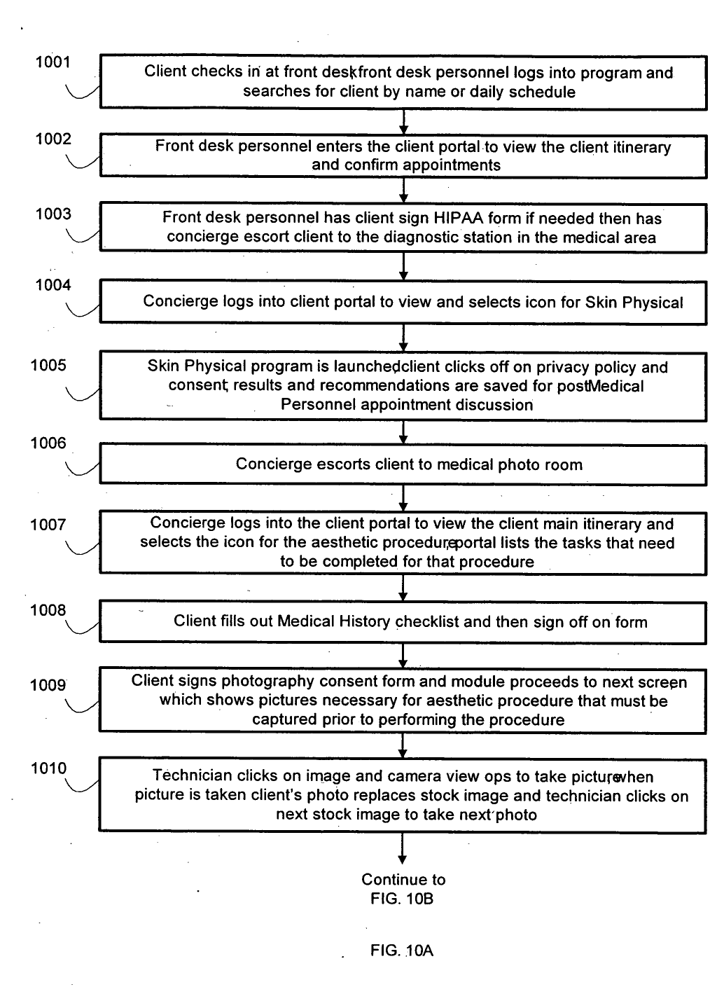

FIG. 9A-9B illustrate an embodiment of the invention in which the concierge performs an aesthetic procedure with or without performing a Skin state. The aesthetic procedure may be any procedure contemplated by the inventors above including, but not limited to, Botox, laser hair removal, photo rejuvenation, skin therapy, subtopicals. In step 901, the client checks in at the front desk. The front desk personnel, or receptionist, logs onto the expert system and searches for the client by name or by daily schedule. In step 902, the receptionist enters the client record/portal to view the client's itinerary and confirm appointments. In step 903, the receptionist has the client sign a HIPAA form which may be an electronic form, if necessary. Then the concierge escorts the client to a photo station in a medical area. In step 904, a concierge logs into the clients record to view the client's itinerary and select the icon for aesthetic procedure. The concierge may be a technician, escort, medical personnel, front desk personnel, and the like. This brings up the screen that list the tasks that need to be completed. Preferably, the tasks are best practices safety/efficacy protocols. In step 905, the client fills out a medical history checklists and then signs off on that form. In step 906, the concierge brings up a photography consent form that the client preferably signs. In a preferred embodiment, the forms are automated by procedure type/date of last execution. Upon signing, the expert system proceeds to the screen that shows the concierge which pictures are necessary for performance of the aesthetic procedure.

In step 907, a series of camera views are presented informing the concierge what views should be taken. In a preferred embodiment, the views are standardized by a best practices protocol. The concierge selects the first image on the screen and a camera view is opened. When the client's photo is taken, the photo replaces the first view on the screen. The concierge continues on to the next image and takes the next photograph. This continues until all of the suggested photographs are taken. In step 908, the concierge returns to the main page of the client's record. Preferably, the photo icon is gray indicating that all of the photographs were taken. In step 909, the concierge escorts the client to a treatment room and alerts a medical professional. The medical professional may be, for example, a nurse practitioner, technician, or a doctor. In step 910, the medical professional greets the client, logs onto the software system, and accesses the client's medical record from the remote, dynamic database. In step 911, the medical professional clicks on the next icon in the medical record to launch the next application. In step 912, the client's photographs are brought up. The medical professional then selects the zones in which the aesthetic procedure will be performed. In step 913, the medical professional performs the aesthetic procedure and post treatment care. The medical professional will then proceed to the documentation section. In step 914, the medical professional completes the documentation of the procedure and makes recommendations for home skin care/follow-up treatments.

The medical professional, in step 915, proceeds to a post-treatment portion of the system. In the post treatment portion of the system, follow-up treatment recommendations are made. In step 916, the Superbill queue is accessed. The queue includes the recommendations, the next appointment, and a description of what services were just performed. In step 917, the medical professional electronically sends the post treatment queue to the front desk personnel. Additionally, the medical professional discusses the post treatment recommendations with the client. Further, the medical professional escorts the client to the front desk to arrange a payment. The Superbill may be printed out with post care instructions/treatment detail. Preferably, the front desk personnel has the recommended products waiting for the client.

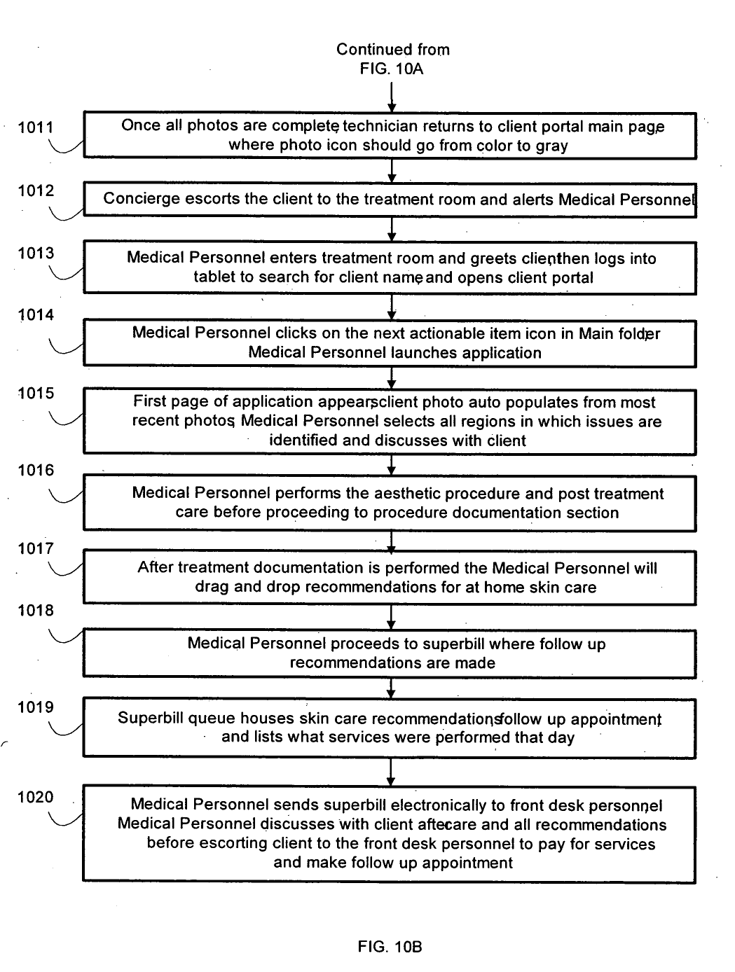

FIG. 10A-10B illustrate an embodiment of the invention in which an aesthetic procedure is performed with a Skin state. In step 1001, the client checks in at the front desk. The front desk personnel, or receptionist, logs onto the expert system and searches for the client by name or by daily schedule. In step 1002, the receptionist enters the client record to view the client's itinerary and confirm appointments. In step 1003, the receptionist has the client sign a HIPAA form, if necessary. Then the concierge escorts the client to a photo station in a medical area. In step 1004, a concierge logs into the clients record to view the client's itinerary and clicks on the Skin state icon. In step 1005, the Skin state program is launched. The client clicks off on the privacy policy and consent. Then the system generates results and recommendations that are saved for future discussion. In step 1006, the concierge escorts the client to a medical photo room.

In step 1007, a concierge logs into the clients record to view the client's itinerary and select the icon for the aesthetic procedure desired. This brings up the screen that list the tasks that need to be completed for that procedure. In step 1008, the client fills out a medical history checklists and then signs off on that form. In step 1009, the concierge brings up a photography consent form which the client signs. Upon signing, the expert system proceeds to the screen that shows the concierge which pictures are necessary for performance of the aesthetic procedure.

In step 1010, a series of camera views are presented informing the concierge which views should be taken. The concierge, or technician, selects the first image on the screen and a camera view is opened. When the client's photo is taken, the photo replaces the first view on the screen. The concierge continues on to the next image and takes the next photograph. This continues until all of the suggested photographs are taken. In step 1011, the concierge returns to the main page of the client's record. Preferably, the photo icon is gray indicating that all of the photographs were taken.

In step 1012, the concierge escorts the client to a treatment room and alerts a medical professional. The medical professional may be, for example, a nurse practitioner or a doctor. In step 1013, the medical professional greets the client, logs onto the system, and accesses the client's medical record. In step 1014, the medical professional clicks on the next icon in the medical record to launch the next application. In step 1015, the client's photographs are brought up. The medical professional then selects the zones in which the laser procedure will be performed. In step 1016, the medical professional performs the aesthetic procedure and post treatment care. The medical professional will then proceed to the documentation section. In step 1017, the medical professional completes the documentation of the procedure and makes recommendations for home skin care.

The medical professional, in step 1018, proceeds to a post-treatment portion of the system. In the post treatment portion of the system, follow-up treatment recommendations are made. In step 1019, the Superbill queue is accessed. The queue includes the recommendations, the next appointment, and a description of what services were just performed. In step 1020, the medical professional electronically sends the post treatment queue to the front desk personnel. Additionally, the medical professional discusses the post treatment recommendations with the client. Further, the medical professional escorts the client to the front desk to arrange a payment and schedule follow up appointments. Preferably, the front desk personnel has the recommended products waiting for the client.

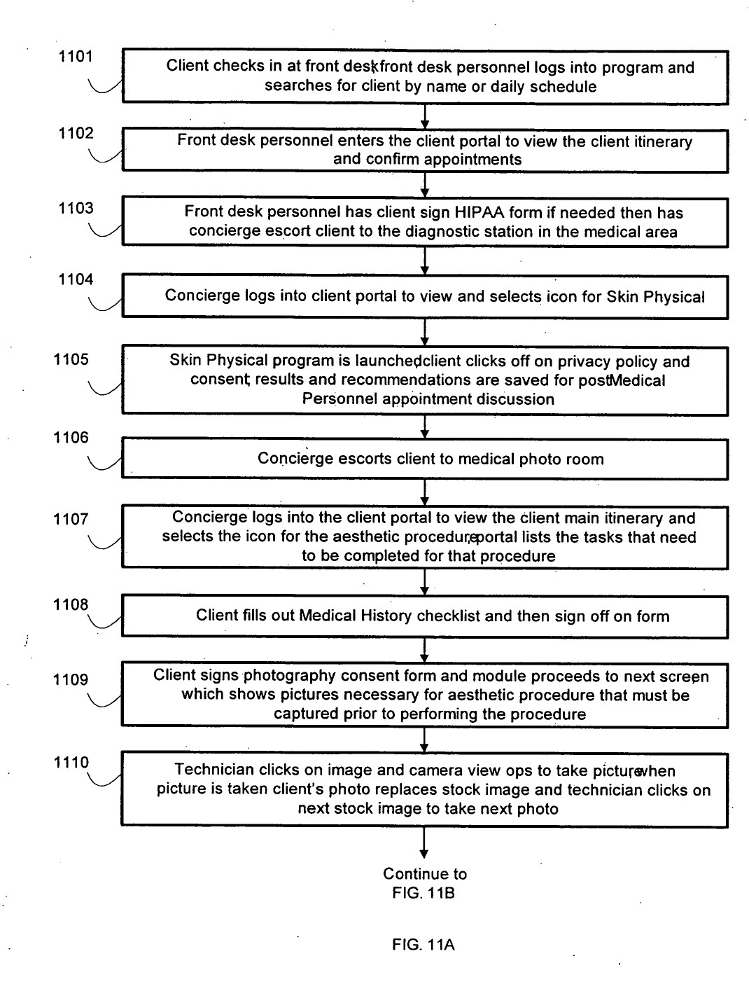

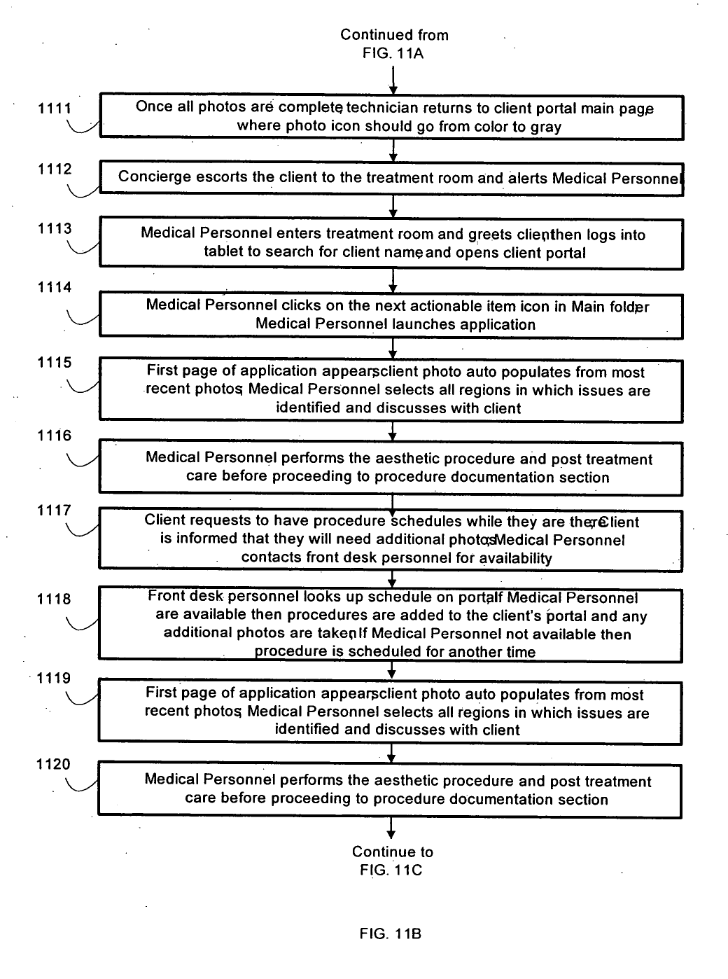

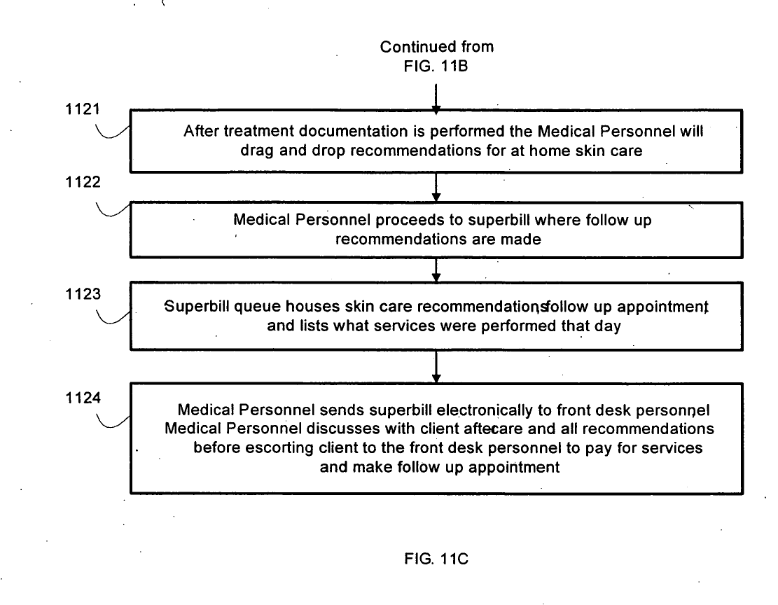

FIG. 11A-11C illustrate an embodiment of the invention whereby a user, i.e., client or patient, undergoes an aesthetic procedure and client schedules future procedures. In step 1101, the client arrives at the business location, and checks in at the front desk or reception area. The front door personnel, or receptionist, logs in to the client portal of the software system and locates the client by name to find the client schedule. In step 1102, the receptionist accesses the client's itinerary and confirms their appointment. In step 1103, the client signs a HIPPA form before the concierge, or technician, escorts the client to the diagnostic station in the medical area.

In step 1104, the concierge logs into the client portal to access a diagnostic tool. In step 1105, the client reads the privacy policy and gives consent for any medical procedures. In step 1106, the client is escorted to the medical photo room by a concierge. In step 1107, the medical photo room, the concierge can log into the client portal to find the client's itinerary and access the aesthetic improvement procedures the client would like performed that day. In step 1108, the concierge confirms that the client has filled out a medical history checklist. In step 1109, the client signs a photography consent form, and the client and/or concierge may optionally view the pictures that are to be taken prior to performing the aesthetic improvement procedure. In step 1110, the concierge clicks on the stock image on the client portal page that enables the camera to take a picture. Further, it is contemplated that the client's photo taken would then replace the stock image on the computer screen. This procedure repeats until all photographs necessary are taken. In step 1111, the concierge returns to the main page of the client portal and the photo icon changes shape, color, or display text to show that the photographs are completed. In step 1112, the concierge then escorts the client to the treatment room and notifies a medical professional. The medical professional may be, for example, a nurse practitioner, technician, or a doctor.

In step 1113, the medical professional greets the client and logs into a tablet or computer to search for the client name. In step 1114, the medical professional launches the client portal. In step 1115, the graphical representation in the client portal shows a recent client photograph, whereby the medical professional can select the zones that need the aesthetic improvement and discuss the procedures with the client. In step 1116, the medical professional proceeds summarize the recommended services zone by zone and the medical professional recommends specific treatment times. In step 1117, the client and the nurse practitioner review the recommended treatment times, and the client requests to have the aesthetic improvement performs today or set up future dates with the concierge. In step 1118, the concierge sets up future appointments. In FIG. 1119, a graphical representation in the client portal may show a recent client photograph, whereby the medical professional can select the zones that need the aesthetic improvement and discuss the procedures with the client. In step 1120, the medical professional prepares the equipment, performs the aesthetic improvement, and performs any post-treatment care. In step 1121, the medical professional uses the client portal to find recommended at home skincare products. It is contemplated that the medical professional can drag and drop recommendations from one page of the client portal to another page. In step 1122, the medical professional documents any notes or comments from the procedure in the client portal. In step 1123, the medical professional lists the recommended follow-up care treatment, recommends follow up appointment dates, and notes what services were performed that day on a Superbill. In step 1124, the Superbill is sent electronically from the medical professional to the receptionist. Further, the medical professional discusses with the client the recommended follow-up care before escorting the client to the receptionist to pay for the services and make a follow up appointment.

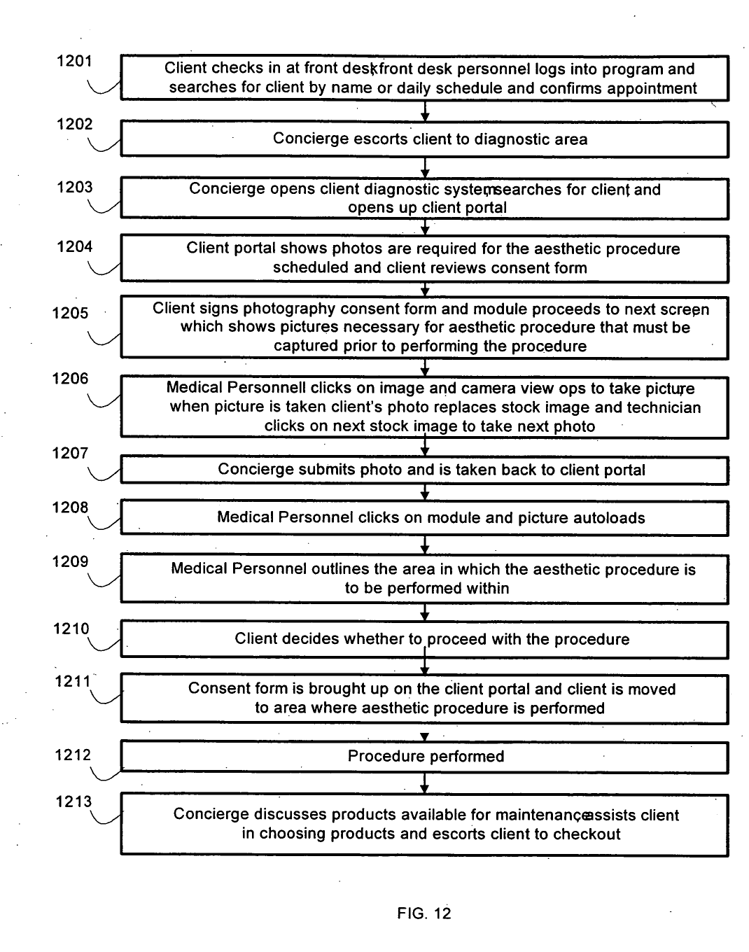

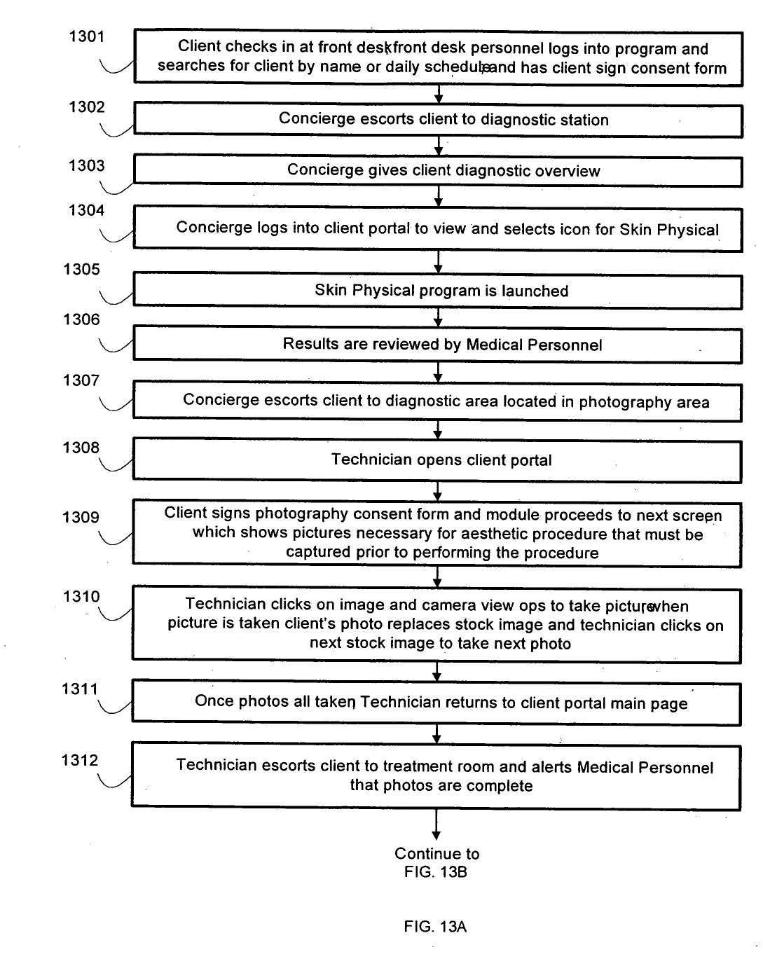

FIG. 12 illustrates an embodiment of the invention whereby a user, i.e., client or patient, undergoes an aesthetic procedure such as brow shaping or tooth whitening. In step 1201, the client arrives at the business location and the client checks in at the front desk or reception area. The front door personnel, or receptionist, logs in to the client portal, locates the client by name, and loads the HIPPA form if needed for the client to sign. In step 1202, the concierge, or technician, or medical professional, or front desk personnel, then escorts the client to a module or diagnostic station. In step 1203, the concierge logs into the client portal to access a diagnostic tool. In step 1204, the client reads the privacy policy and in step 1205 gives consent for any photos or aesthetic procedures. The client and/or concierge may optionally view the pictures that are to be taken prior to performing the aesthetic improvement procedure. In step 1206, the concierge clicks on the stock image on the client portal page that enables the camera to take the one or more pictures. In step 1207, the client's photo taken replaces the stock image on the computer screen. In step 1208, the concierge returns to the main page of the client portal where the photo icon changes shape, color, or display text to show that the photographs are completed. In step 1209, the photographs are loaded and the concierge may then view the client's photos.

In step 1210, the client and medical personnel discuss the potential changes caused by the aesthetic improvement procedure. In step 1211, the client reviews the procedure and determines if they would like to continue with the procedure. In step 1212, the concierge brings up the consent form for the client to sign. The concierge then moves the client to the aesthetic procedure area and in step 1213, the procedure is performed. In step 1214, the concierge then recommends products for maintenance and escorts the client to check out.

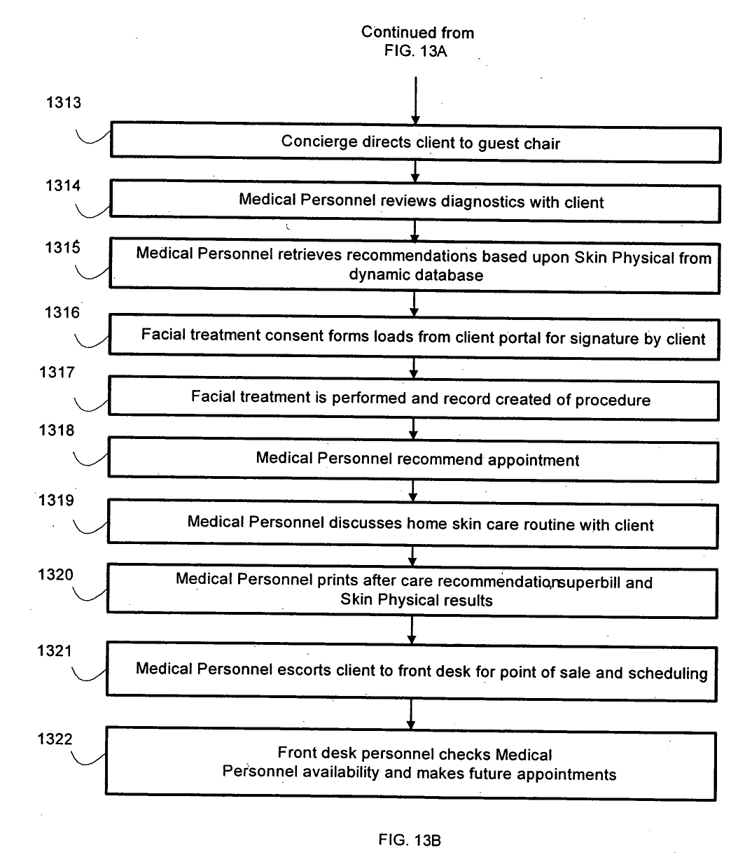

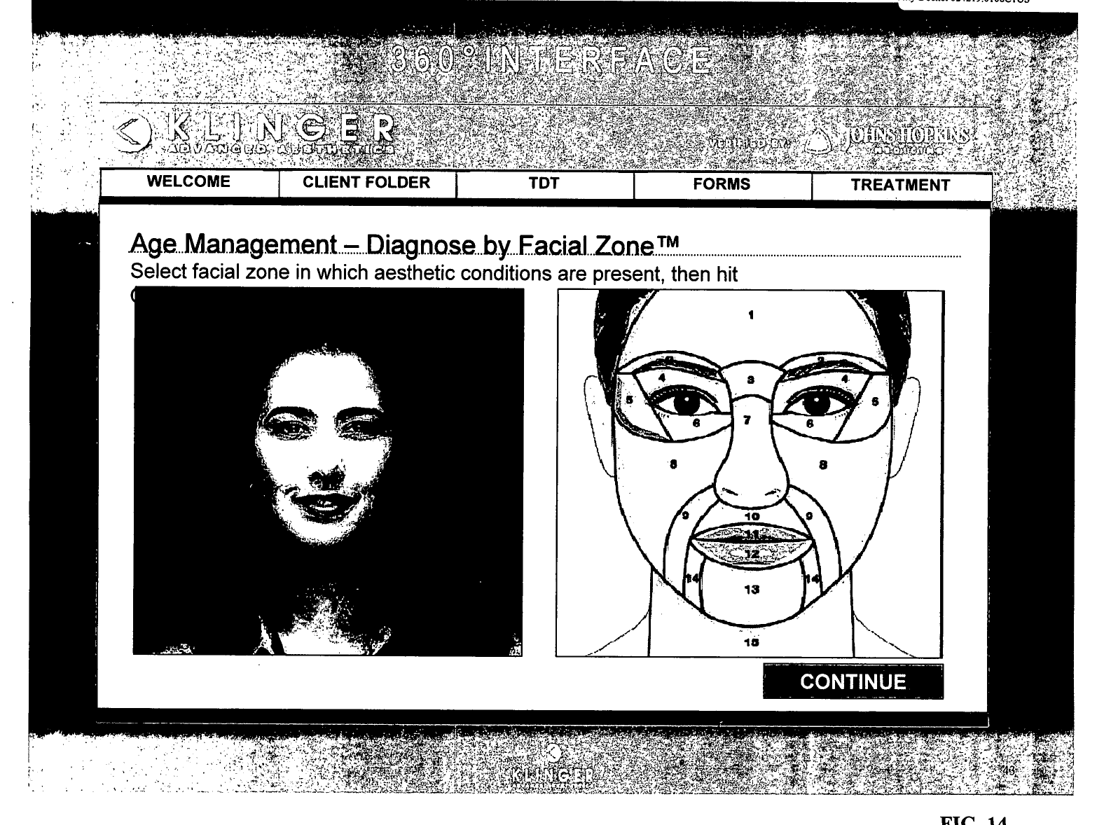

FIG. 13A-13B illustrates an embodiment of the invention whereby a user, i.e., client or patient, undergoes the procedure of facial diagnostic overview. In step 1301, the client arrives at the business location and checks in at the front desk or reception area. The front door personnel, or receptionist, logs in to the client portal and locates the client by name to find the client schedule. The client then signs a HIPPA form before the concierge, or technician, escorts the client to the diagnostic station in the medical area. In step 1302, the concierge escorts the client to a diagnostic station. In step 1303, the concierge gives the client the diagnostic overview. In step 1304, the concierge logs into the client portal to view the aesthetic treatment protocol. In step 1305, the diagnostic tool is launched (see FIG. 8). In step 1306, the results of the diagnostic tool are viewed by an aesthetic professional or medical personnel.

In step 1307, the client is escorted to the medical photography area. In step 1308, the concierge logs into the client portal and locates the photography consent form. In step 1309, the client signs the consent form, and the client and/or concierge may optionally view the pictures that are to be taken prior to performing the aesthetic improvement procedure. In step 1310, the concierge, or technician, or medical personnel, clicks on the stock image on the client portal page that enables the camera to take the one or more pictures. In step 1311, the concierge returns to the main page of the client portal where the photo icon changes shape, color, or display text to show that the photographs are completed. In step 1312, the concierge then escorts the client to the treatment room and notifies the aesthetic professional. In step 1313, the client changes into a robe and then in step 1314 the aesthetic professional reviews the diagnostic findings. In step 1315, the aesthetic professional logs into the client portal and accesses the recommended aesthetic procedures. In step 1316, the aesthetic procedure consent is signed by the client and in step 1317, the procedure is performed. The record of the treatment is also saved in the client portal. In step 1318, an appointment is recommended with a medical professional for diagnostics. In step 1319, after at home skin care routines are discussed, in step 1320 the after care routine, Superbill, and diagnostic results are printed. In step 1321, the client dresses and is then escorted to the front desk in step 1322 for check-out and future appointment scheduling with a medical professional.

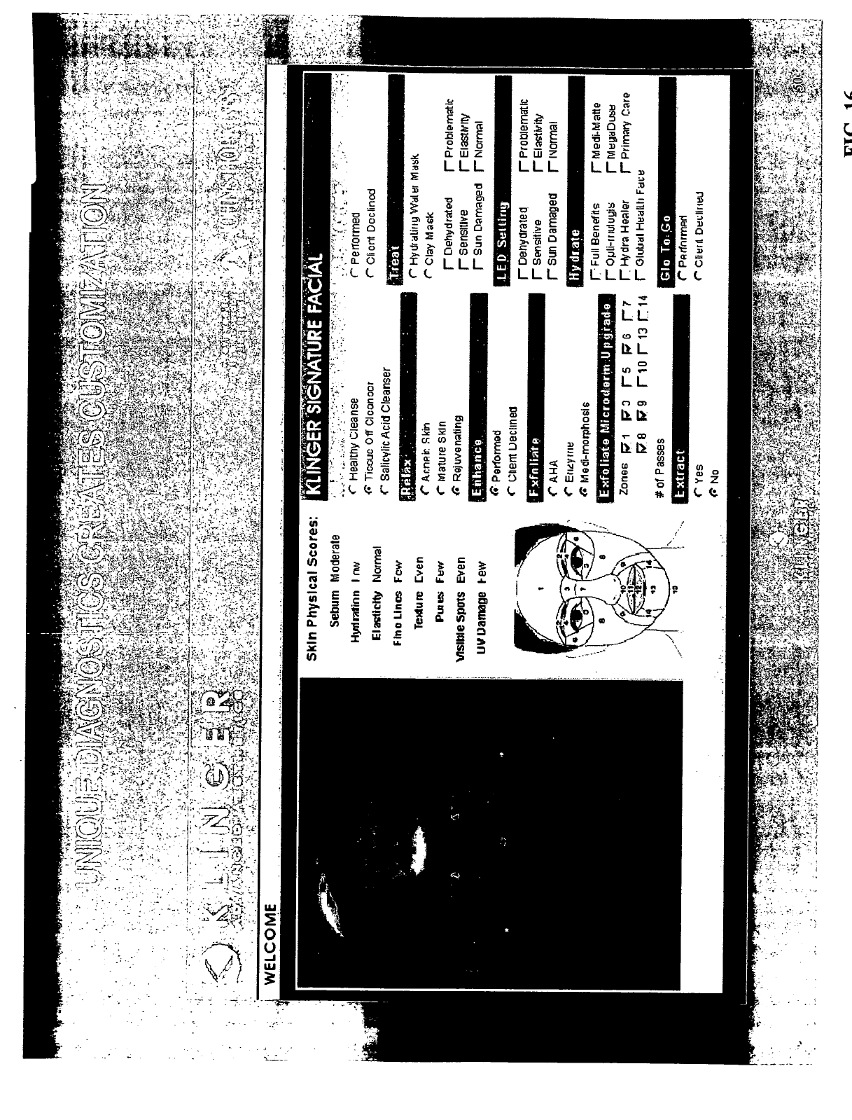

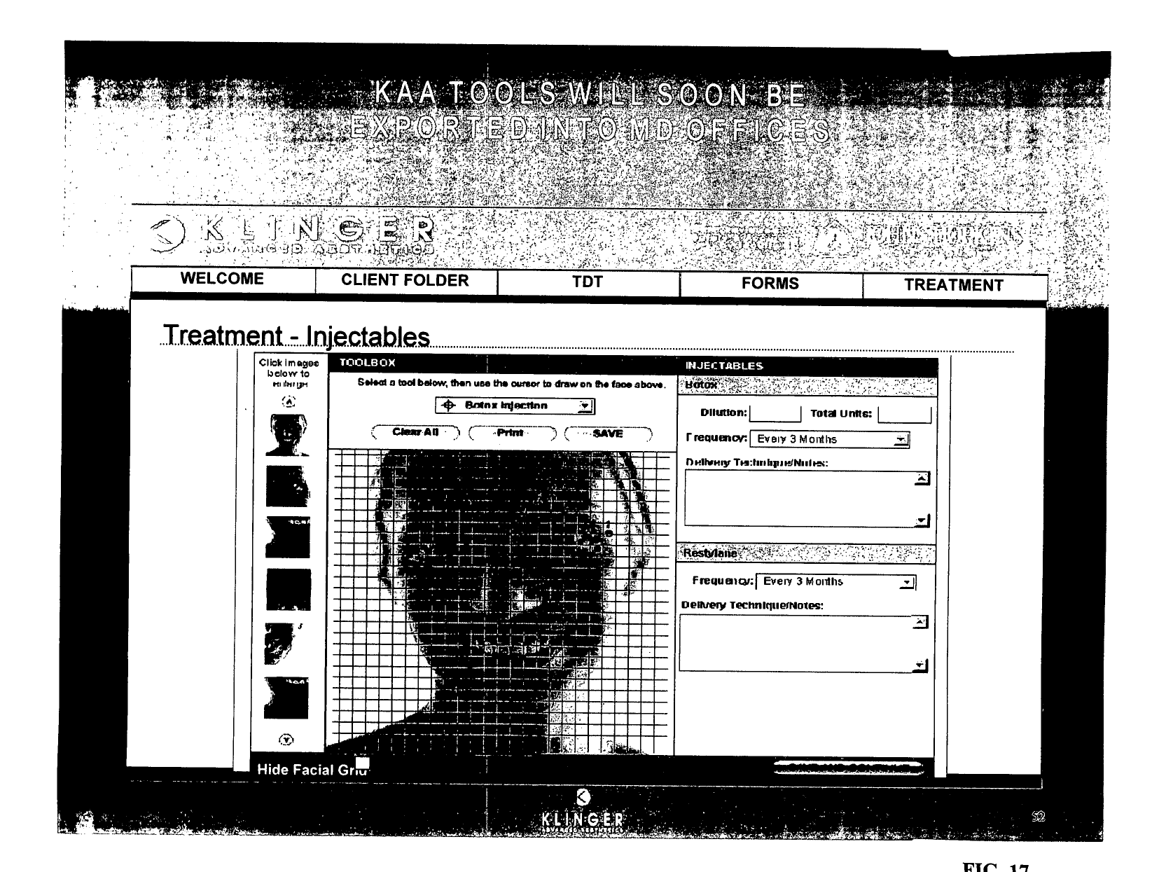

FIG. 14-17 illustrate various methods by which a face may be broken into zones by an electronic mask. The electronic mask allows for the medical professional or software system to review or analyze the parameters of the zones separately as opposed to measuring the parameters of the entire face. In these figures, a medical professional, concierge, or client may locate a facial zone in which an aesthetic condition is present by highlighting the zone by mouse click or touch screen (FIG. 14), by drop-box (FIG. 15), or by check-box (FIG. 16).

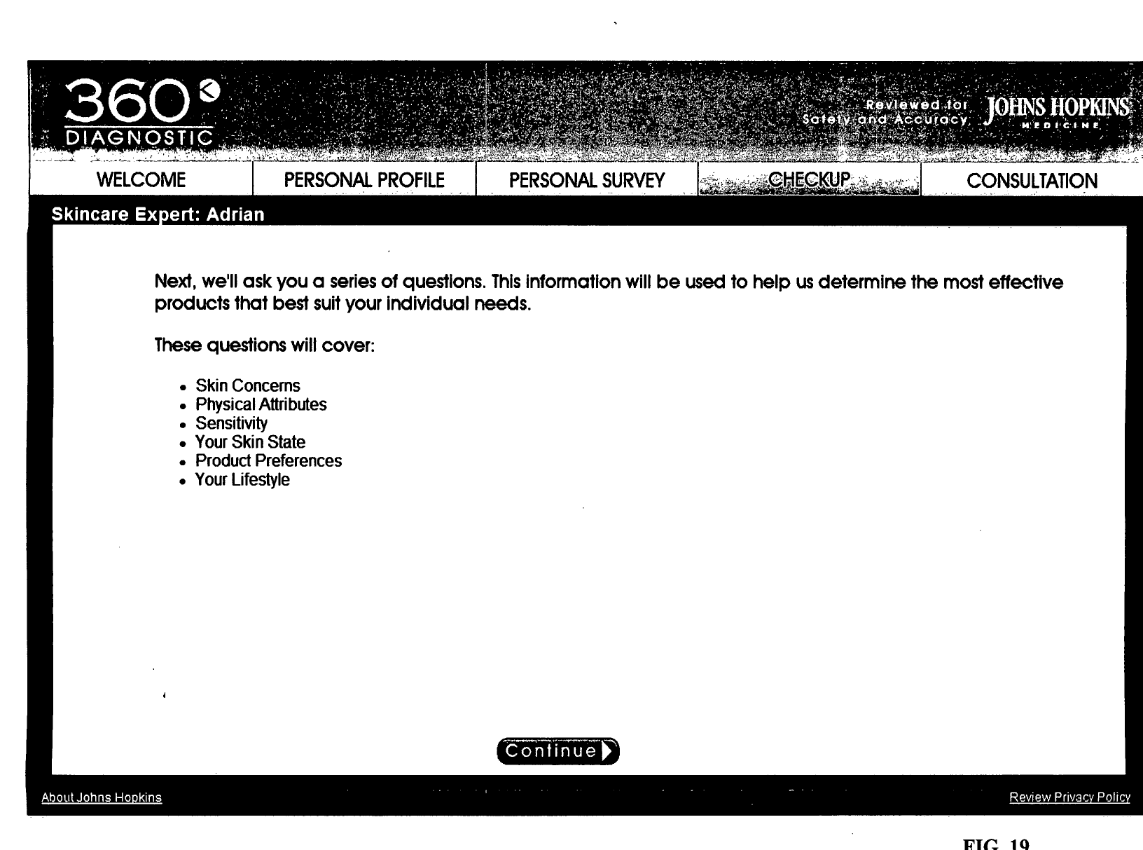

FIG. 18 illustrates one possible layout of treatment rooms of a business location. In this layout, a client enters the location at a reception or greeting area. The reception or greeting area is adjacent to a salon area where aesthetic improvements such as makeup artistry, fashion and eyewear consultation, hair styling, hair coloring, nail services, and non-medical facial related aesthetic procedures may occur. The salon is separate from, but connected to, a medical area. The medical area is the location in which medical aesthetic procedures such as plastic surgery, cosmetic dentistry, laser hair removal, plastic surgery, and cosmetic dermatology occurs.

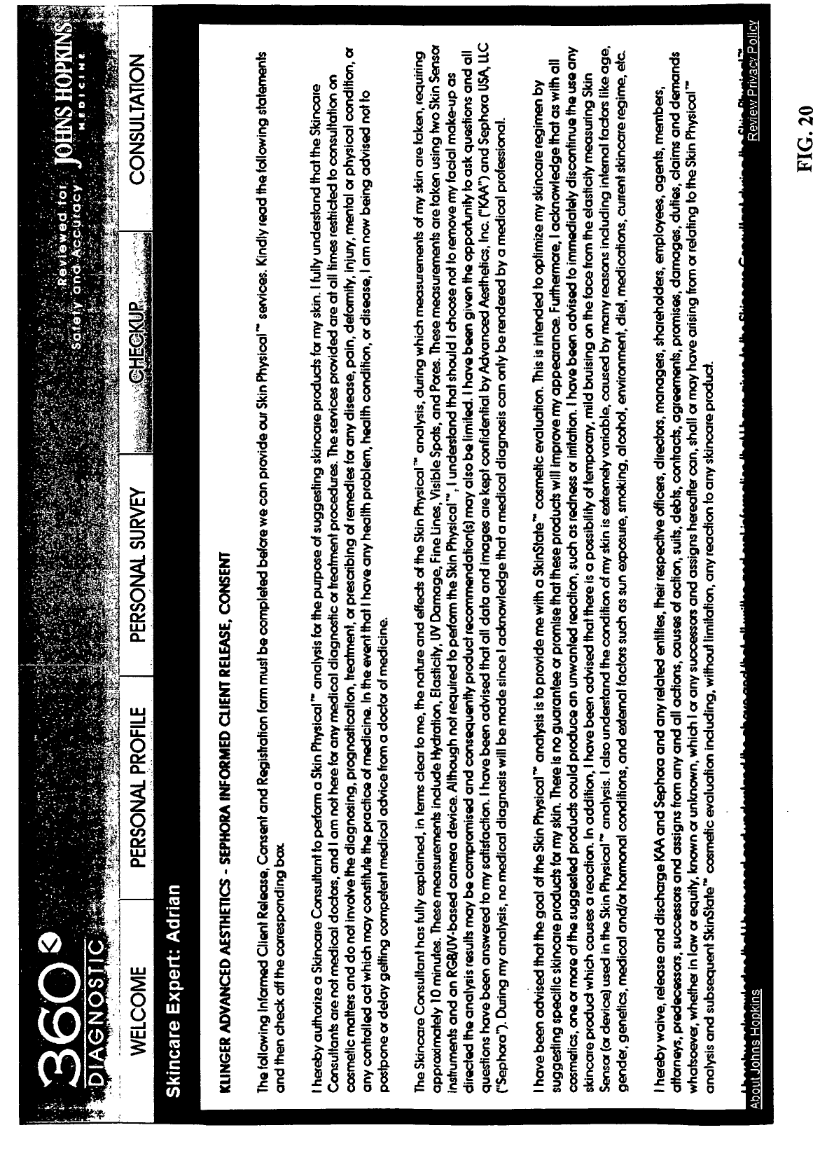

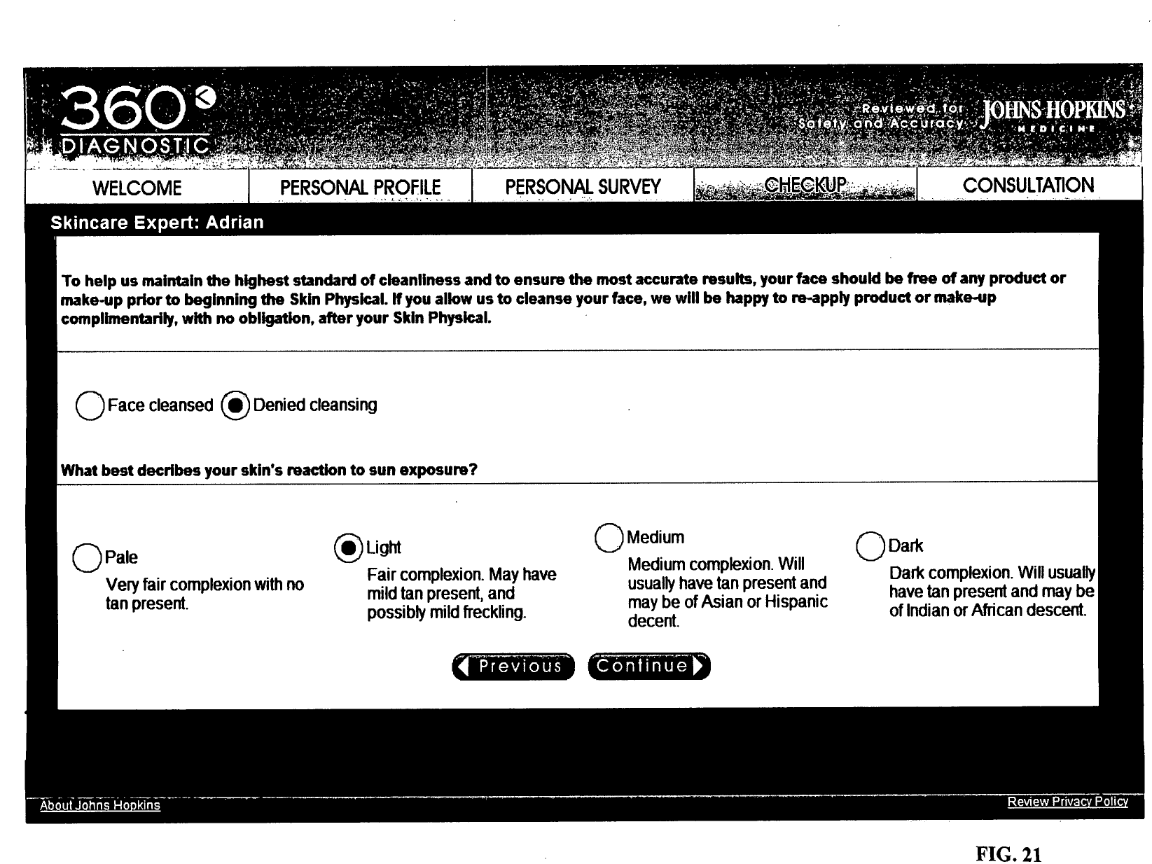

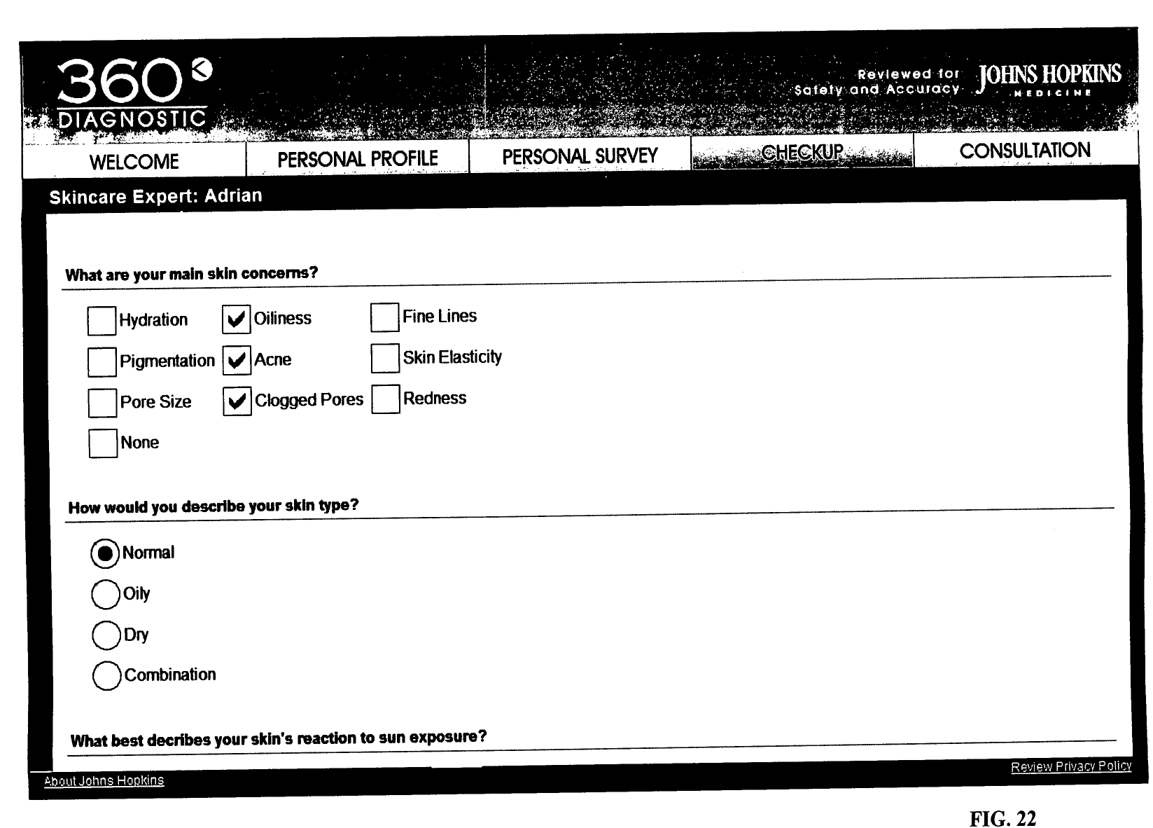

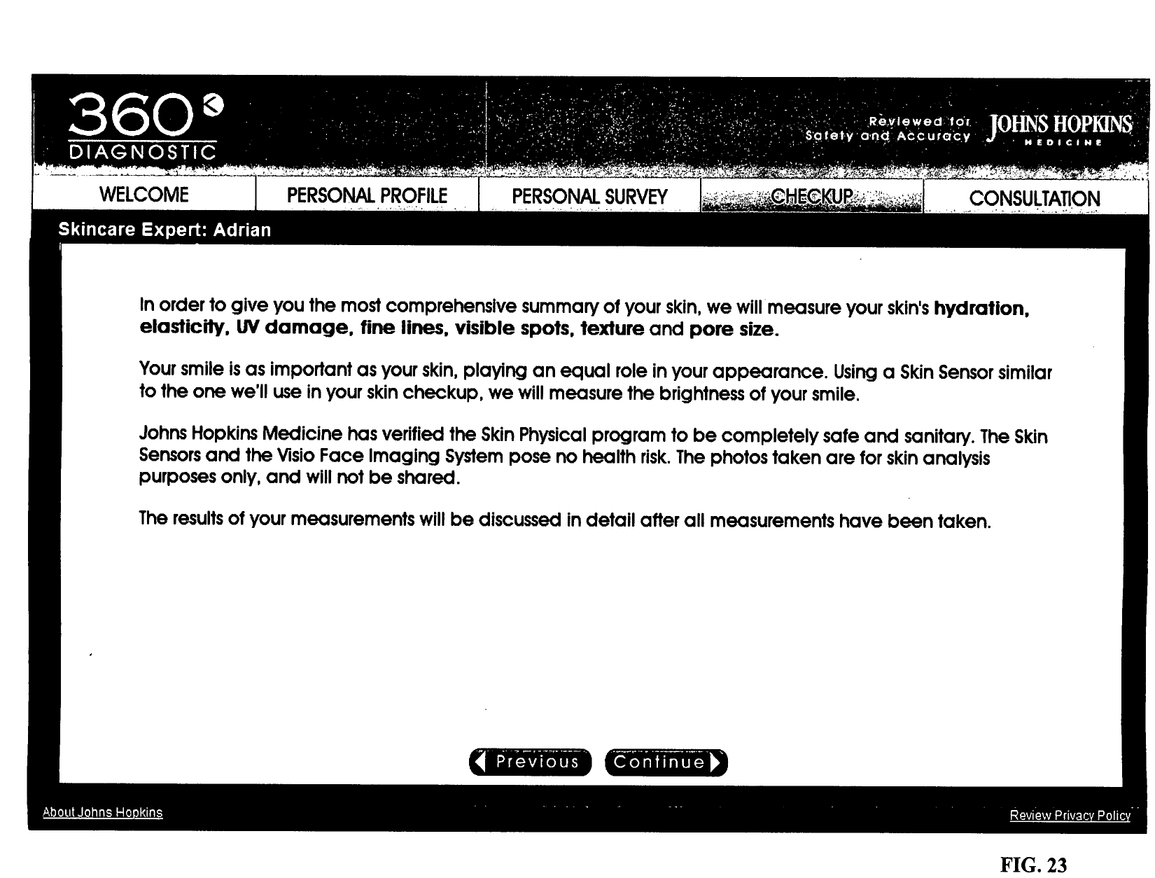

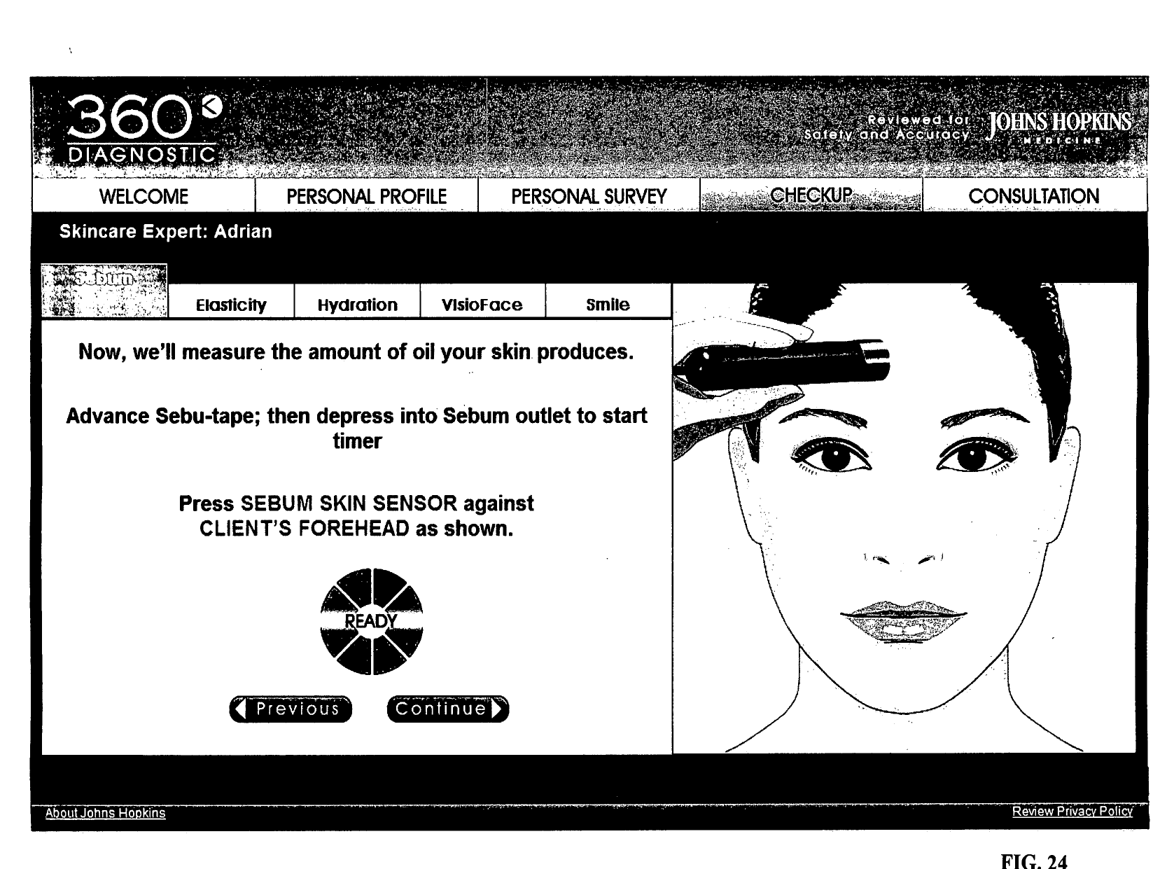

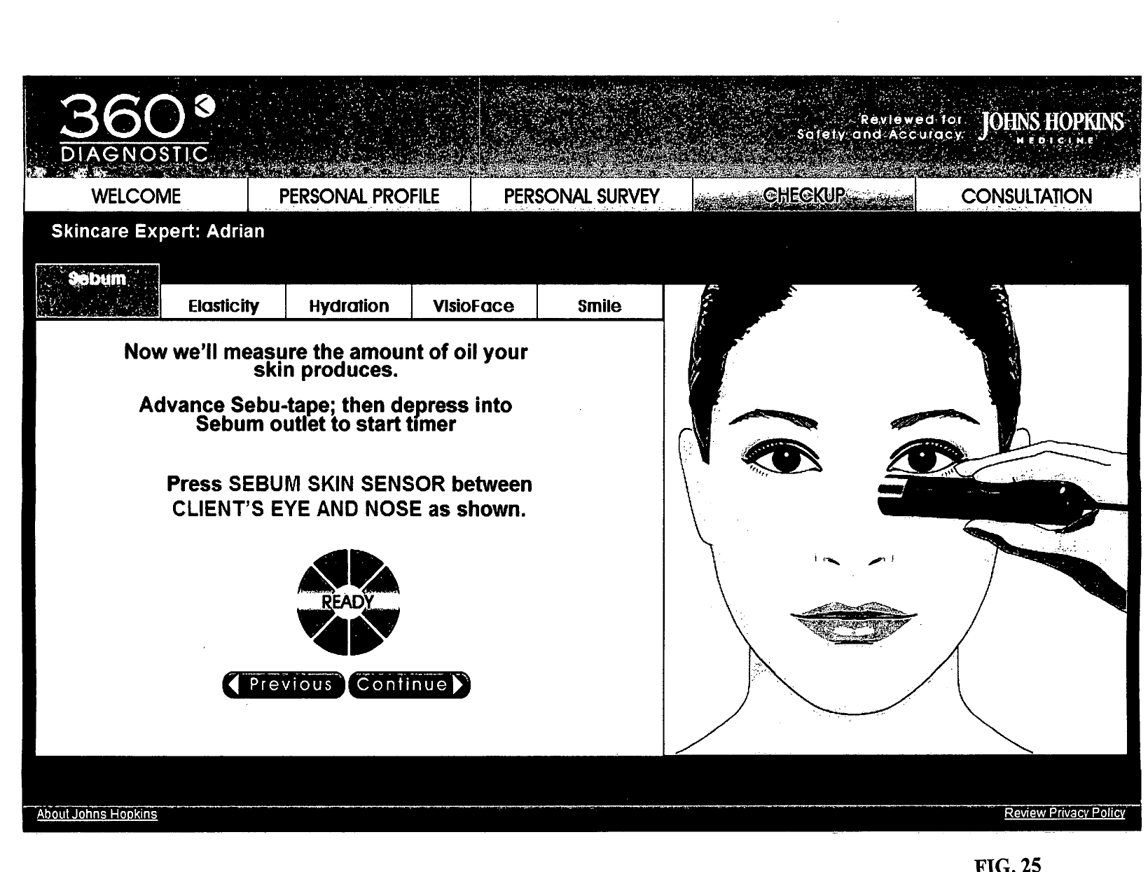

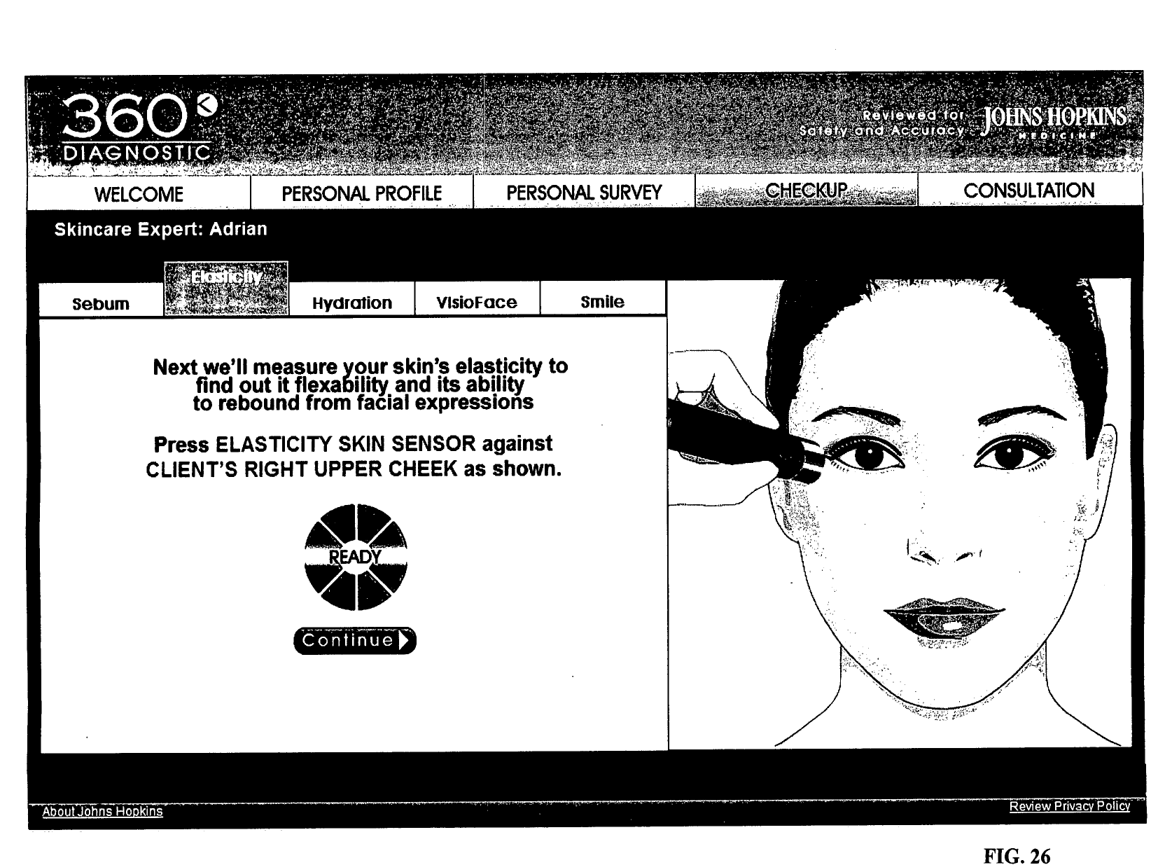

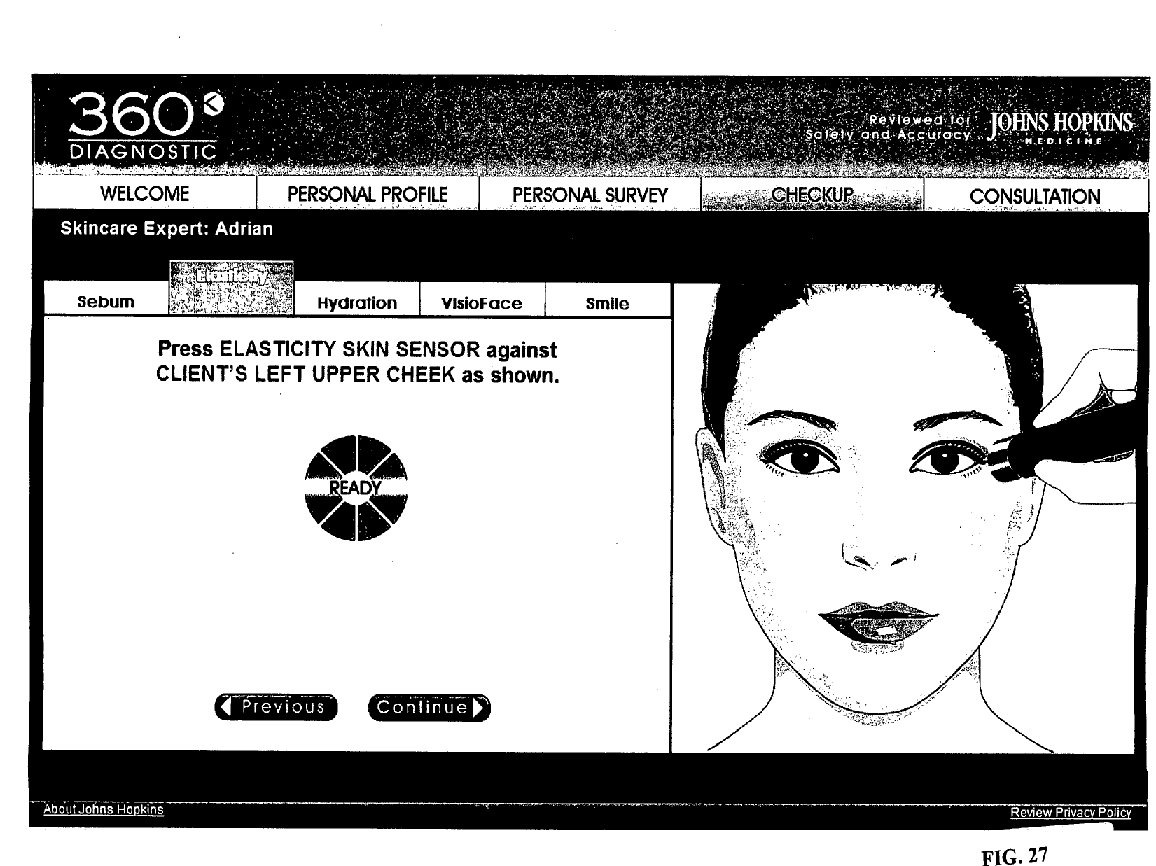

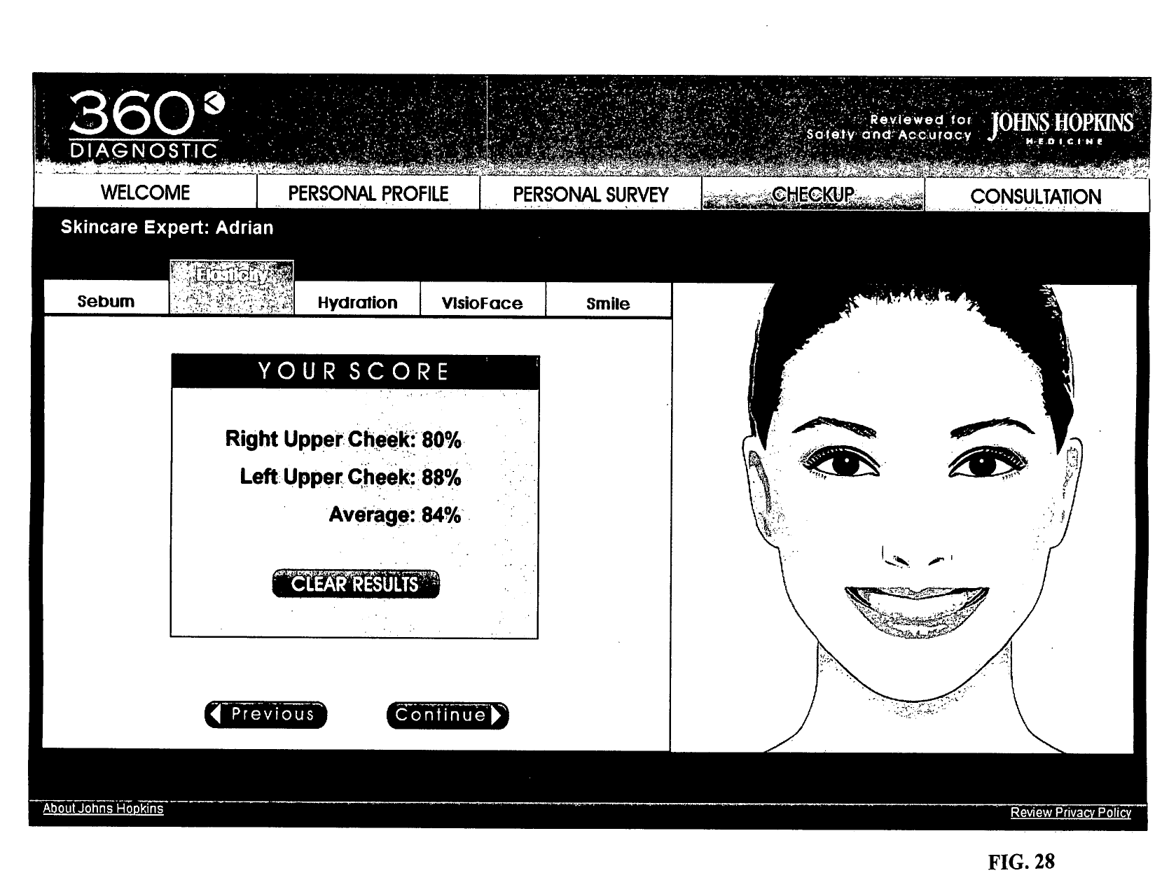

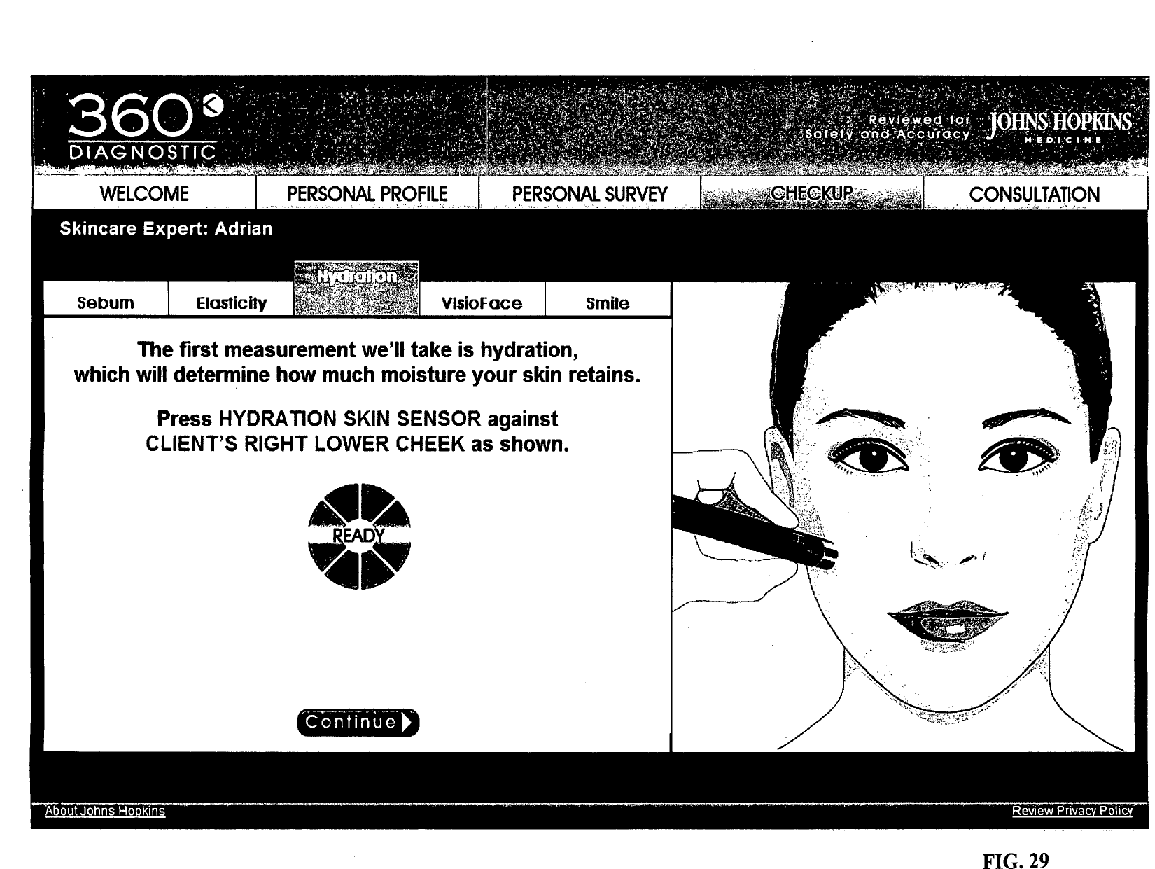

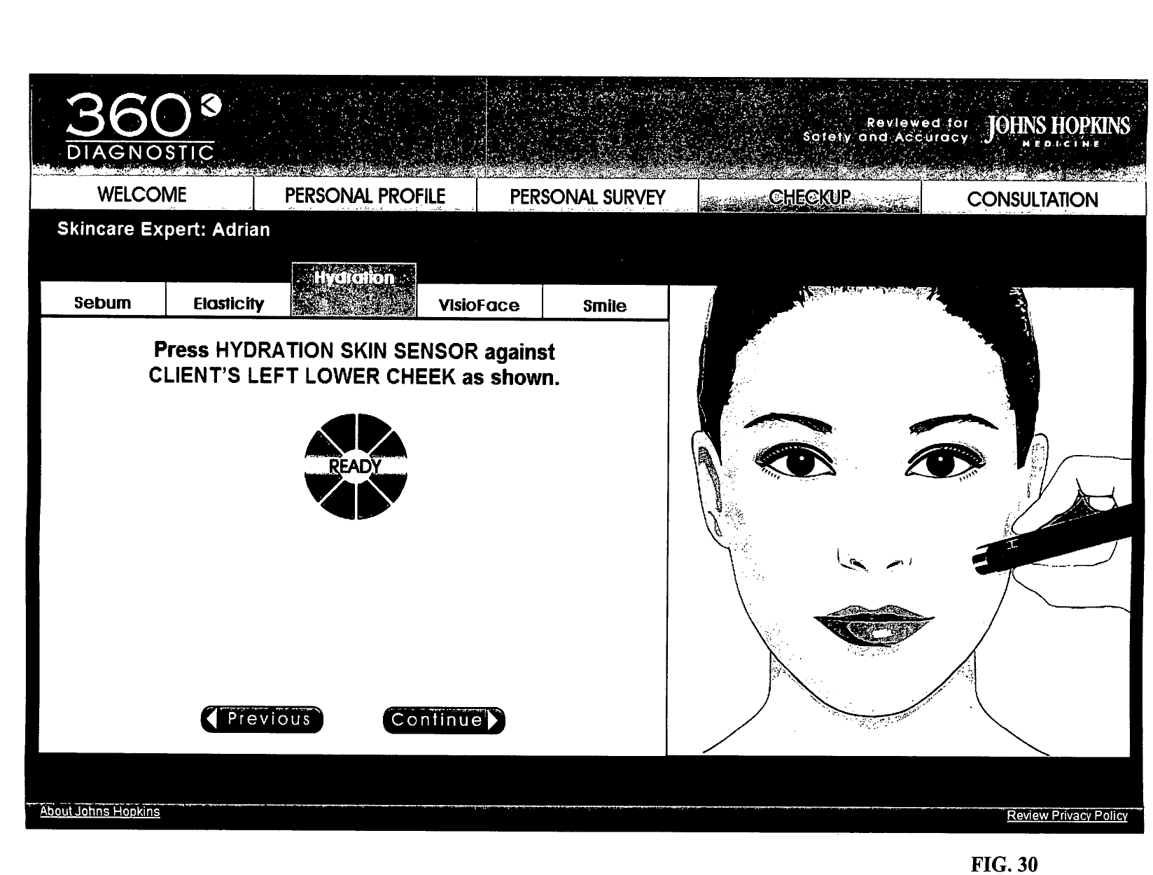

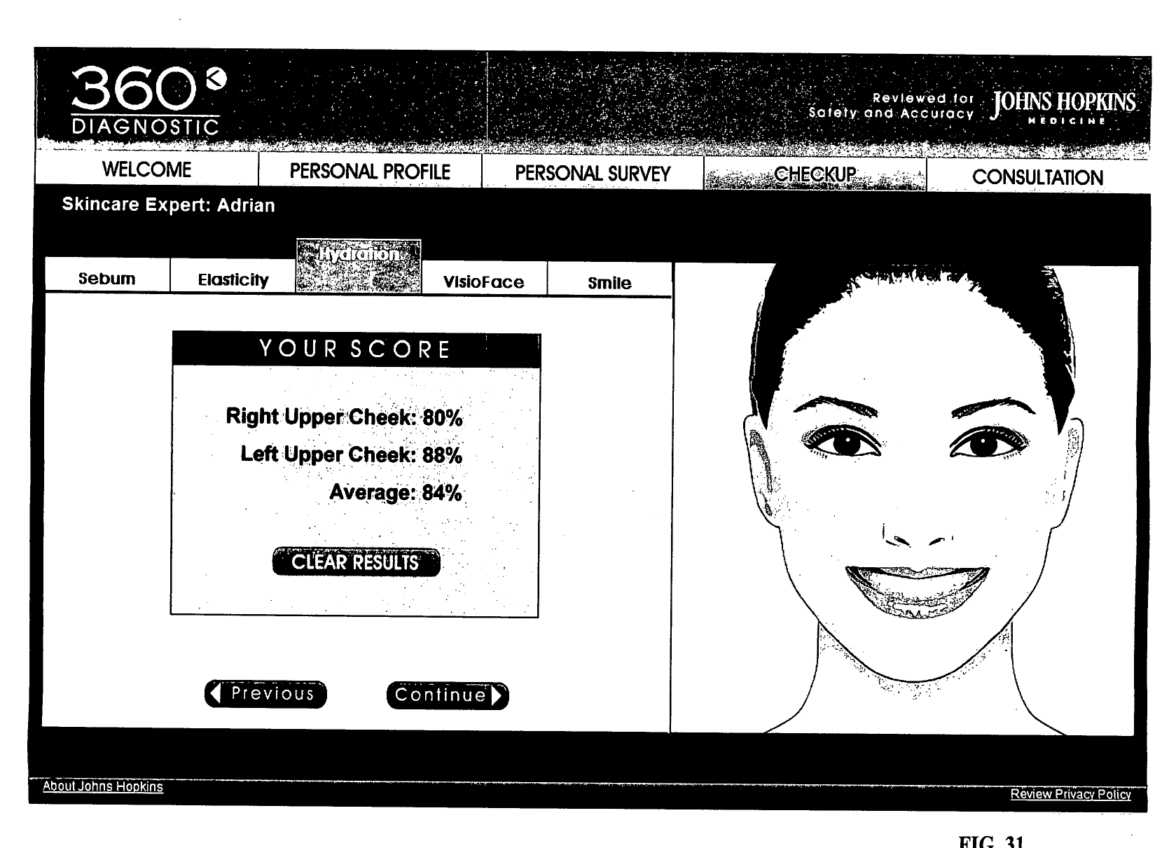

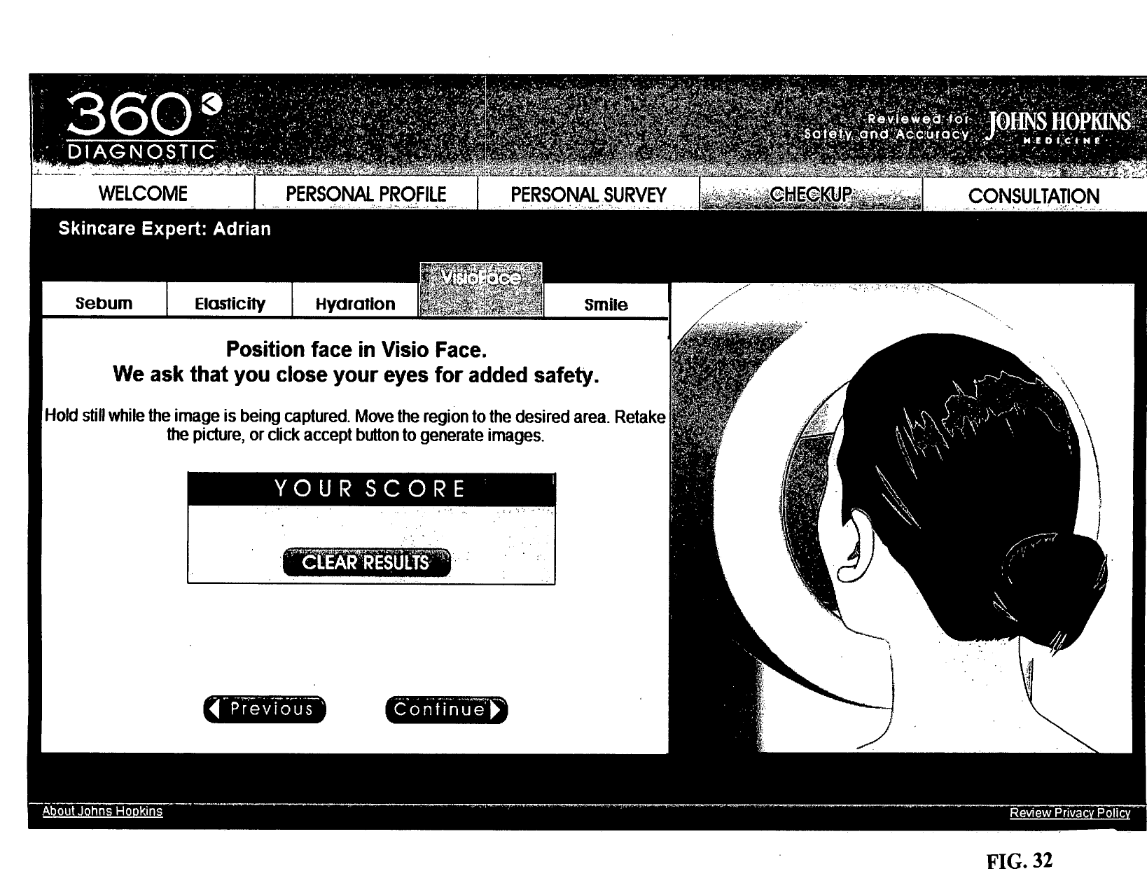

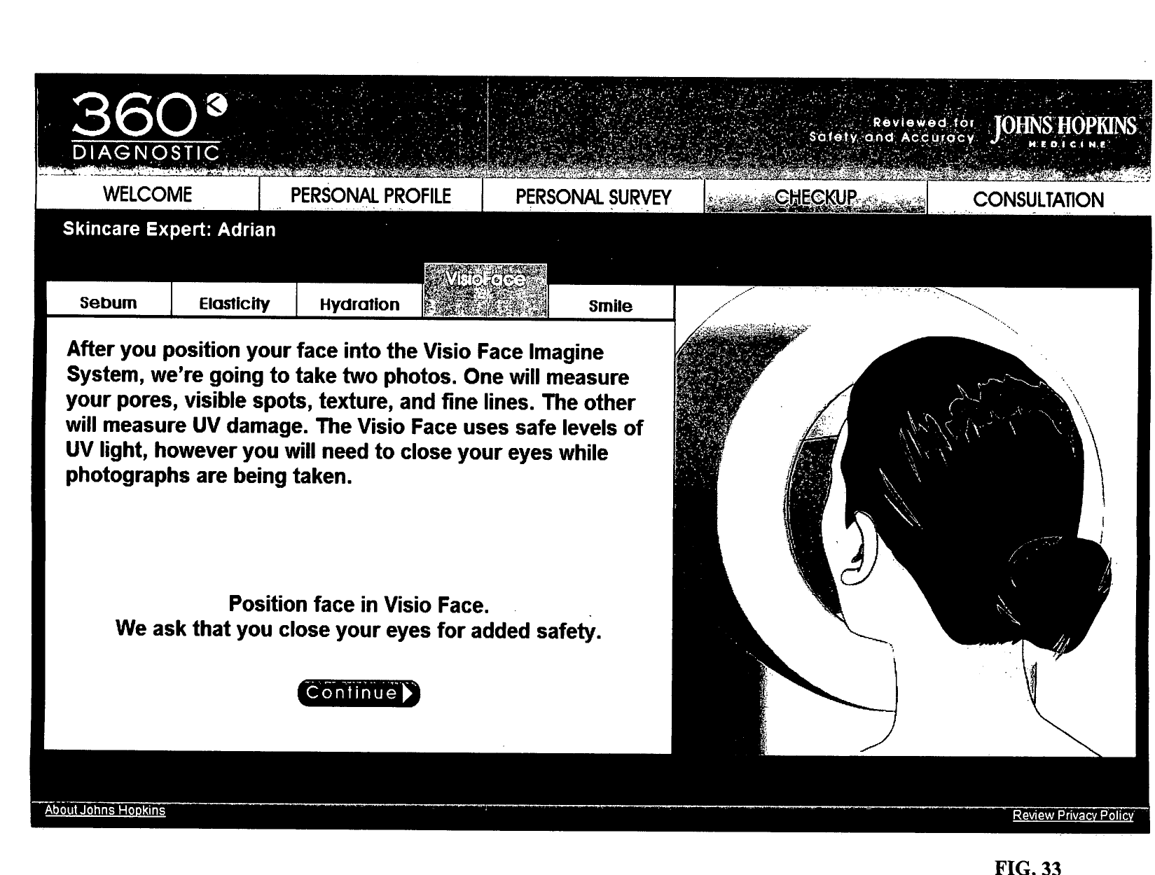

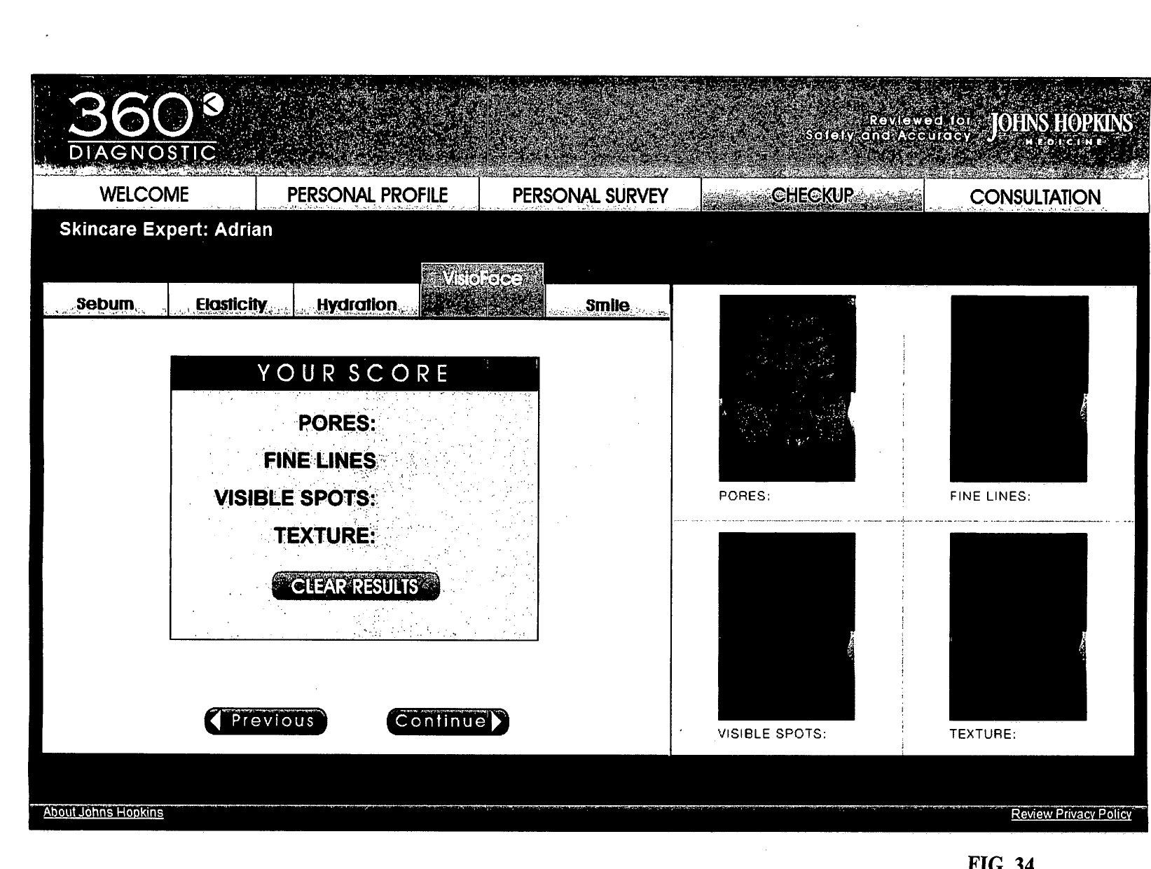

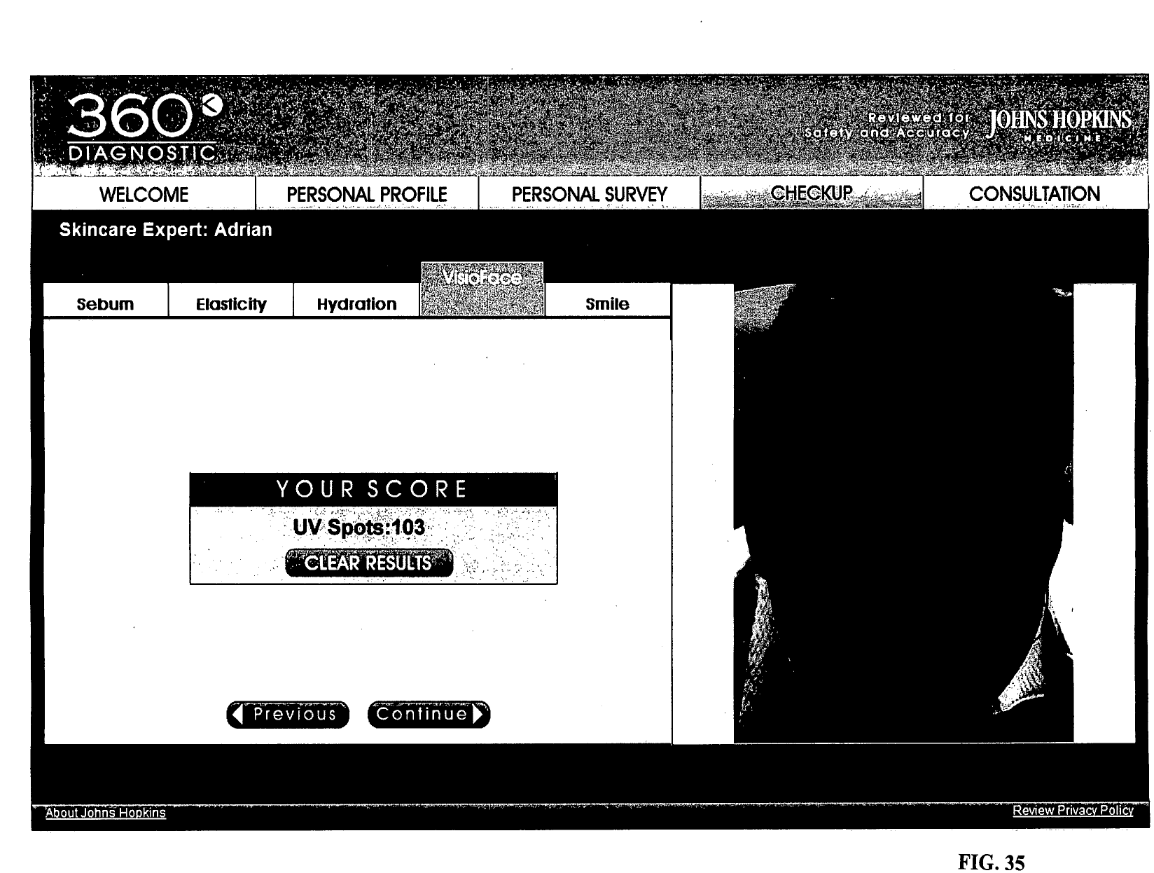

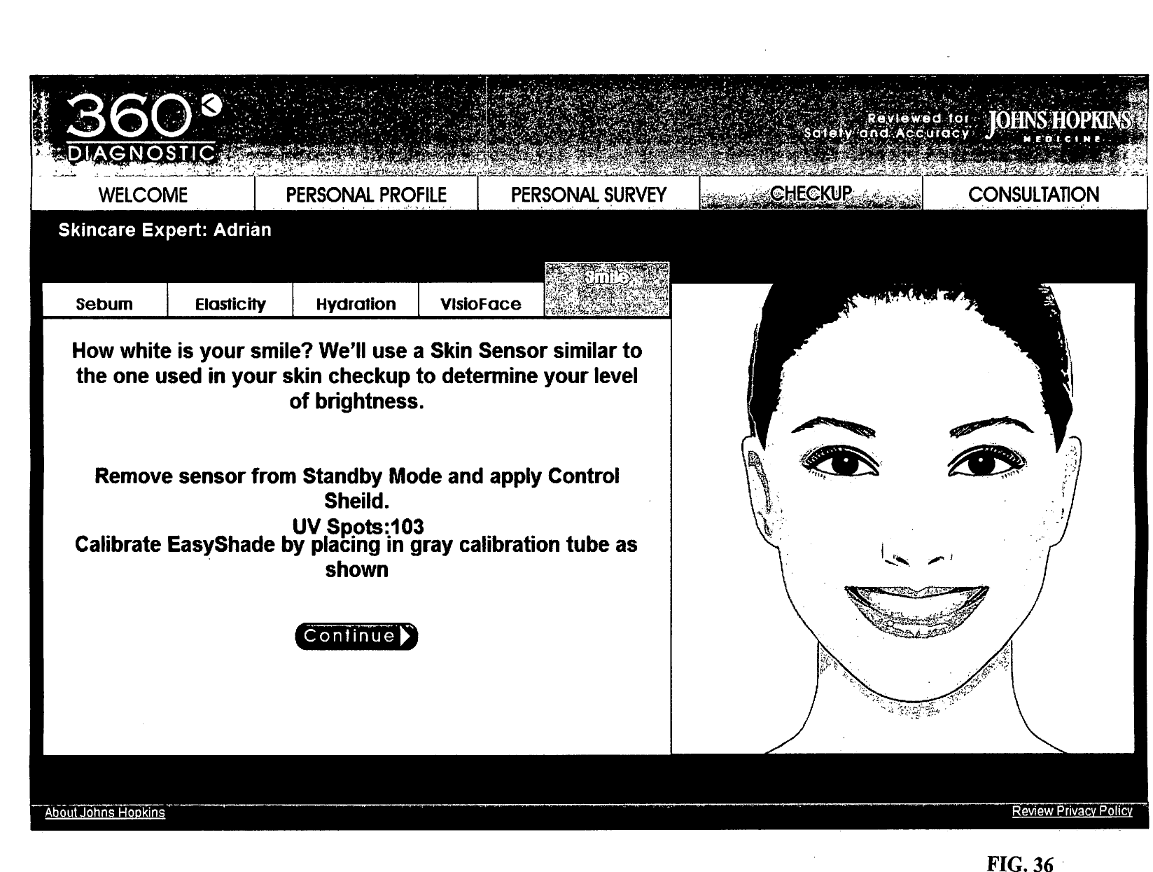

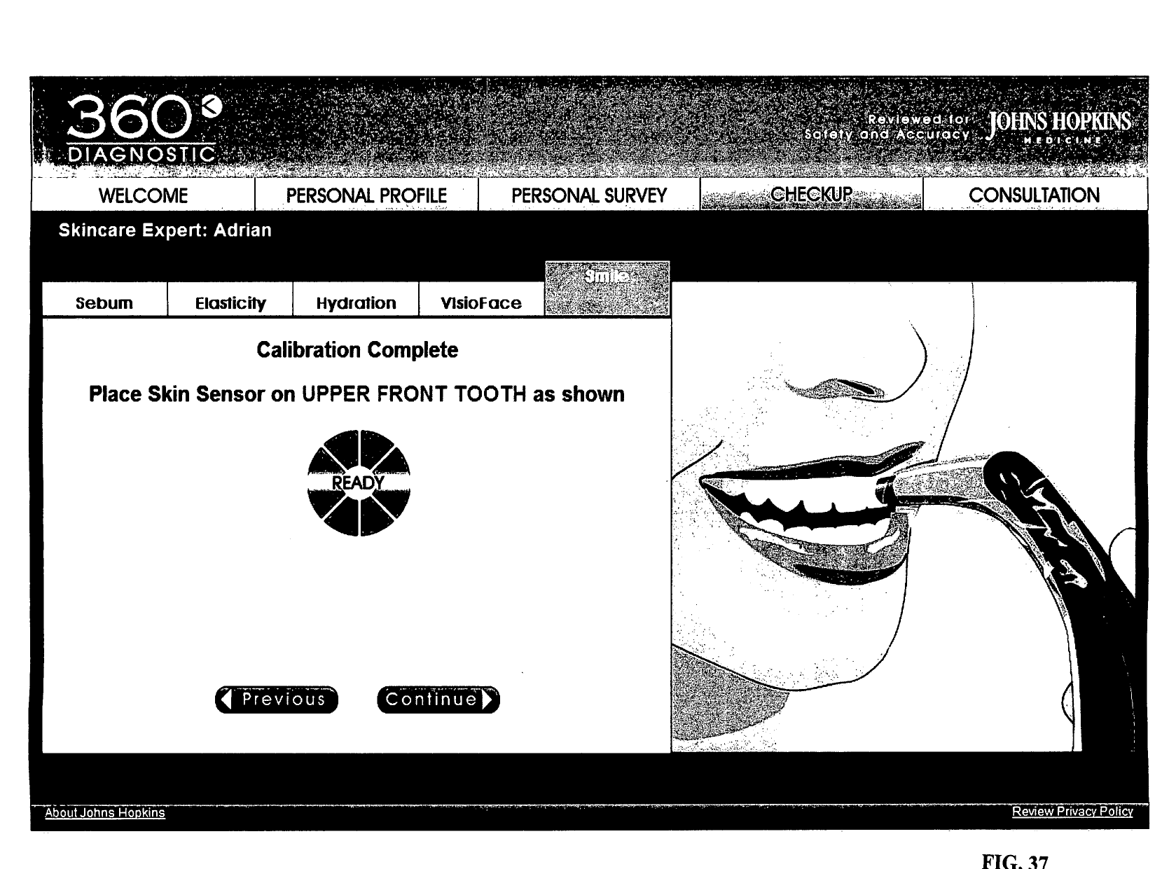

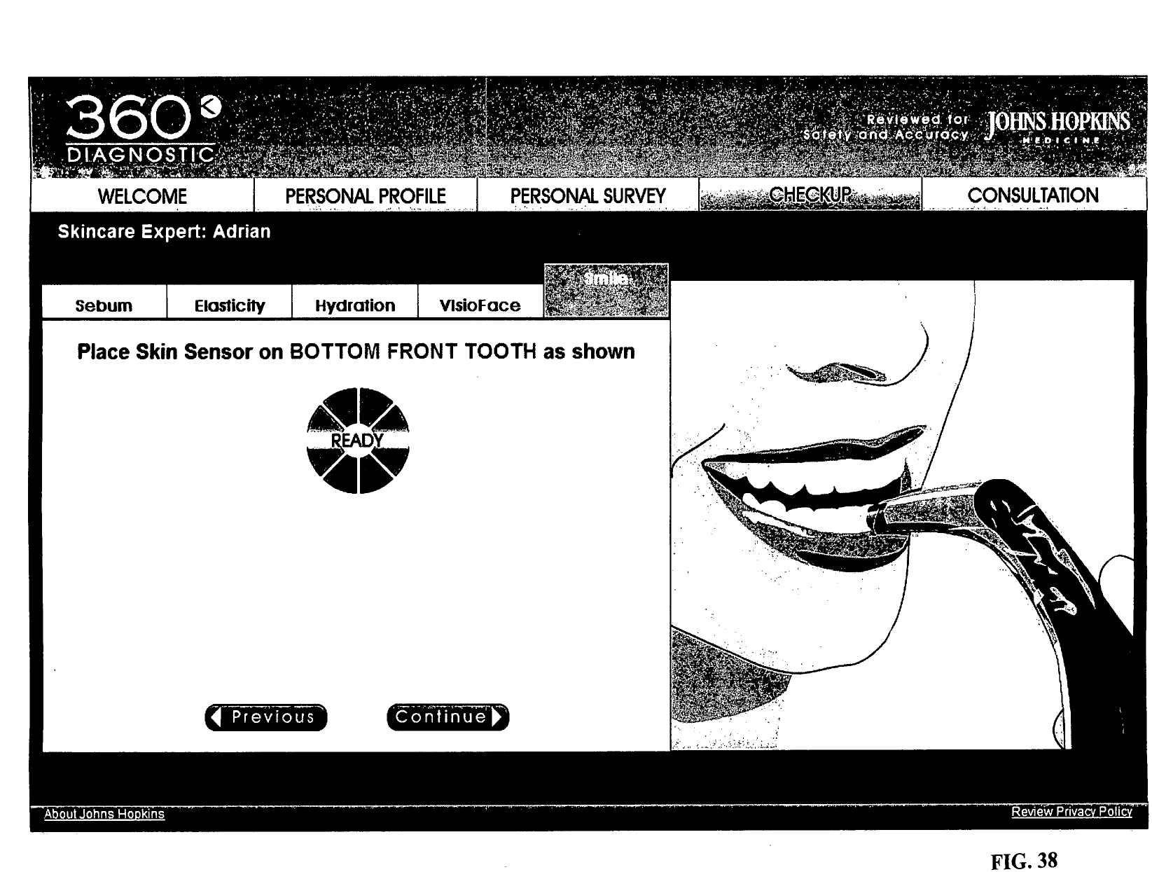

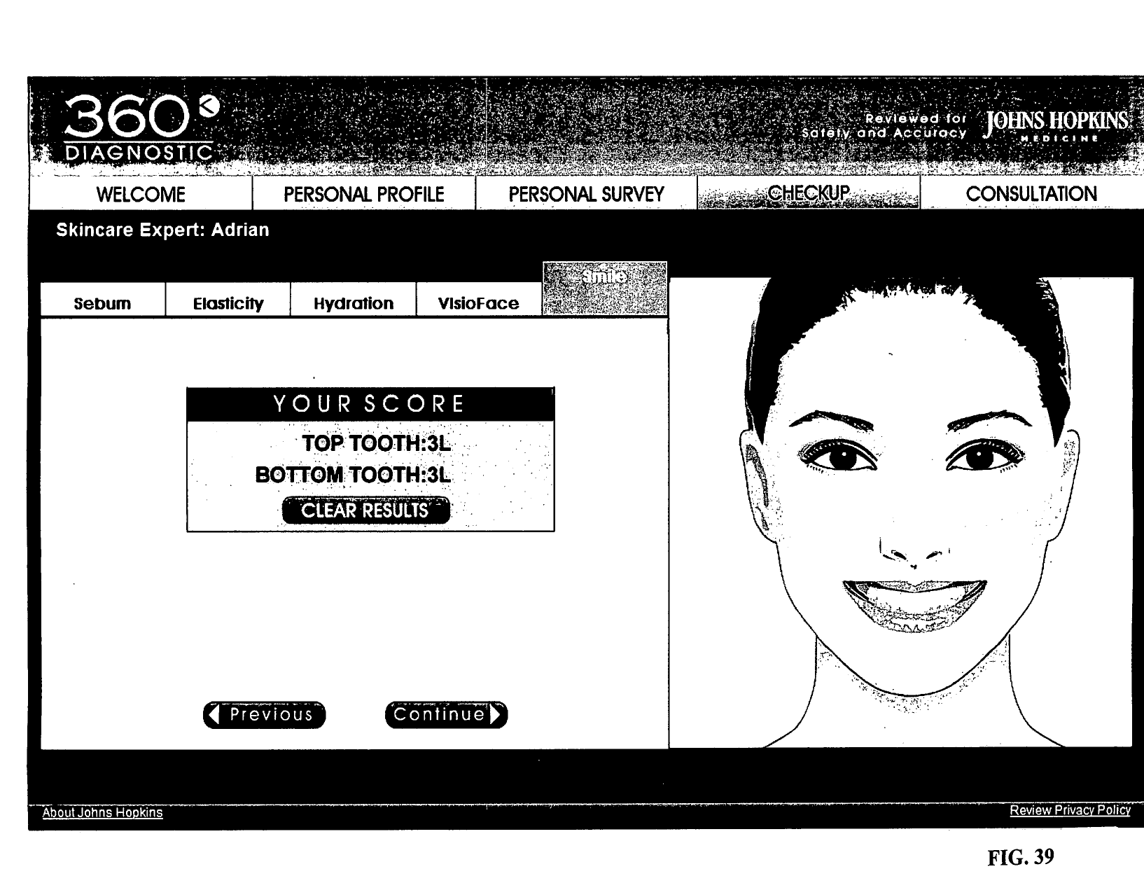

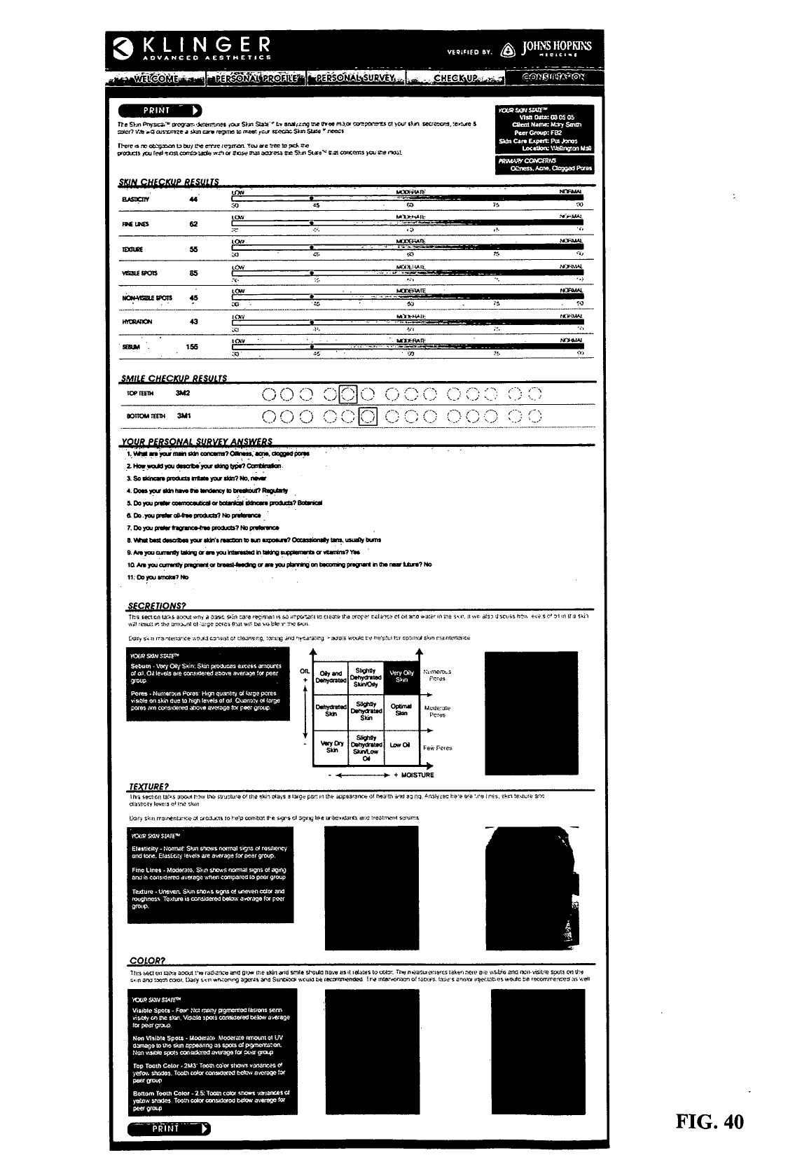

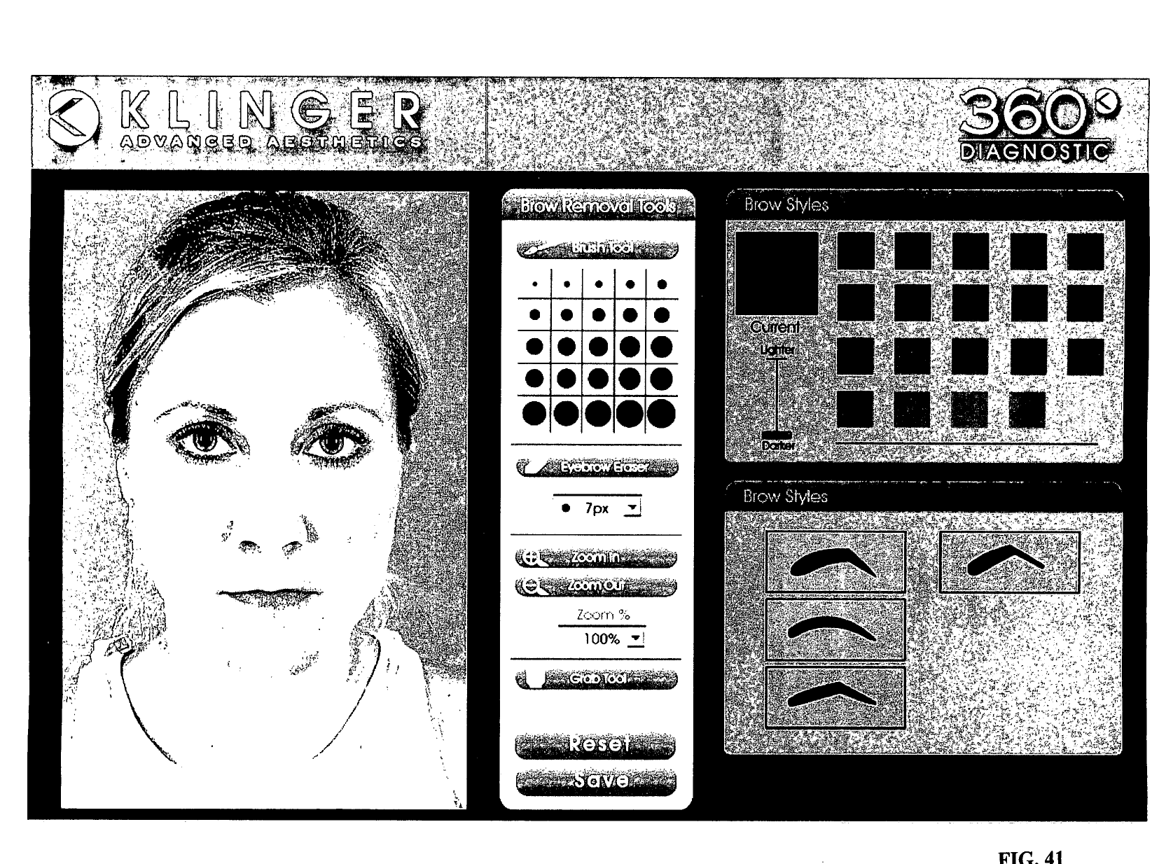

FIG. 19-41 illustrate one possible graphical user interface of a software system that a person may use to analyze their Skin State and smile without use of a concierge. Therefore, the aesthetic diagnostic analysis system is completely self-directed and involves minimal contact with other persons. Indeed, it is contemplated that the analyzation of one's Skin State and smile may include a stand-alone kiosk or computer diagnostic station. In these embodiments, the client would approach the station and follow directions presented on the display. For instance, FIG. 19 informs the client of potential questions to gather client information. In FIG. 20, the client must review a client release form and give consent for the analysis. FIGS. 21-22 requests the client complete a personal survey form by clicking on radio buttons or checkboxes to find the client's reaction to sun exposure, main skin concerns, and skin type. FIG. 23 instructs the client of the measurements that will be tested. In one embodiment, illustrated in FIG. 24, the client follows the instructions on the graphical user interface and places the probe in the center of their forehead to find their skin sebum content. The direction tell the client to press a button when the client is ready for the probe to take the measurement. FIG. 25 requests that the client place repeat the procedure of FIG. 124 but with the probe between their nose and eye. To find their skin elasticity, FIG. 26-27 requests that the client place the probe on their left and right cheek and then press a button when the client is ready for the probe to take the measurement. FIG. 28 illustrates the client's average elasticity score. To find their skin hydration, FIG. 29-30 requests that the client place the probe on their left and right cheek and press a button when the client is ready for the probe to take the measurement. FIG. 31 shows the client's average hydration score. FIG. 32-33 instructs clients to place their face within an image system where pictures of their face will then be taken. FIG. 34 informs the client of the four parameters that will be measured; namely, pores, fine lines, visible spots, and texture. Further, it illustrates one potential arrangement of the parameter information determined by the photographs. In this figure, the client is shown four pictures of their face with an electronic mask laid over the face to show where the software located pores, fine lines, visible spots, and skin texture. FIG. 35 illustrates one potential arrangement of the client's UV spots comparison information, showing the client score and a close-up of their visible spots photograph. It is envisioned that the results for the pores, fine lines, and skin texture may be shown in a similar fashion. FIG. 36 then instructs the client that the whiteness of their teeth will be analyzed. FIG. 37 and 38 instructs the clients to place the probe on their upper and lower front tooth and press a button on the client is ready for the probe to take the measurement. FIG. 39 shows the client's average tooth whiteness score.

It is contemplated that the station would provide an analysis consistent with the invention. For instance, it is contemplated that a software system is connected to the station such that the software system may use information from the database to analyze the diagnostic prove and/or photography information, perform complex algorithms to compare the client information to peer information from the database, update and/or alter information stored in the database, and make recommendations for product usage or aesthetic procedures. The software system connected to the database then compares the skin checkup information from the user to the information from other users having the same general gender, age, and skin type. The comparison information may show that the user skin condition is below, at, or above average as compared to their peer group. For instance, in FIG. 40A-C client's total results are displayed, including how the user ranked relative other user. They also illustrate one potential arrangement of the client's total results, including the elasticity, fine lines, texture, visible spots, nonvisible spots, hydration, sebum, tooth whiteness, personal survey answers, the client's secretions Skin State, texture Skin State, and color Skin State.

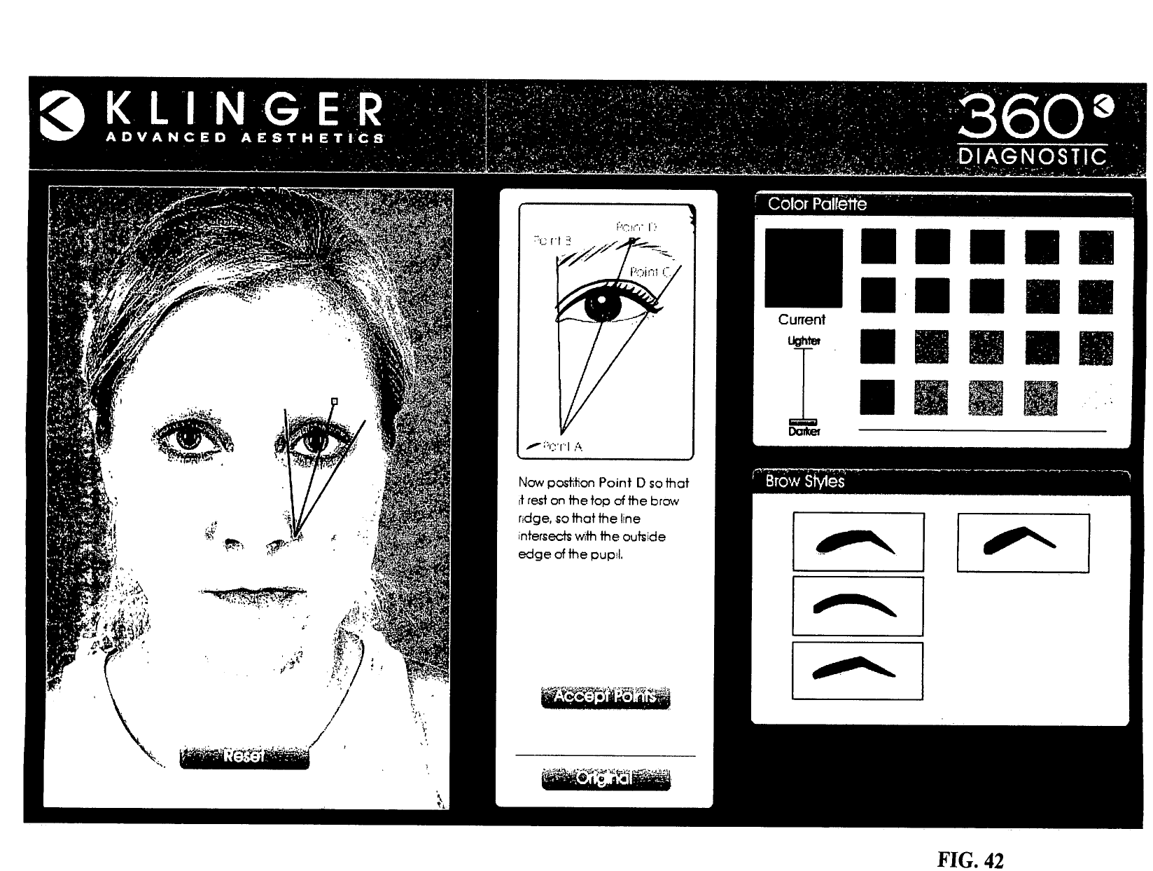

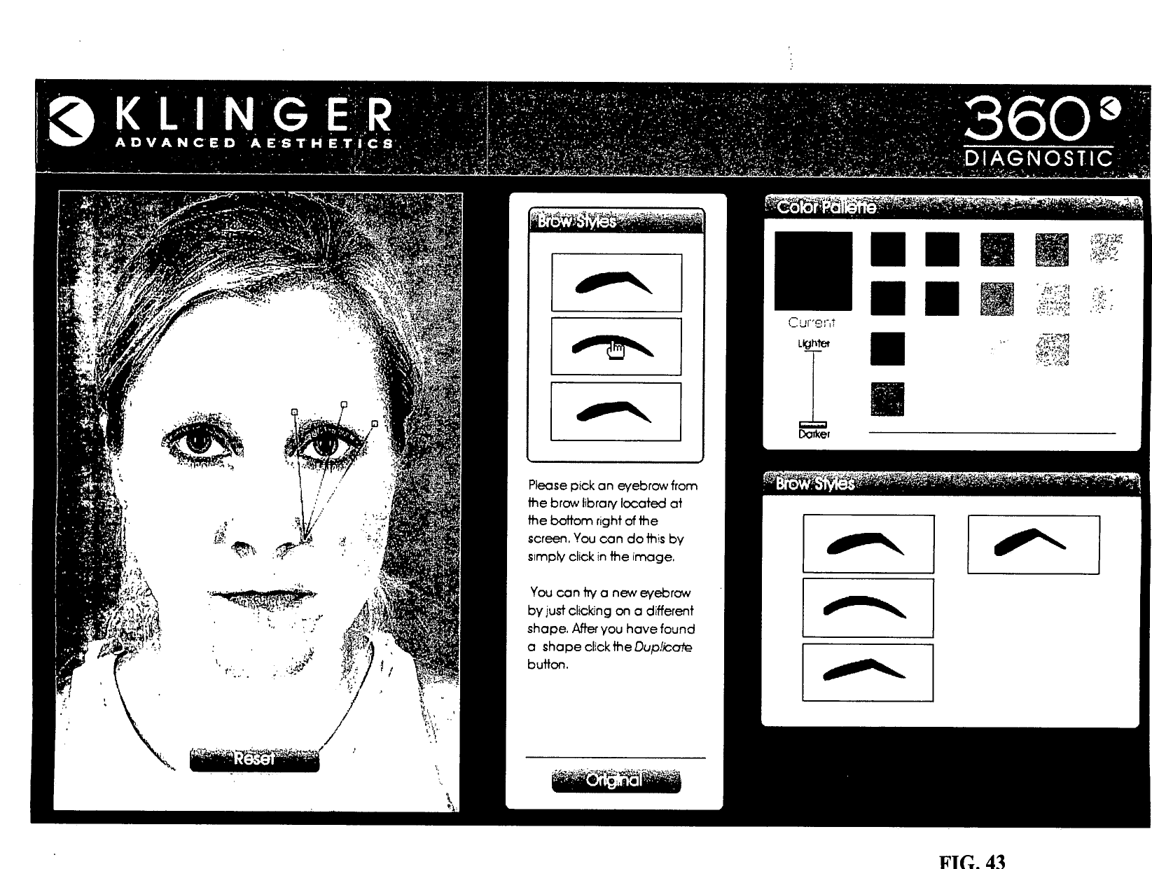

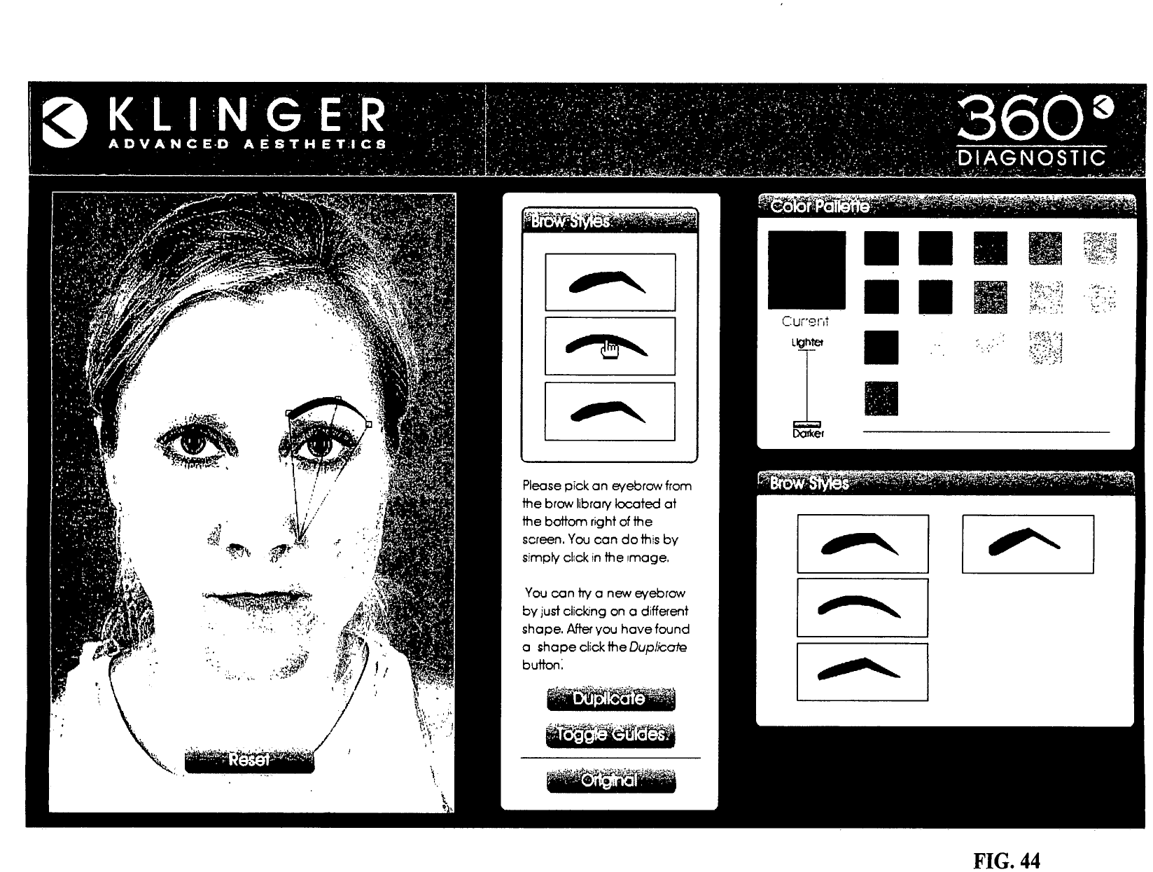

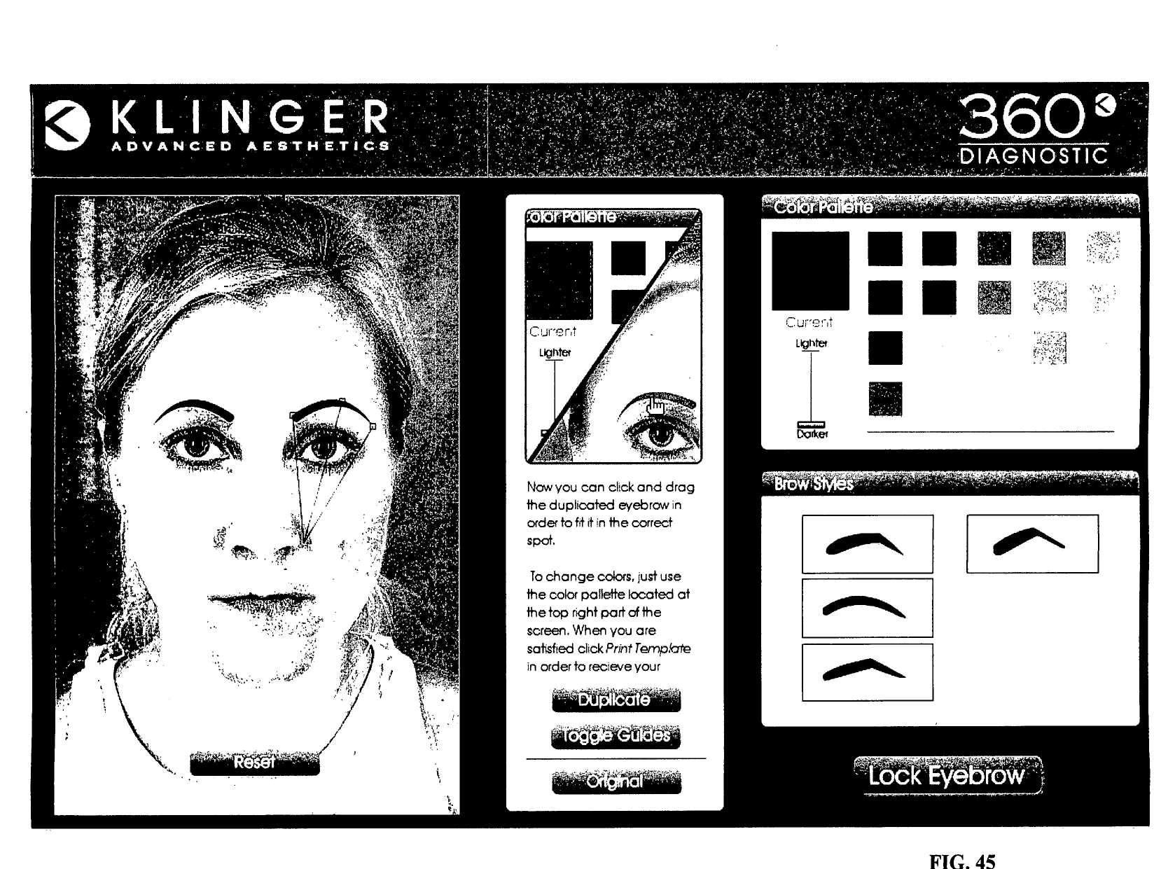

FIG. 41-45 illustrates additional features that the software system may have to assist the client in determining an eyebrow shape and color. FIG. 41 illustrates one potential arrangement of the eyebrow tool that is presented to the client, including a client photograph, buttons to zoom in and out of the photograph, an eyebrow eraser, an eyebrow brush tool, eyebrow colors, and eyebrow styles. In FIG. 42, the current eyebrows at the client are removed and the client is instructed to position a box over three particular points of there are eyebrow, namely the beginning and end of the eyebrow lengths, and the top of the eyebrow ridge. In FIG. 43, the client is instructed to pick an eyebrow style by clicking on a graphical representation of an eyebrow shape. In FIG. 44, the eyebrow chosen by the client is placed upon the client's photograph said the client can do what the new shape would look like on their face. Once an eyebrow shape is determined, the client drags and drops a duplicate eyebrow over the other eye in FIG. 45. Further, , the client chooses a color for the eyebrow, and may print a photograph with the new eyebrows when the client is satisfied.

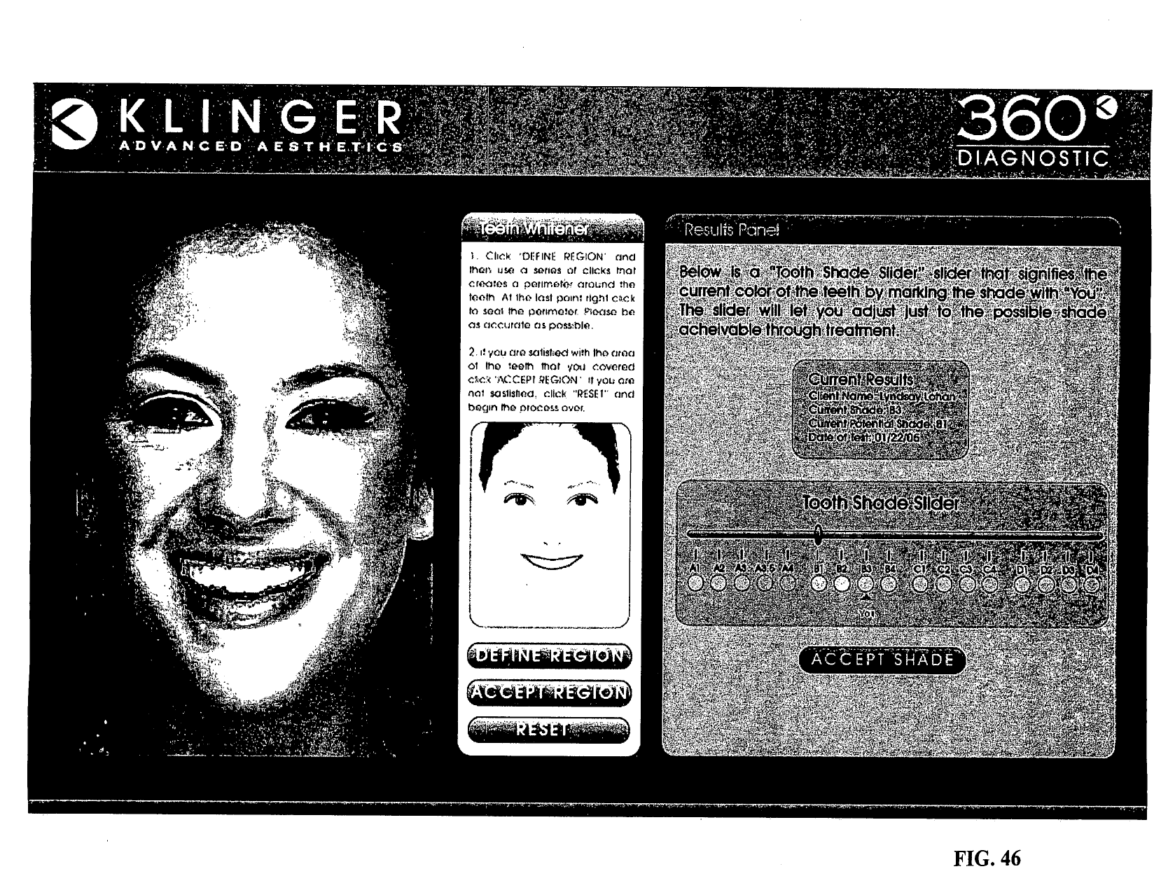

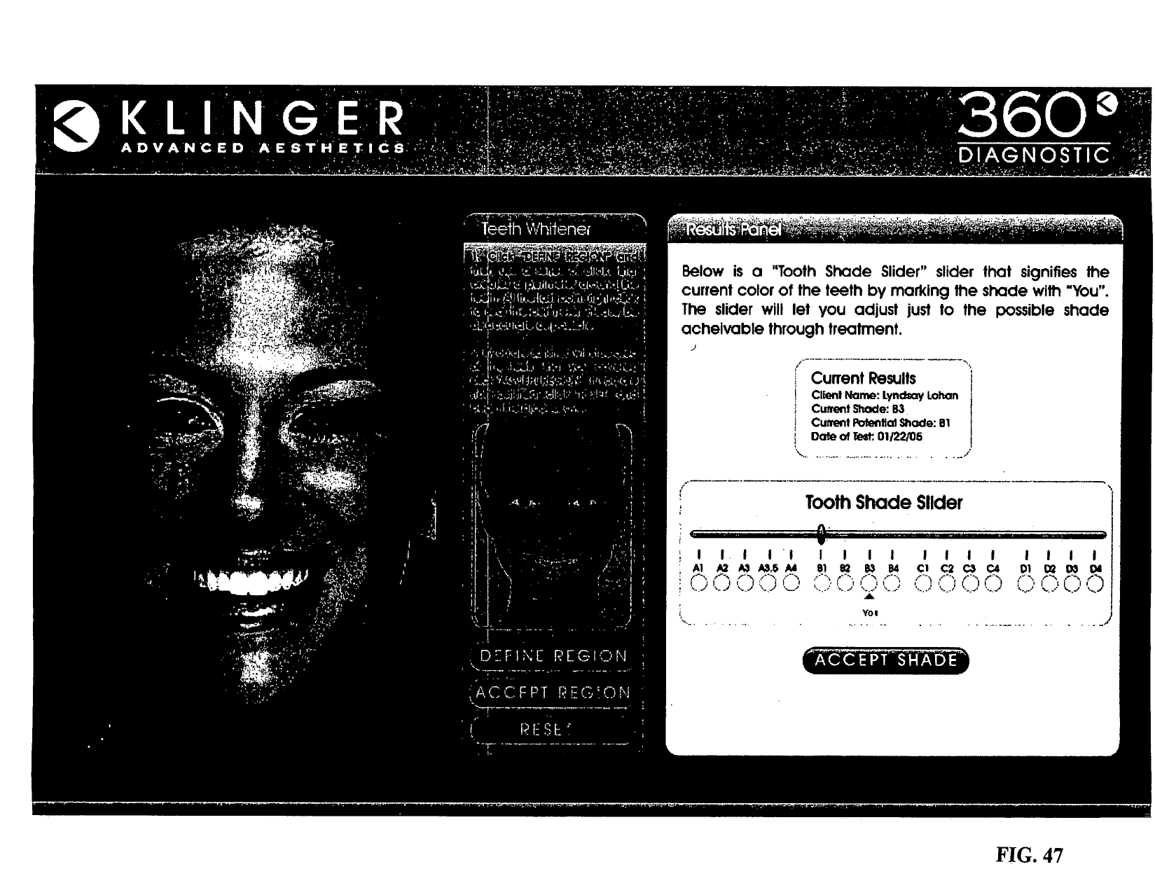

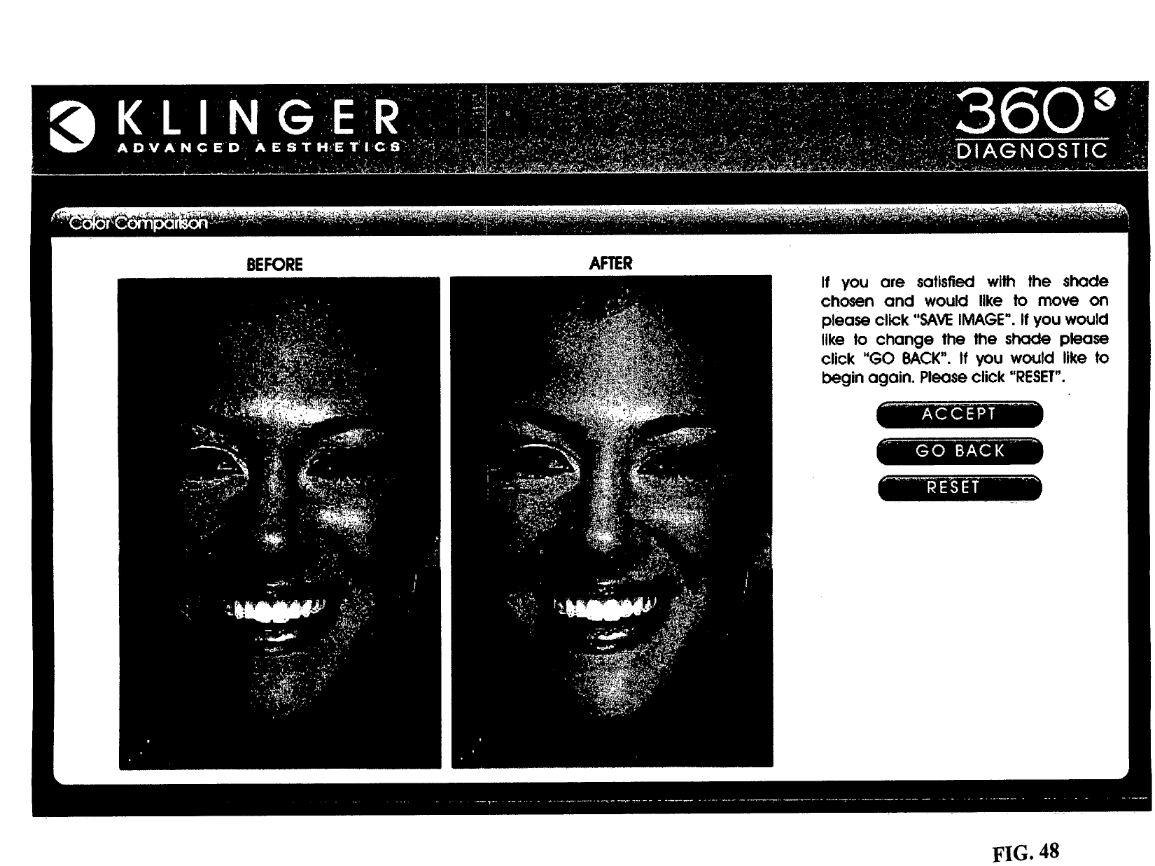

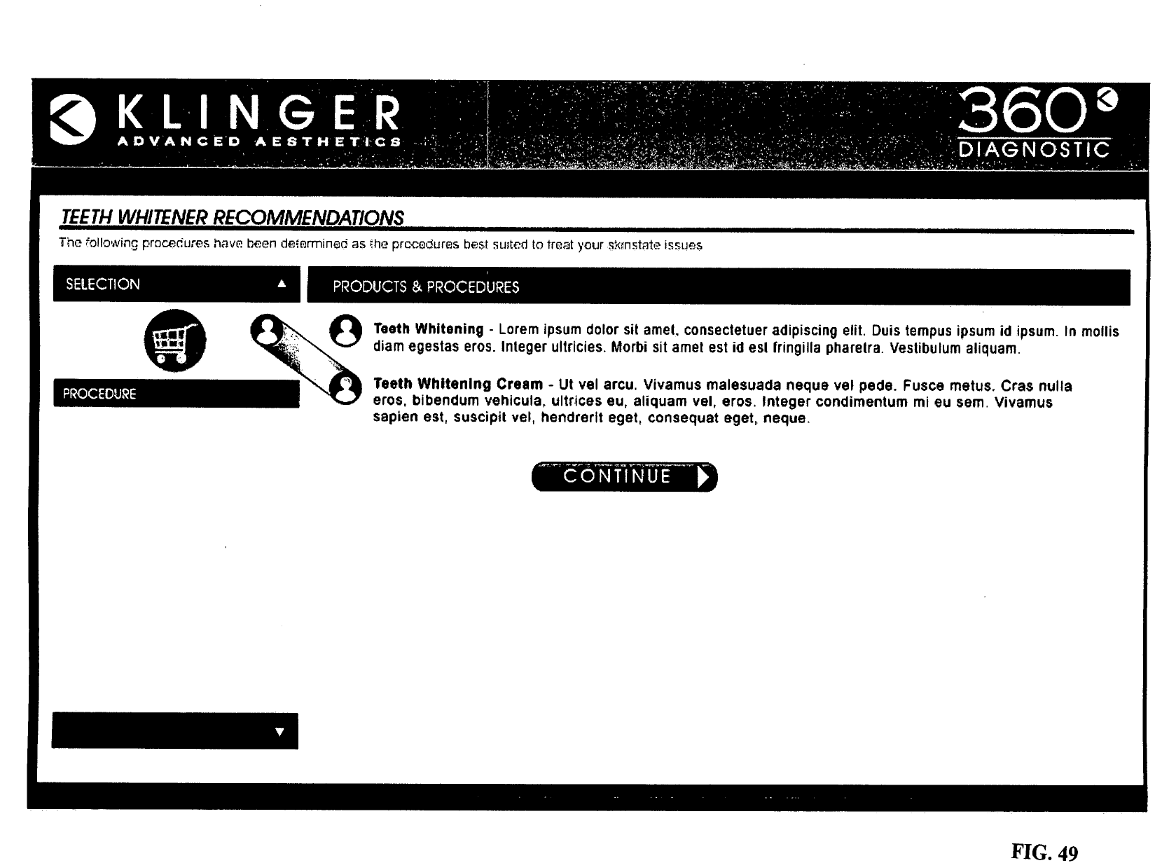

FIG. 46-49 illustrates additional features that the software system may have to assist the client in determining what shade of tooth whiteness the client may desire. FIG. 46 illustrates one potential arrangement of the tooth-whitening tool that is presented to the client, including a client photograph and instructions for the client to create a parameter around the teeth in the picture. In FIG. 47, the client can select a tooth shade they would like to have. In FIG. 48, the client is presented with a picture of themselves with their current tooth shade and potential new tooth shade. FIG. 49 lists recommended procedures to whiten the client's teeth.

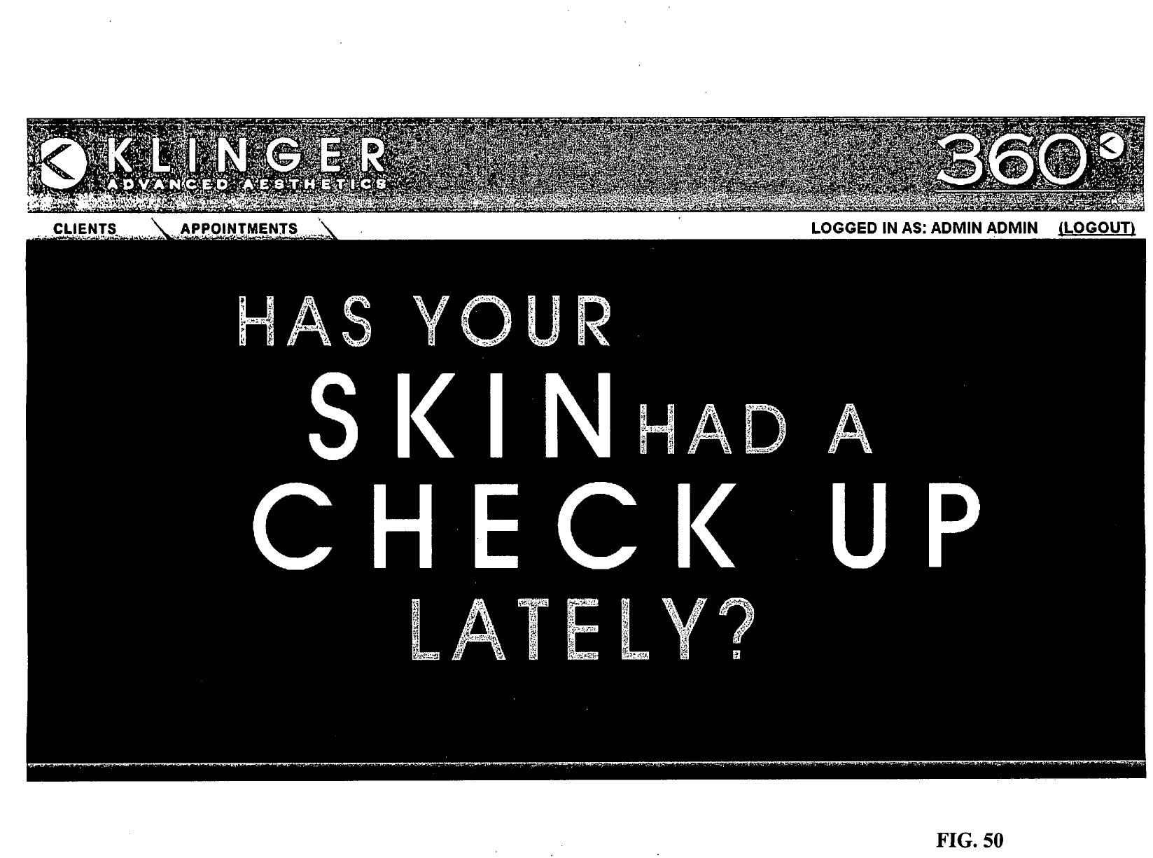

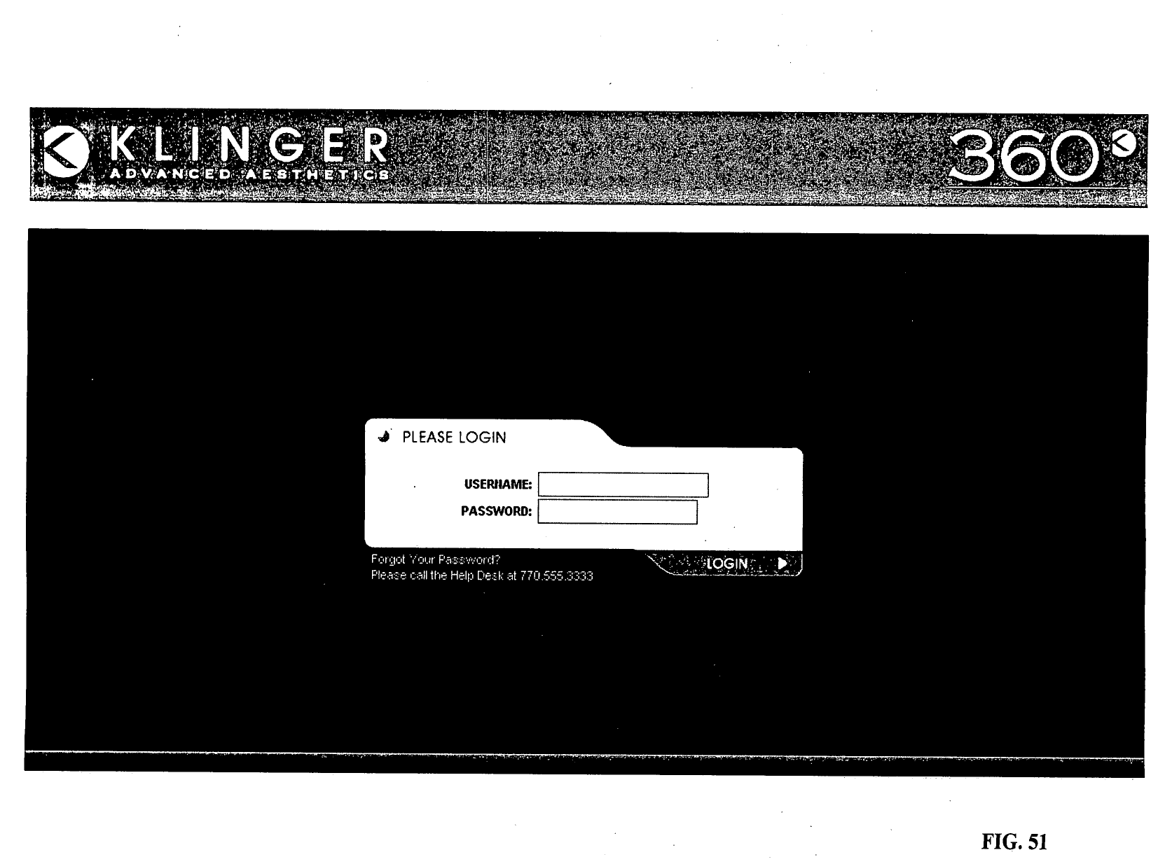

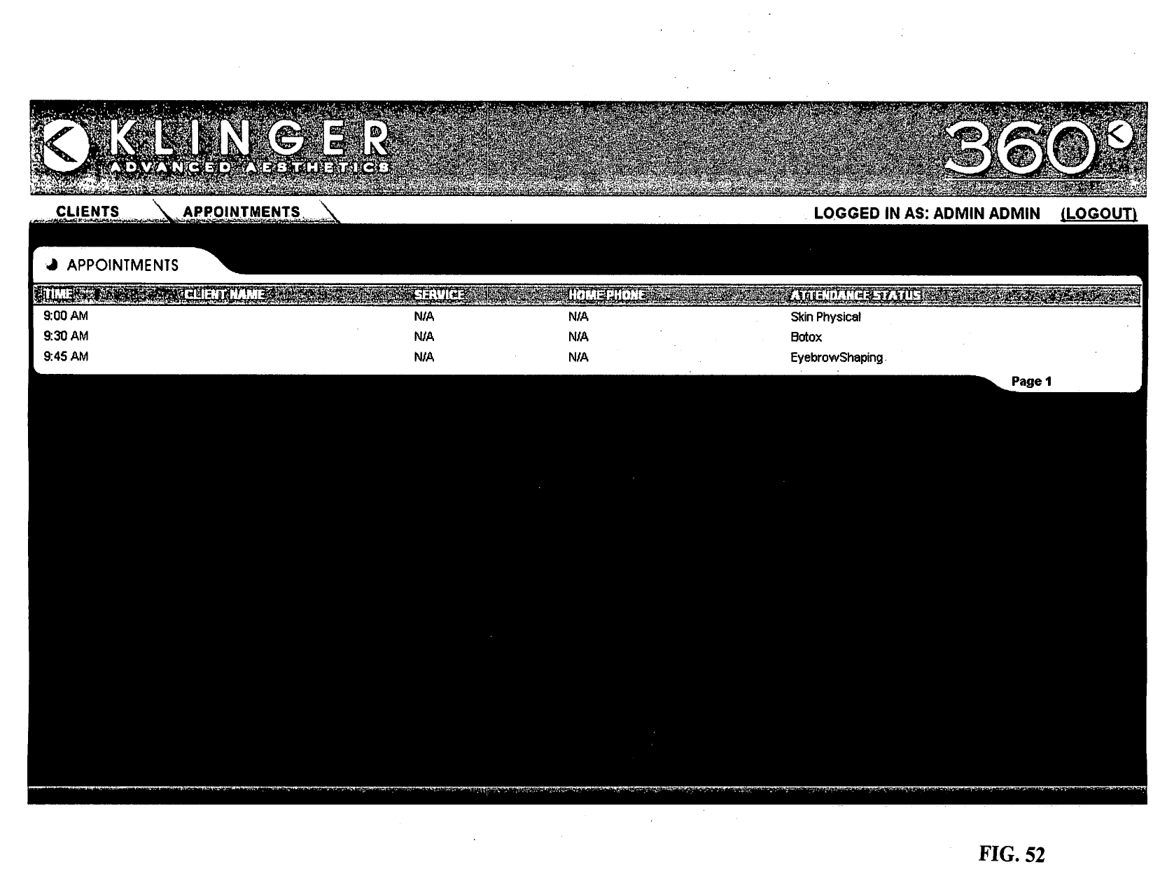

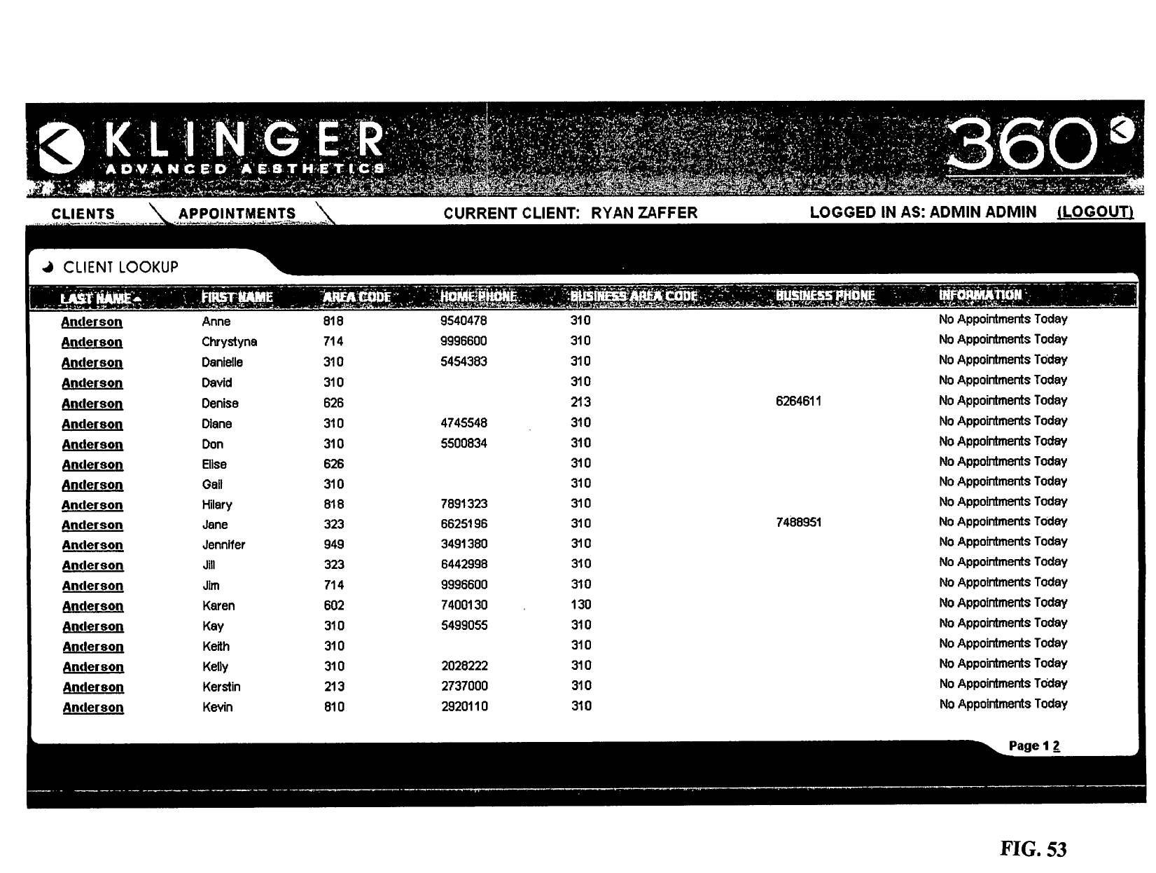

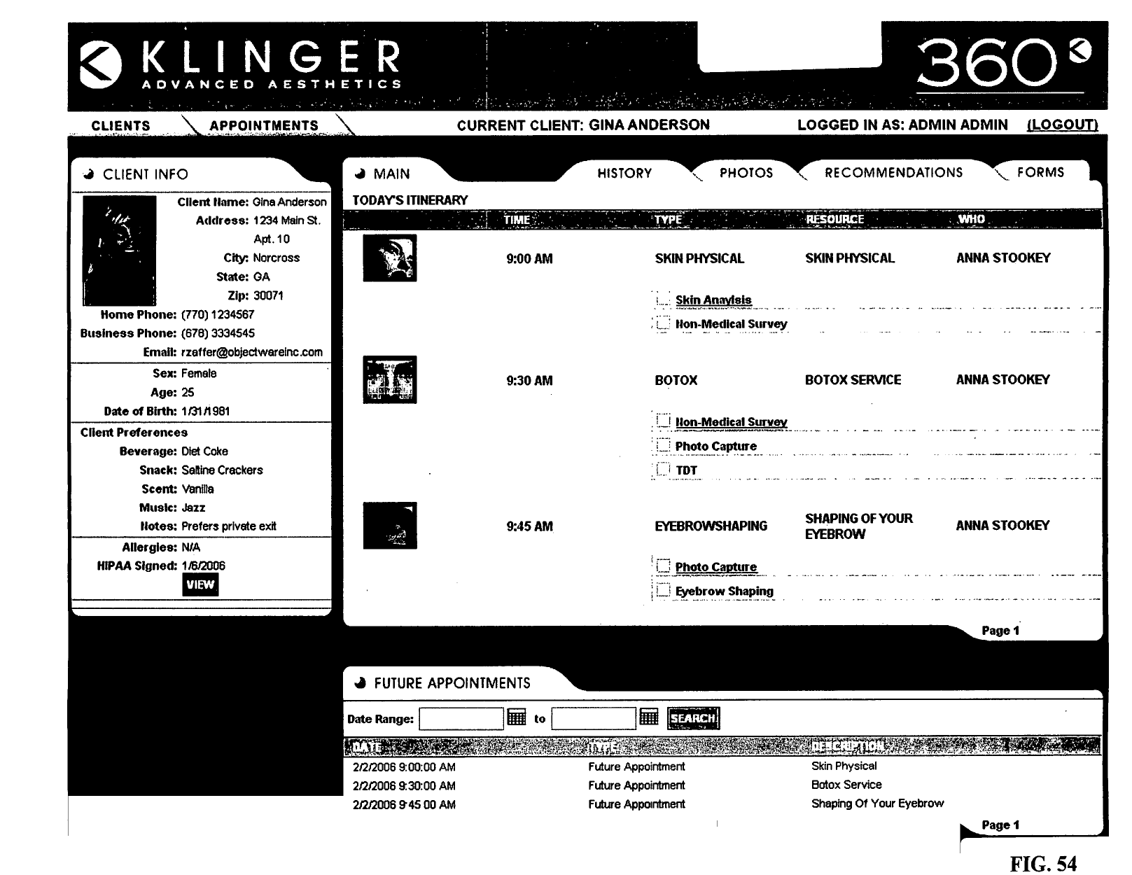

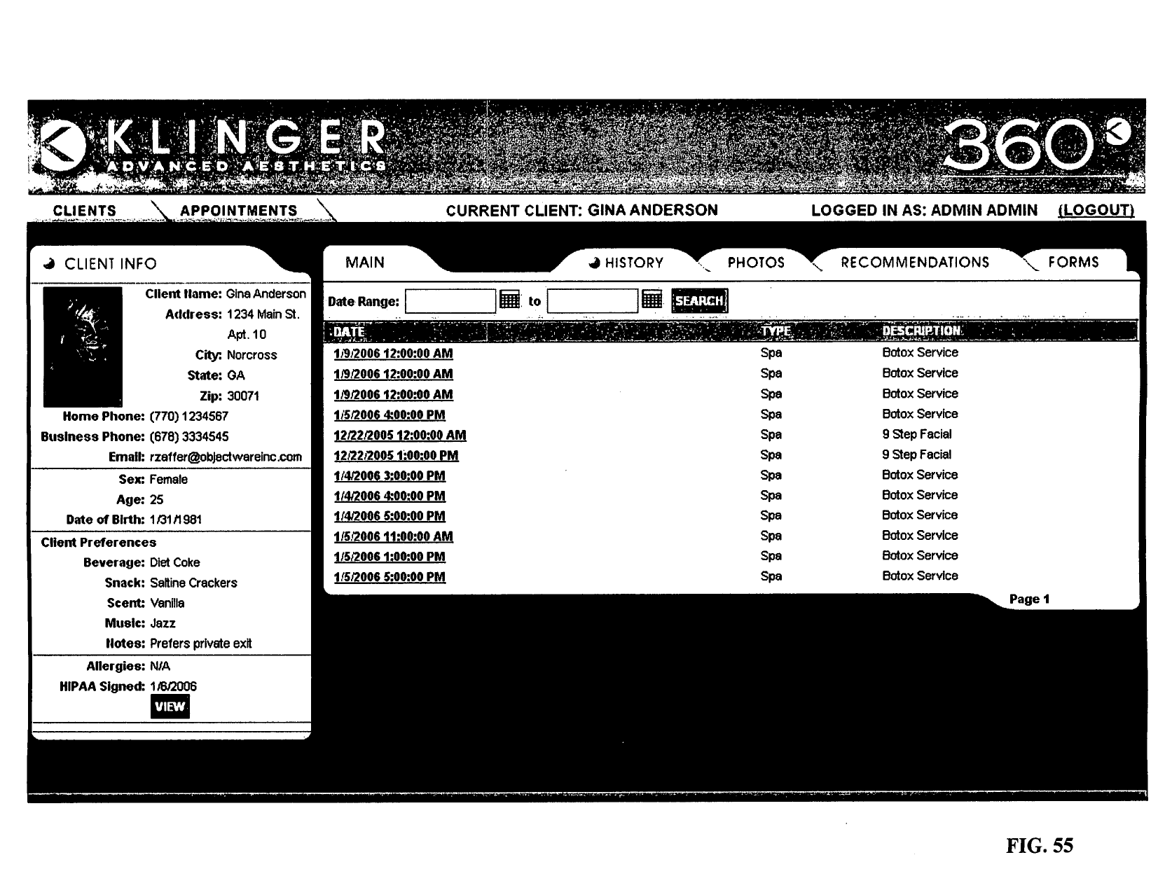

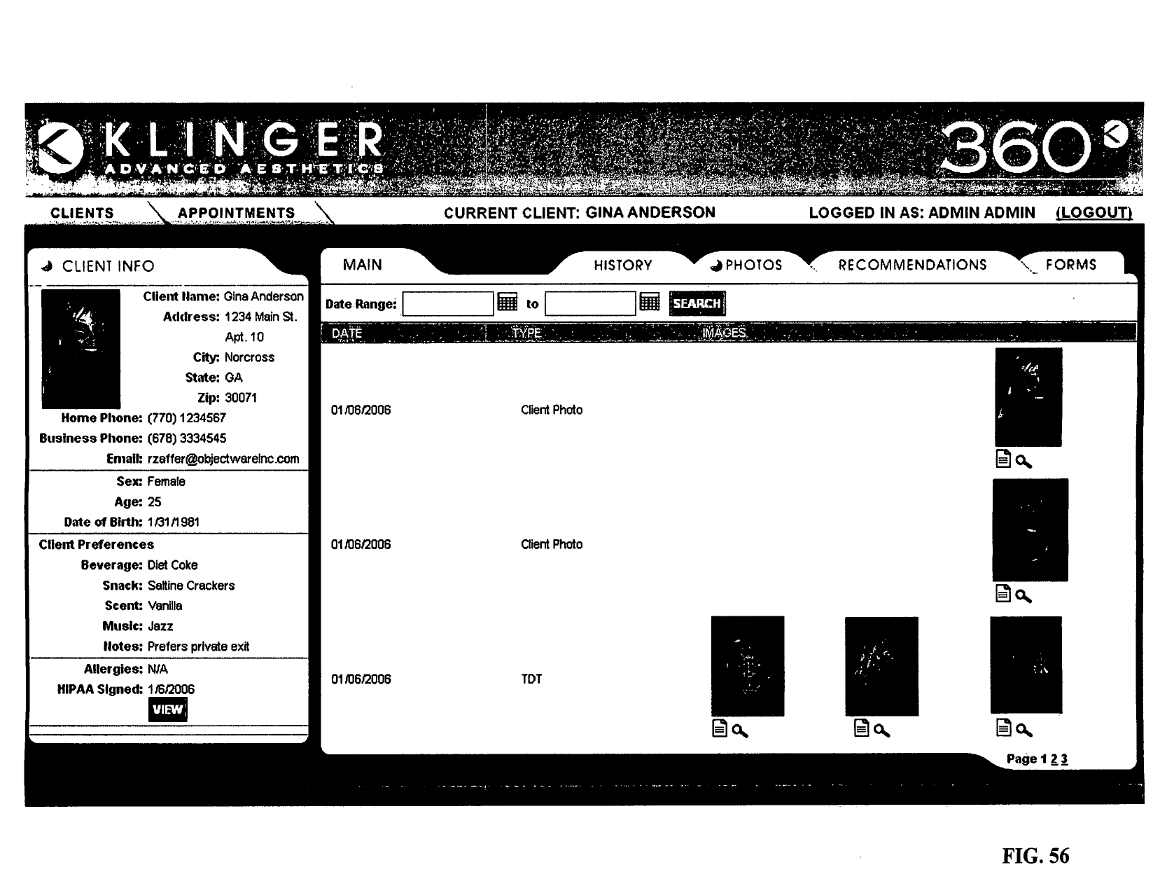

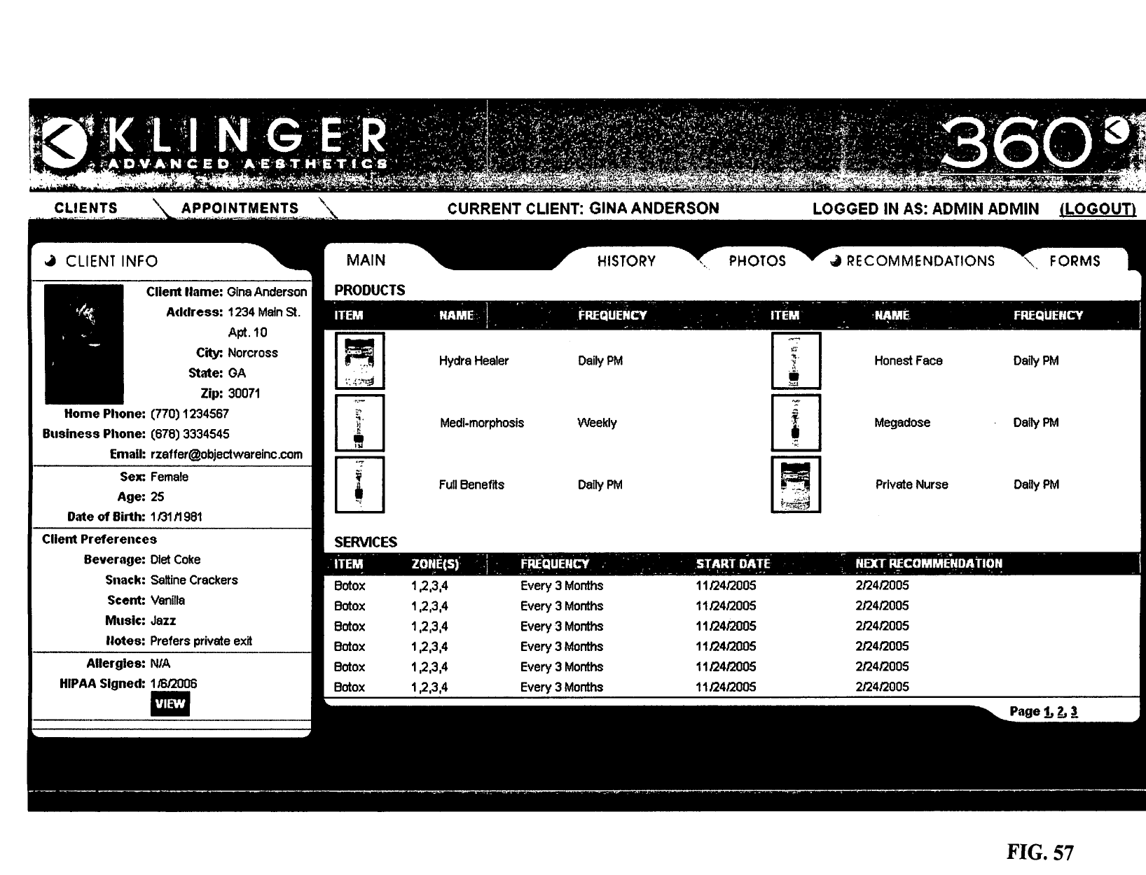

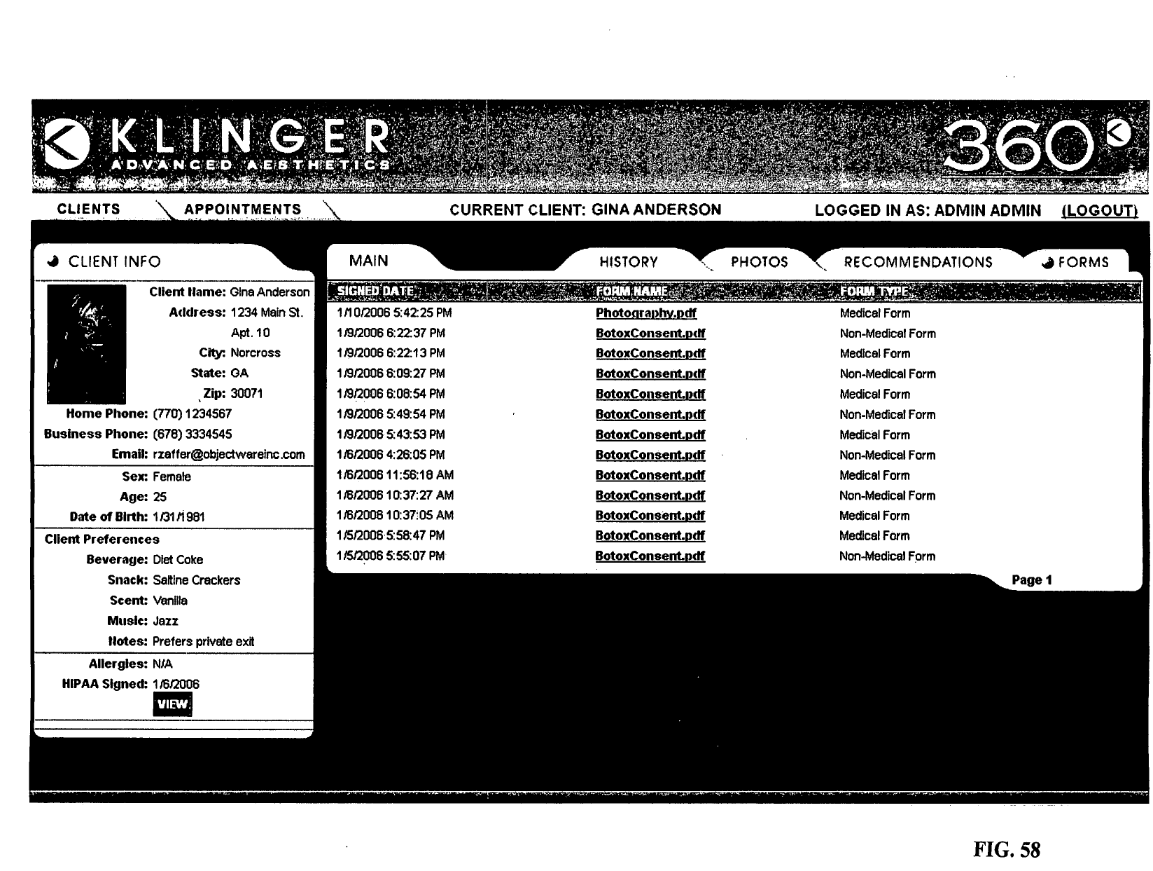

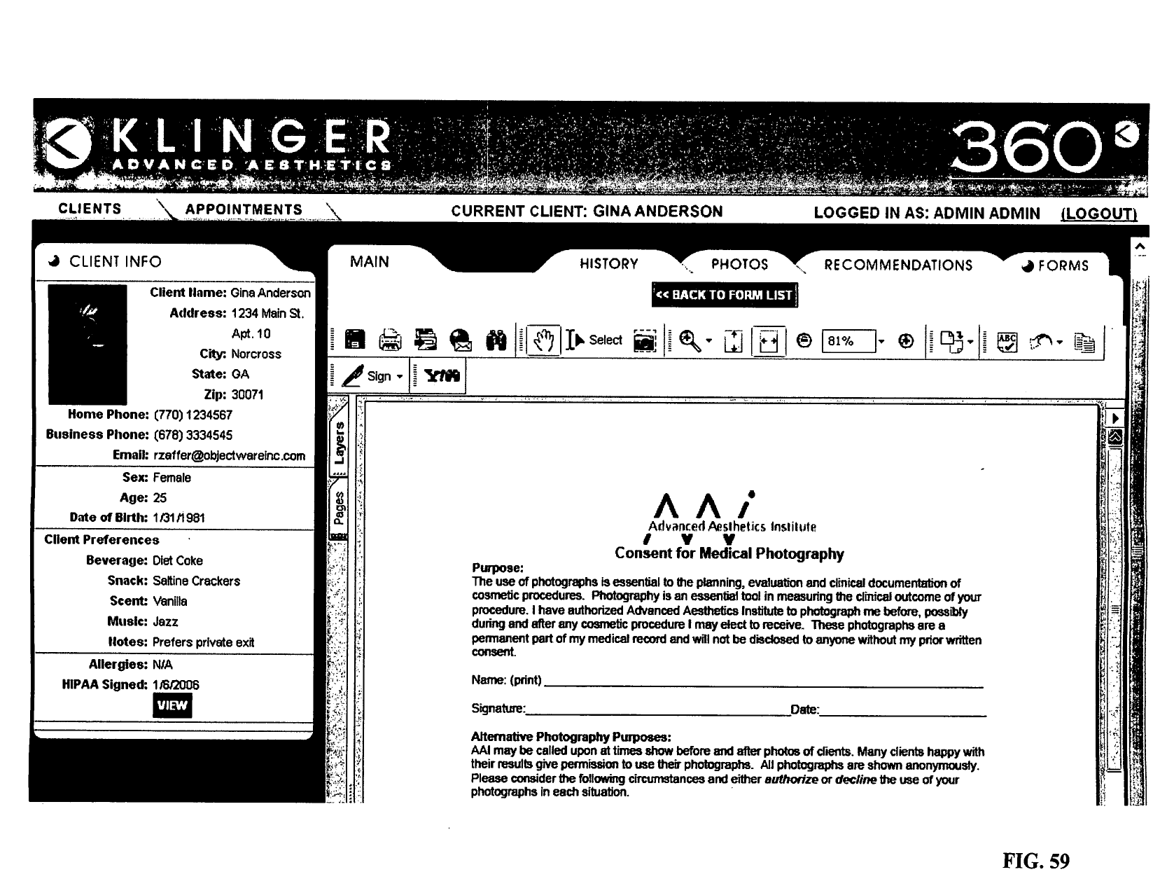

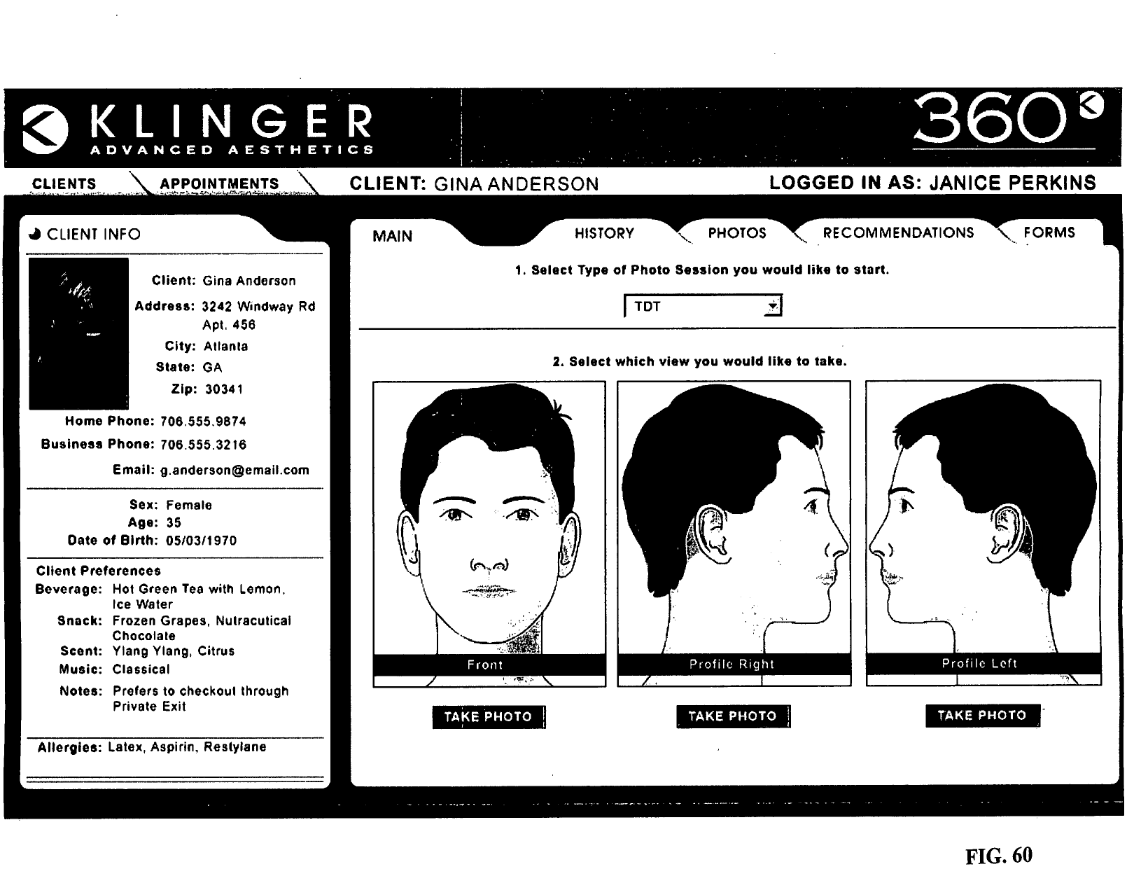

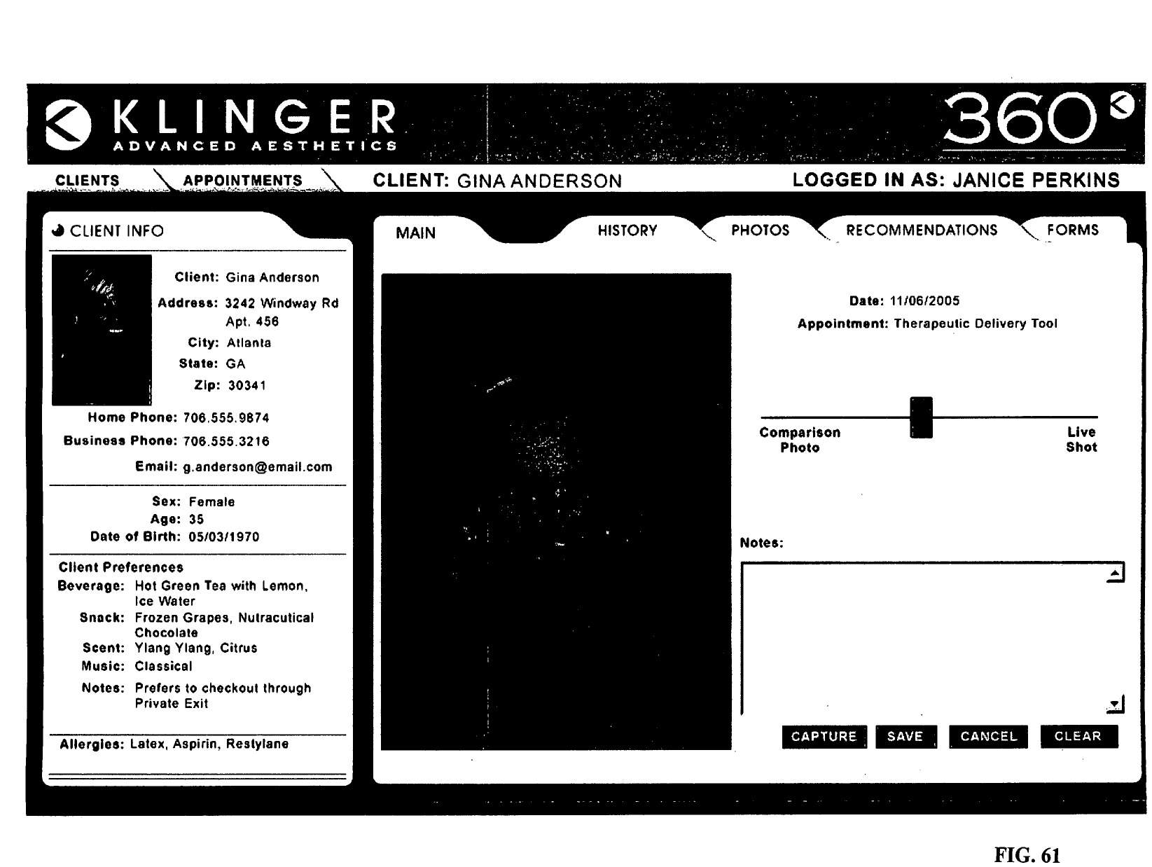

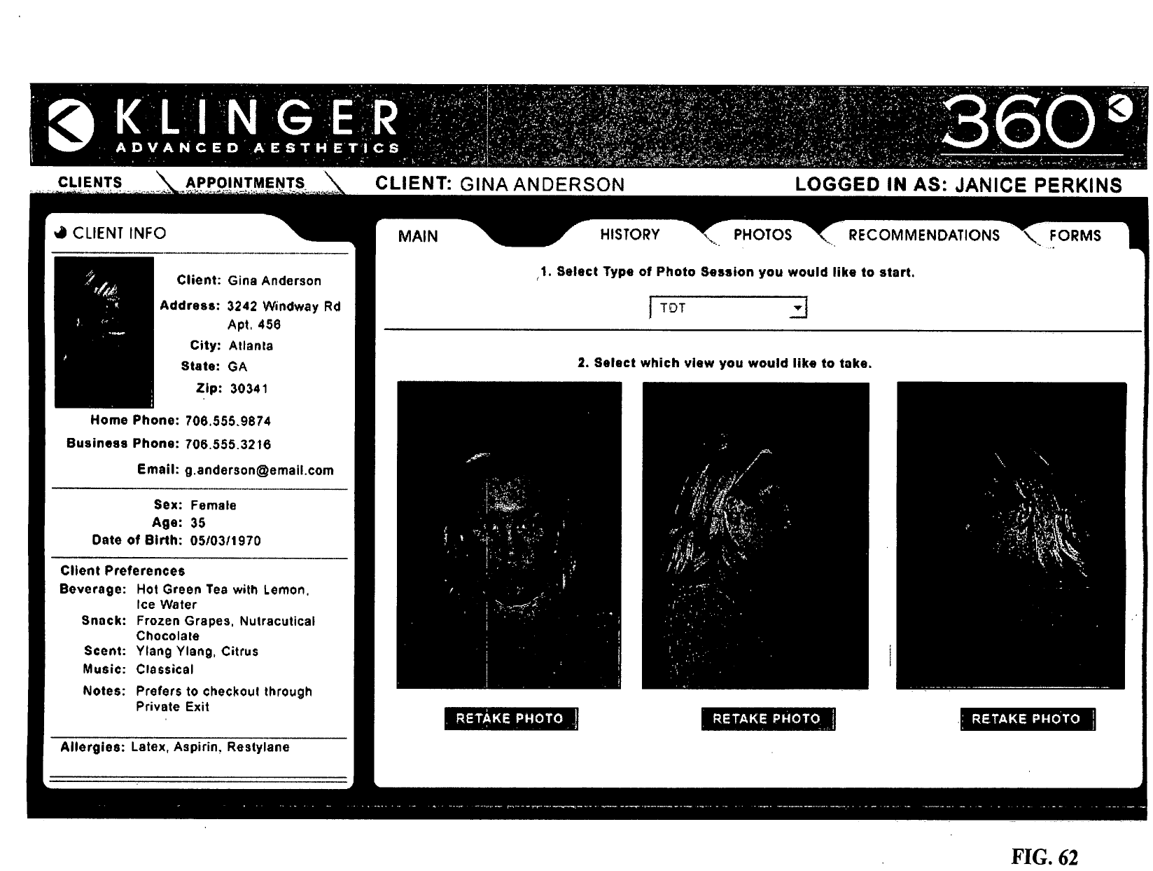

FIG. 50-62 illustrates graphical user interfaces that an administrator or medical personnel may see when they are logged in to the software system. FIG. 50-51 illustrates greeting and logon pages for the person using the program. FIG. 52 lists one client's appointment times and the aesthetic procedure to be performed at that time. FIG. 53 illustrates a potential interface arrangement of information when a client is looked up by an administrator or medical personnel. FIG. 54 illustrates the potential interface arrangement of one client's information, including information such as the client's name, address, contact information, sex, age, birth date, preferences, allergies, when the HIPPA was last signed, the current itinerary, and future appointments. FIG. 55 illustrates a potential interface arrangement of the client history, including the past procedures and dates the procedures were performed. FIG. 56 illustrates a potential arrangement of the client photographs. FIG. 57 illustrates a potential interface arrangement for the recommendations for the client, including the name of recommended products and their frequency of use, and the recommended aesthetic procedure. FIG. 58 illustrates a potential interface arrangement for the list of all current and past client consent forms. FIG. 59 illustrates that when a client form from FIG. 58 is selected, the consent form itself may be shown. FIG. 60 illustrates a potential interface arrangement for a photo session, including graphical representations of the photographs to be taken. FIG. 61 illustrates a potential interface arrangement whereby a client before and after picture may be morphed by use of a slide bar. FIG. 62 illustrates a potential interface arrangement for a photo session, whereby a client photograph is substituted for the graphical representation of FIG. 60.

### EXAMPLE 1

A user is interested in having one or more aesthetic improvement procedures performed. The user visits a concierge (120) for a consultation (130) and shares several issues that she would like to have addressed including, but not limited to, tired-looking eyes, weight, size of nose, hairstyle and discolored teeth. The concierge performs a diagnosis (150) using one or more tools including, but not limited to, self-perception questionnaire tool (320), facial electronic photograph tool (330), facial beauty analytical tool (340) and facial measurement wrinkle tool (350). The diagnostic data acquired through the use of the tools is presented by the concierge to one or more providers of aesthetic improvement procedures (160). In the present example, the providers selected may include a hair stylist, hair colorist, facial aesthetician, make-up artist, fashion consultant, plastic surgeon, cosmetic dermatologist and cosmetic dentist. The aesthetic improvement providers provide the concierge with feedback (170) on potential areas of improvement for user's face and body. The concierge provides the user with a comprehensive report that includes the results of the diagnostic assessments, an outcomes report containing results achieved by previous users for the same procedures proposed for the current user, and results from an electronic photo system containing the feedback from the aesthetic improvement providers (180). This latter step permits the concierge to obtain directional view of the impact of the proposed aesthetic improvement procedures and the costs associated with performing the procedures.

As a result of the consultation, the user is recommended the following aesthetic improvement procedures: eyelid surgery, eyebrow shaping, BOTOX™ treatment, new make-up, new hairstyle, new hair color, ceramic laminates and whitening for teeth. After pursuing the aesthetic improvement procedures, the user meets the concierge to obtain a post-procedure outcomes assessment that includes a satisfaction report competed by the user, facial electronic photograph and wrinkle analysis. This is followed by a comparison of pre- and post-procedure user appearance assessments to determine the degree of the aesthetic improvement in an objective manner.

### EXAMPLE 2

An exemplary embodiment of the invention is carried out for two users A and B. A survey tool measures the user's orientation of their own appearance (importance placed on appearance), self-evaluation of their own appearance and level of satisfaction with their appearance. Preferably, the survey tool features a 1-5 scale for measurement of user responses. Other scales may also be used.

A beauty analysis tool is applied to users A and B before and after the performance of aesthetic improvement procedures as a means to measure the movement of a user's aesthetic appearance from start to finish. One exemplary measurement system is the Marquardt system. Other measurement systems may be used as well. Under the Marquardt system, the basis for measurement is the phi factor ratio, which is a known mathematical tool for measurement of beauty and symmetry. Under this system, feature perfection is standardized using a 1,000-point scale, where 1000 equals perfect facial feature symmetry (that includes individual features as well as the aggregate of all features taken together). In the case of user A the Marquardt data before the performance of an aesthetic improvement procedure is 505 out of a possible 1000. The value for the same post-treatment is 835, i.e., an improvement of 330 points or 39.5%. In the case of user B, the pre-procedure treatment value is 600 and the value after treatment is 785, i.e., an improvement of 185 points or 23.5%.

A wrinkle measurement tool preferably having an assessment scale of 0 to 5 is applied to users A and B. Prior to the performance of an aesthetic improvement procedure the wrinkle measurement (Lemperle data) for user B is “4” for the forehead region and “5” for the neck region. Following the performance of an aesthetic improvement procedure, the Lemperle score for user B's forehead is “2” and the value for the user's neck is “3”. The overall improvement for the two areas tested is 45%.

A panel of experts is assembled comprising a concierge, plastic surgeon, cosmetic dermatologist, cosmetic dentist, hair stylist, hair colorist, makeup artist, fashion consultant, aesthetician and beauty magazine editor. The panel reviews and completes an outcome survey tool. The outcome survey tool is preferably measured on a scale of 0 to 5.

The results of the application of an exemplary embodiment of the invention on users A and B is summarized below:

1 Outcome Weight User A User B Summary* Value User Procedure 4.95 4.95 1 36% Satisfaction Beauty Analysis +39.2% +23.5% 1 Wrinkle Analysis N/A +45% 1 Combination of +39% +39% 1 13.5% Beauty Analysis and Wrinkle Analysis Panel of Experts 4.73 4.53 1 22.5% Adverse Effects 0 0 1 10% Total Score 1 1 100% *Outcome summary is a weighted average of the combined data obtained from user surveys and quantifiable metric data where “1” indicates a perfect outcome and “−1” indicates worst possible outcome.

### EXAMPLE 3

An exemplary embodiment of the invention in accordance with FIGS. 6 and 7 is carried out on a female user. The user (100) undergoes an aesthetics concierge consultation (130) with a concierge. The user's medical history (610) is gathered, aesthetic feature-related chart information (230) is gathered, and self-reported client assessment data (620) is gathered. The concierge places the gathered information in the user's chart (630). The user expresses an interest in BOTOX™ injections to reduce wrinkles in her forehead and soft tissue filler to plump up her upper lip. The user enters a diagnostic room (140) and meets with an aesthetic diagnostician. Standardized Canfield medical photos (390) are taken including a frontal view in repose at an 18% down angle for use with the Marquardt beauty analysis system (340). A Lemperle wrinkle measurement system (350) is performed on the target areas that the user desires to treat with BOTOX™ and/or soft tissue fillers. The analysis reveals the level of wrinkles in a specific target region. A Marquardt beauty analysis system (340) is conducted and an electronic mask is drawn on the electronic photo of the frontal view of the user's face. The electronic mask allows assessment of a user's features, for e.g., whether the user's upper lip is ideally proportioned relative to the rest of the user's face. A “zone map” of the target areas for BOTOX™ injections and soft tissue filler is overlaid (640) on the user's electronic photo by the diagnostician. The diagnostician notes down the information in the user's chart (630).

The user has a physician consultation with a cosmetic dermatologist, plastic surgeon or cosmetic dentist. The physician conducts a pre-treatment evaluation of the user. The physician concludes the client is a candidate for BOTOX™ in the glabella and eye regions as well as for a soft tissue filler in the upper area. The physician places the above information in the user's chart (630).

The user is escorted to a treatment room (650). The user receives a “pre-treatment” relaxation procedure from a medical aesthetician. While the user is receiving the relaxation procedure, a medical assistant and the physician review the electronic photo of the user with the “zone map” overlay (640) and confer regarding the course of treatment to be administered. The physician administers the BOTOX™ and soft tissue filler treatment and the medical assistant records (670) the specific zone location and concentration of BOTOX™ and filler being administered to each zone. Following the treatment, the user undergoes a post-treatment evaluation (680).

After a specific period of time, the user returns for a follow-up visit (700). During the follow-up visit, the user is interviewed by the concierge to gauge the user's satisfaction with the treatment. The user is re-photographed using the Canfield system (390). The beauty analysis system (340) is administered to observe the effects of the treatment and to allow a comparison between the user's “before” and “after” images. A wrinkle assessment (350) is also performed to gauge the reduction of wrinkling in the target areas. The physician meets with the user to conduct a post-treatment evaluation (680). The evaluation includes a review of potential adverse reactions. The evaluation includes a review of at least three photographs of the user's face-the “before” photo of the user's face with call-outs of the wrinkle and upper lip issues; the “before” photo of the user's face with the target (zone) areas filled in by the medical assistant which show the client where the BOTOX™ and soft tissue was administered; and, the “after” photo of the user's face with call-outs to show the improvements achieved. The wrinkle assessment and beauty analysis data are also reviewed to assess the quantitative improvement in the user's appearance. In addition, the physician reviews the user's satisfaction survey and confirms the user's satisfaction with the results of the treatment.

One of three likely scenarios can result from post-treatment evaluation discussion between the user and the physician. In a first scenario the results are satisfactory and acceptable (710) to both the user and the physician. The user's chart (630) indicates the protocol used for the BOTOX™ injections and soft tissue fillers that created the desired result. In this scenario, the same or similar approach may be administered during the user's next visit (720). In a second scenario, the results are satisfactory to the user but not to the physician (730). The physician will modify the user's chart (630) to change the treatment to be administered to the user during the next visit (740). In a third scenario, the results are satisfactory to the physician but not to the user (730). As in the case of the second scenario, the physician will modify the user's chart (630) to change the treatment to be administered to the user during the next visit (740).

In another preferred embodiment, an integrated diagnostic platform is created. This diagnostic interface is located is specified facilities to enable diagnostics based solutions and advanced cosmetic medical charting for clients.

The integrated diagnostic solution encompasses several distinct functions, or modules. While every module is fully integrated and builds upon previous client encounters, each does have specific functionality and end results. The overall goal of this system is to increase efficacy of treatment and to ensure safety and compliance, through logic-driven, pre-formatted appointment activities.

A skin state evaluation is performed with a software application that fully integrates skin analysis probes, a digital photo analysis booth, and a teeth shade probe. After answering several profile questions to establish a client's current skin care habits, the equipment is used to scientifically measure the current state of the client's skin. A logic-based backend program then recommends the products and services most appropriate for treating that particular client's skin conditions. Ideally, every client has an evaluation prior to having a facial, in order to provide the aesthetician with quantitative information about the client's skin.

A nurse practitioner assessment tool is a system to guide a consultation so that a client is completely analyzed and educated about their aesthetics issues and options. The face or other body region is split into zones using a proprietary zone mask design, where each zone has specific issues. After the assessment by a nurse practitioner or physician, a backend logic system recommends an entire suite of Rx products and services that may be used to improve upon any conditions identified.

An advanced charting tool is a logic driven program to enforce compliance in properly documenting treatment. Based on the treatments that are performed, the system loads the appropriate intake forms, consent forms, treatment-specific required medical photos, actual treatment documentation tools, and billing details. A simpler version is available for tracking spa treatments as well, including facials, waxing, and massage therapy. The program has fixed activities that must be completed in order, thus ensuring that all documentation is captured.

A medical photo module is a logic-driven application that may be integrated with the nurse practitioner assessment tool and/or the advanced charting too. The medical photo module loads images of the photos needed for each specific treatment. Te medical photo module also stores the appropriate zoom, focus, and other camera details per each image. The storage of settings is important in a practice where there may not be a dedicated medical photographer. With the medical photo module, the practitioner merely has to line up the client appropriately, and the software controls the rest of the process.

A brow-shaping module also utilizes an imaging system for capturing a digital photo. The photo is pulled into a program that allows the user to digitally erase the client's eyebrows, and, along with the client, place digital version of the ideal eyebrow shape, size, and color on the photo. This template may be printed out and used as a stencil to alter the client's eyebrows.

In order to implement the system of the invention several databases are preferably created. First, a client history database is preferably created for tracking and reporting of sales related to the diagnostic platform. This includes the creation of various reports and data files to support automated feeds. Additionally, this system is preferably capable of creating diagnostic productivity reports. Second, a client history database is preferably created to allow queries of various client transactions. A query facility against this database is required and will be built as a new, companion browser service offering.

A user interface allows operation of the system. A web-based front end connects the client database, physical locations, corporate maintenance, and reporting. A user interface stores and retrieves data on a SQL Server.

An administrative interface allows for access to and maintenance of the system. An administrative user interface provides maintenance functions to include updating product and service recommendations, logic, forms and surveys, photo requirements, product usage information, images of new products, and any promotional information. Reports are generated using this interface. Local end-user security access is determined using this interface. An administrative setup system grants access to activate and/or deactivate screens based on given needs for diagnostic probes.

Security is an important feature of the invention. Security is preferably provided at various levels to protect the storage, access, and transmission of any data from retail locations to the SQL database. A security group level is administered by an administrative group. SQL is preferably used as a platform and provides necessary security controls. Local security is controlled by a staff logon/logoff and timeout procedure. Database security is controlled at the field level by a database administrator. If multiple stations are implemented and wireless connectivity is introduced then wireless security protocols are followed. Wireless security protocols may include, but are not limited to, WEP, SSID Broadcast limitation and MAC filtering. User level security is controlled by defined groups. Security is additionally defined by content definition, i.e. someone without medical access will not see any items related to a medical procedure.

The invention may be hosted on several servers. Servers may include, but are not limited to, two front-end web servers, two back-end database servers, one load balancer, and a cold failover setup at separate location.

Client profile data is required by the invention. Client data may be referenced from existing databases. Additional information may be captured by the system. Examples of required client profile data includes, client identification, client name, zip code, telephone number, gender and date of visit. Other information may be optional or required. In general, a single database houses common client profile data and data specific to each client visit. This information can be accessed by logging in to the administration interface. Preferably, no client is allowed to access this information and management access is limited by security permissions.

A skin state evaluation may be performed. Several tests of skin state are performed with various pieces of equipment. Hydration is preferably tested with a coreometer. Indication levels may be very dry, dry, or moisturized. Elasticity is preferably tested with a cutometer. Indication levels may be high, medium or low. Sebum is preferably tested with a sebumeter. Indication levels may be low, average or high. Large pores are preferably detected with a VISIA device. Indication levels may be low average or high. A VISIA device may then used to test for texture, fine lines and wrinkles, visible spots and UV damage. Indicators for UV damage may be low, average or high. Teeth whiteness is preferably tested with an easy shade device. Indication levels may be brightness, color or chroma. With any indication levels, other levels are possible.

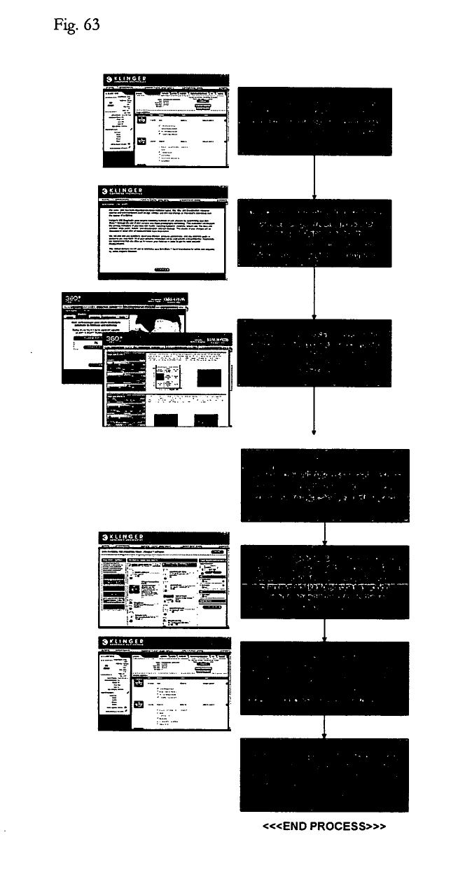

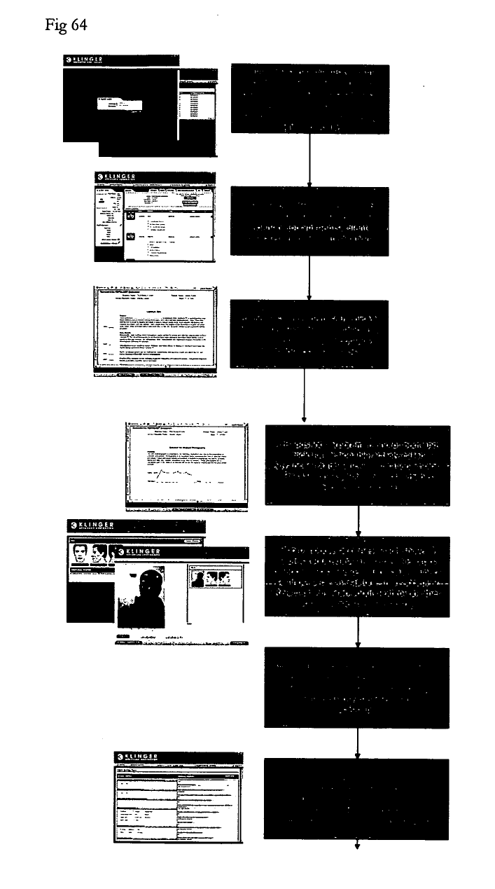

FIG. 63 shows a process for a skin state evaluation. A concierge logs into a system and searches for a client's name 1400. If the client is found, the concierge clicks on the name to advance to a client portal. If a skin state evaluation is scheduled the concierge clicks on the icon to launch an application. The application launches and shows a primer page that gives the concierge talking points 1410. The application then advances to consent forms that the client must accept before continuing. The concierge performs skin state evaluation diagnostics and advances to a results page 1420. The concierge discusses what results mean to a client and addresses any concerns. The concierge then proceeds to recommend products 1430. Working together, the concierge and the client drag and drop products the client would like to purchase. The recommend times for use are noted and may be printed out. The concierge then exits from the skin state evaluation back into the client portal 1440. The concierge clicks on a complete appointment line item to officially close out this portion of the client's itinerary. Time spent in each stage of the process is monitored. The results and recommendations are saved in a skin physical history section of the client's portal 1450. Product and treatment selections are also saved for future reference, reporting and marketing.

There are several features of the skin state evaluation. Any displayed artwork is gender specific based on inputs to the system. A profile survey captures more qualitative information about client, and helps establish a baseline of current skin care habits. The profile survey aids the concierge in the consultation after all measurements are taken. A profile survey is editable in the administration site. A suggested order of measurements is sebum, elasticity, hydration, VISIA and teeth shade. Other orders are possible. A teeth shade measurement is not required.

The determination of where a client falls on a score range is determined by peer groups. Peer group settings may be determined by age and gender alone. Other factors may include geography, skin color, and ethnicity. An example of peer group age ranges that share pertinent signs of aging, are: 18-25, 26-33, 34-41, 42-49, 50-57, 58-65, 66-73, and 74+.

COSMEDICINE™ products are weighted per each measurement by points, so that product recommendations are customized to each client. For example, a client who has a very poor score for Sebum may be recommended one cleanser, whereas someone who has a Sebum score placing them in a normal range would be recommended a milder cleanser.

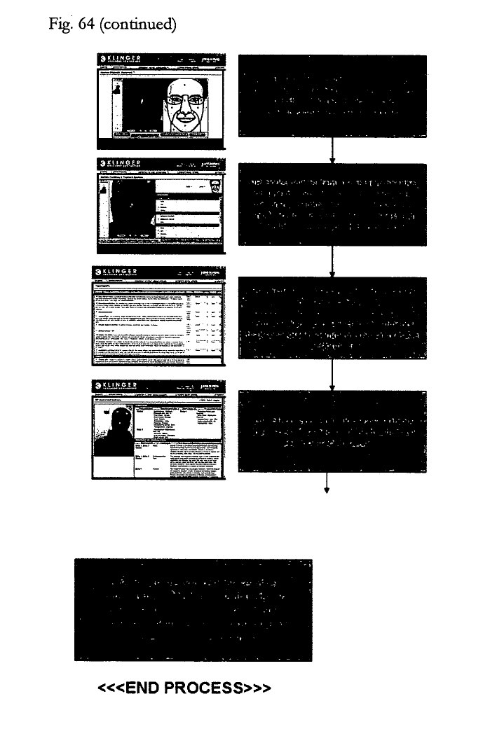

FIG. 64 shows a process for a nurse practitioner evaluation. These procedures guide a nurse practitioner's consultation with a client. A client goes to an employee at a front desk 1460. The client is searched in the system and logged in. The employee then logs into the computer system and searches for the client by name or daily schedule. The employee enters the client portal to view the client itinerary and confirm appointments 1470. The client is then checked into the computer system. The employee at the front desk then has the client sign any necessary HIPAA forms 1480. A nurse practitioner is notified and takes the client to a photography room for consult photos. The nurse practitioner then logs into a program in the photography room and clicks on an actionable activity 1485. A photographic consent is required to continue. A photo module launches that shows the number of photos required for a consult 1490. The nurse practitioner clicks on photo, which auto-changes any camera settings. The nurse practitioner then clicks on capture, then accepts or rejects photos. It is possible to continue through other photos while previous photos are saving. After taking the photographs, the nurse practitioner logs out of the computer and escorts the client to a treatment room where a consult will be performed 1500. A medical history review is then actionable. The nurse practitioner reviews medical history with the client to make note of any changes 1510. If this is the first encounter with the client, the medical history must be completed at this time. After finishing the medical history review, the nurse practitioner returns to the itinerary where the next activity is actionable 1515. The nurse practitioner clicks on an advanced diagnostic consultation 1520. The nurse practitioner, with the assistance of the client, identifies areas of concern and specific issues with those areas of concern. The issues and the severity of the issues together generate service recommendations 1530. The nurse practitioner, working with the client, selects treatments that are recommended for the client. The client is given a takeaway outlining the issues identified and the treatments recommended for each zone 1540. The client may be booked for service immediately if the nurse practitioner has availability or for service in the future 1550. The recommendations and photos are saved to the client's file.

A zonal mask divides the face or body region of interest into a specific number of areas. Preferably, a face is split into nine issue-specific areas. One or more areas of concern may be selected from an interactive mask image shown next to the client's photograph.

The zones selected then load showing the potential issues that can occur in the specific zone. The options are tailored to capture if the condition exists and the severity of the condition. Each condition and severity is preferably tied to a suite of product and service recommendations. For example, a mild forehead wrinkle may have a retinoid and a chemical peel recommended as a treatment, whereas a moderate to severe wrinkle would also include Botox® among the recommendations. The nurse practitioner assessment builds on knowledge gained through the skin state evaluation. The nurse practitioner is shown aesthetic concerns identified by the client in the profile survey.

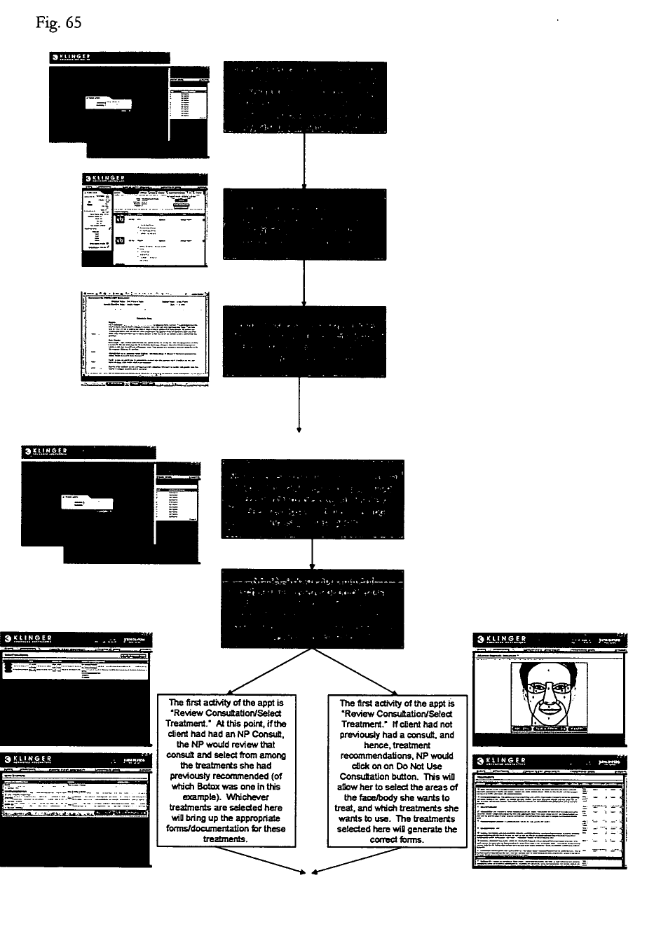

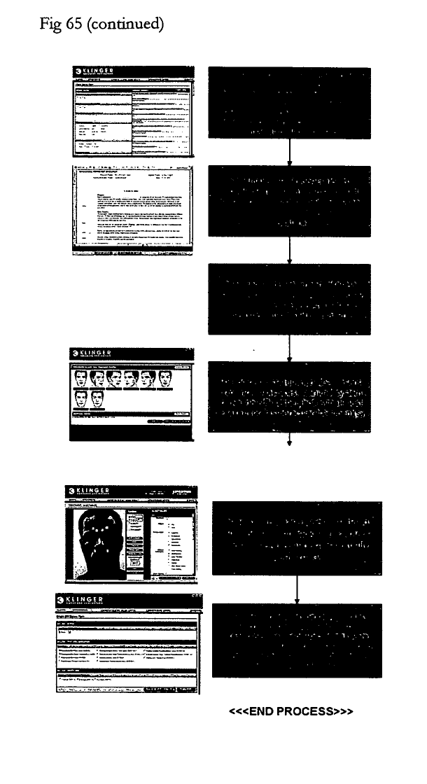

FIG. 65 shows a process for treatment documentation. A client goes to an employee at a front desk 1560. The client is searched in the system and logged in. The employee then logs into the computer system ad searches for the client by name or daily schedule. The employee enters the client portal to view the client itinerary and confirm appointments 1570. The client is then checked into the computer system. The employee at the front desk then has the client sign any necessary HIPAA forms 1580. A nurse practitioner retries the client and escorts them to a treatment room 1590. The nurse practitioner then logs into an application, or uses a previously logged computer, and brings up a client portal. The nurse practitioner then sees the type of treatment scheduled 1600. Despite having a schedules procedure, the nurse practitioner preferably asks the client if the scheduled treatment is the only treatment the client receives or wants that day 1610. The first activity for clients with previous treatments would be a review of a previous consult 1620. The nurse practitioner would select from previously recommended treatments. When the treatments are brought up, the correct forms are also brought up for each selected treatment. If the client did not previously have a consult, the nurse practitioner would select an option for not using consultations 1630. The nurse practitioner then selects the areas of the face or body the client wants treated and which treatments will be used. The treatments selected here preferably generate the correct forms. Once the treatments to be performed have been selected, the next step is intake 1640. The intake questions associated with the selected treatments appear on the computer. Medical history appears on the screen, which is pertinent if the client had not just completed a consult. If the intake did not generate any contradictions that would prohibit treatment, the system then loads the necessary consent forms for signature 1650. Once consents are signed, the client is escorted to the medical photo room by the nurse practitioner 1660. The client must sign a photographic consent form prior to taking pictures 1670. Then, the system shows the nurse practitioner all the photos required for a consult. Once photos have been captured, the nurse practitioner takes the client back to the treatment room where the treatments are actually performed 1680. The nurse practitioner then fills out the billing details that show how much materials were used, which areas were treated, etc. 1690. Codes are shown for check out in the computer system.

The treatment documentation is an important part of this embodiment of the invention. Dynamic logic loads treatment-specific intake questions, consent forms, required photo images, documentation fields and tools, and billing details.

Regardless of treatment scheduled, the first step is to select the treatments that will be performed. If consultation has preceded treatment, the nurse practitioner may select consultation to review and select treatments recommended as a result of consultation. If no consultation had occurred, the nurse practitioner does an in-room consultation to determine optimal treatments, select the zones containing the conditions to be treated, and select the treatments that will be performed from among the services corresponding to the zones chosen.

The treatments selected determine what forms, tool, etc. are loaded throughout the charting process. Intake surveys per each treatment selected are brought up on screen for the practitioner to go through with client.

Medical history appears on screen as well and can be edited. An edit log is stored in the administration site so that an administrator can see who updated the medical history, when this happened, and what was changed.

Intake questions can be flagged in the administration site to show popup messages to the practitioner. An administration site function is available to report when these flags appeared and whether the practitioner continued with process, particularly if a popup recommendation was to stop process.

Consent forms, in PDF format, are loaded for signature via tablet PC or other computing devices. After consent forms are signed, the client is escorted to a medical photo room where a photo consent form is signed. A photo module then opens showing all photos that are preferably taken for treatment. Artwork is gender specific. All camera settings are preset to each individual photograph. Preferable, photo resolution is high enough that area specific photos do not need to be taken. For example, to capture the “squinting” photos for a Botox® treatment, the user does not need to zoom in with the camera view in to focus only on the eye area; the resolution is high enough that the user can keep the zoom level on the full-face image.

Treatment documentation pages load after a treatment is performed.

Injectables documentation preferably has specific functionality. The system loads the client's primary photo (front full-face view) from the photos just taken. The practitioner, using facial landmarks, sets a grid upon the client's digital face; this grid captures the coordinates where the practitioner makes marks for the location of administered injectables. An injectables toolbox is shown, with only the injectables selected in the first step of the process illuminated as actionable. The practitioner clicks on an injectable tool and makes a mark on the facial photo where she just administered the treatment. A dropdown field allows the selection of the amount injected in each spot. A column captures the total amount of each injectable administered, and permits the nurse practitioner to enter details of the treatment.

Body treatments, such as laser hair removal on the body, bring up full body artwork (gender specific) as a reference to help the practitioner as she enters the details of the treatment. For lasers and photo rejuvenation, details such as number of passes, energy, and area(s) treated are captured.

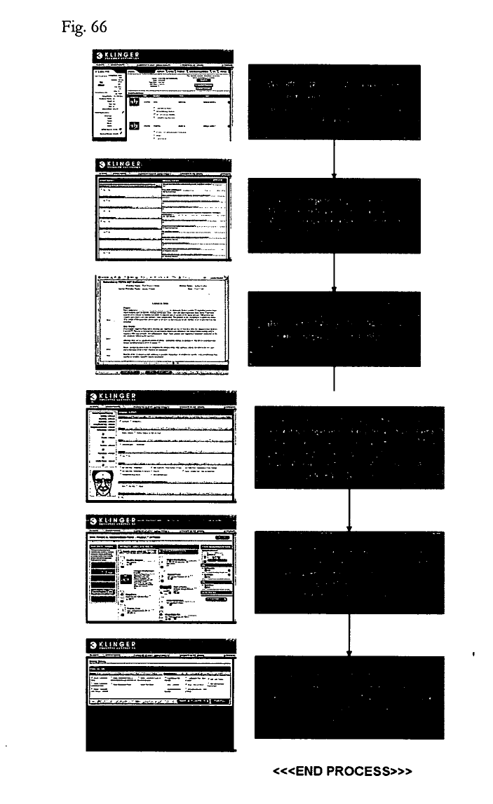

FIG. 66 shows a system for spa treatments, such as, but not limited to facials, waxing and massages. The spa treatment system is similar to the above processes, but is not dynamically generated. The process is fixed per treatment in this order: intake—treatment specific, consent form—treatment specific, treatment documentation—treatment specific, product recommendations (facials only), and billing details—treatment specific.

For the facial process, a client's skin state evaluation scores are shown on the treatment documentation page so an aesthetician has this knowledge about the client's skin prior to beginning treatment.

As with other treatments, a user or aesthetician brings up a client itinerary and clicks on the first activity of the treatment 1700. The first step is intake, where the aesthetician captures any information that may preclude treatment or alert the aesthetician to any problem areas 1710. After doing the intake, the client preferably signs a consent form 1720. After the consent is signed, the actual treatment documentation launches 1730. If the client has gone through a skin state evaluation, the images and scores are loaded to allow the aesthetician to tailor treatment. After completing the treatment and documenting what was performed, the aesthetician reviews and edits the product recommendations based on a better understanding of the client's needs 1740. Finally, the aesthetician details in the billing survey what was actually performed and any upgrades that were performed for proper billing of the client 1750.

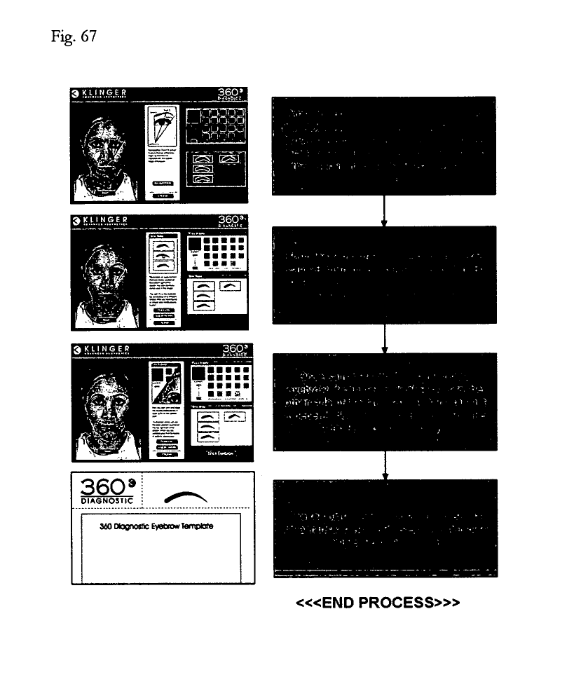

FIG. 67 shows a brow shaper process. After the client's photo is captured, the photo is loaded in the brow-shaping program 1760. The aesthetician erases the client eyebrows, and then applies the coordinates for an ideal eyebrow shape. From the templates on the screen, the user selects from among the basic shapes and the aesthetician alters the shape, color and thickness as needed 1770. Once satisfied with the shape of the eyebrow, the shape is duplicated on the opposite side of the face so the client can get a general idea of a final appearance 1780. The template may be printed out on a transparency and used as a stencil to implement this design 1790.

A mathematical algorithm is used to erase eyebrows. New eyebrow coordinates are set using mathematical ideals for symmetry. An eyebrow shape template is formatted automatically to these coordinates when selected from an eyebrow template column. The shape may be altered by moving coordinates. A color palette may be used to alter color to better match client's natural hair color.

A number of reports are preferred. All reports are preferably generated from a third party database. SQL reports are used to create virtually any type of report. Additionally, a number of report templates are designed and standardized based on input from all parties. A user ID and password are necessary to access the admin/reporting functions.

Performance metrics are measured. Examples of possible performance metrics include tracking: how long sessions take (by module, by user), number of sessions per store per day/week/month/etc., number of people that used system on certain day, MTD, YTD, etc., new versus repeat clients, top selected products and services, product recommendations to product sales, client demographics such as numbers that claim certain concerns and their corresponding scores or number that migrate from skin state evaluation to nurse practitioner assessments or treatments, average cohort score by age, skin type, ethnicity, gender, zip code, use by hours for staffing purposes, and number of clients who undergo treatment from among recommendations.

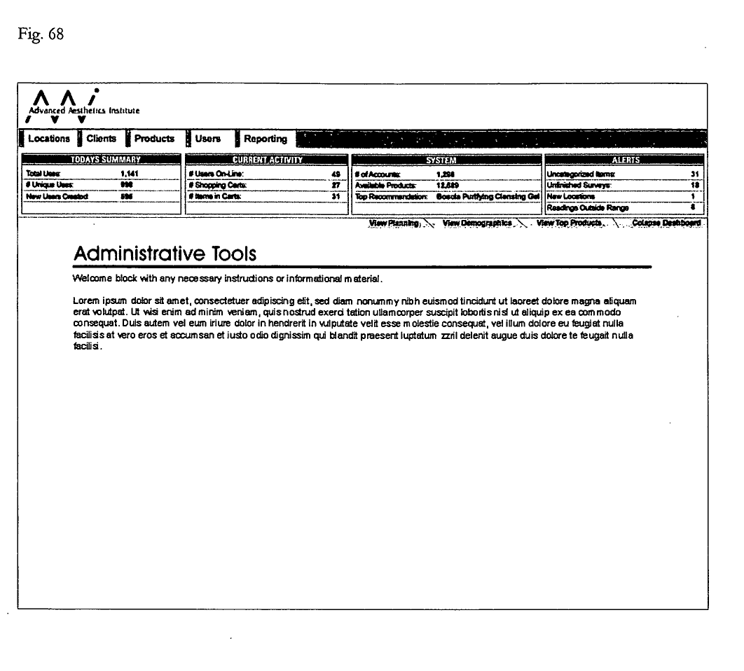

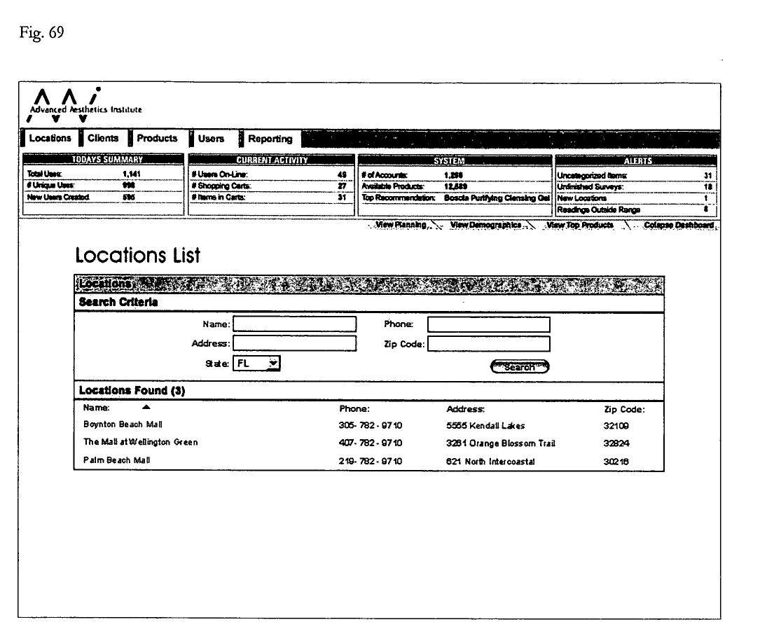

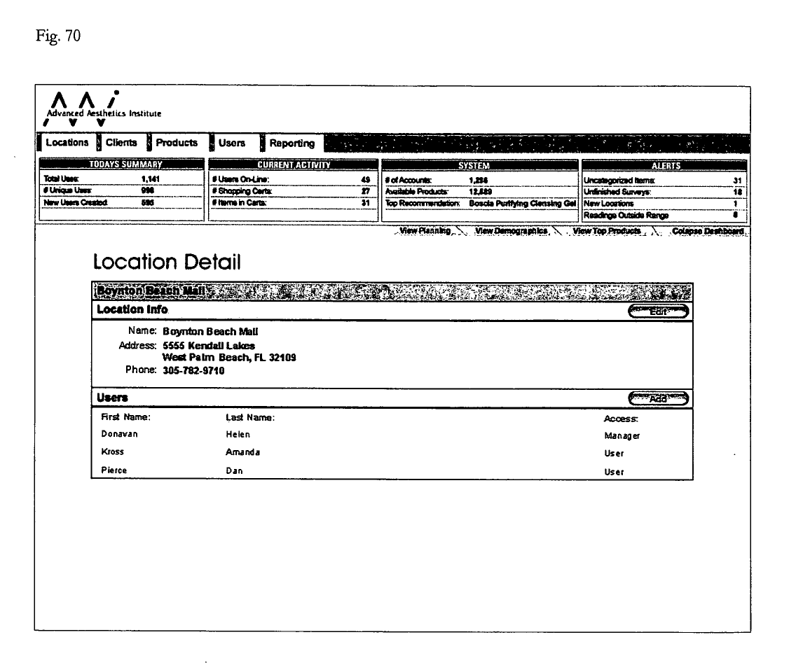

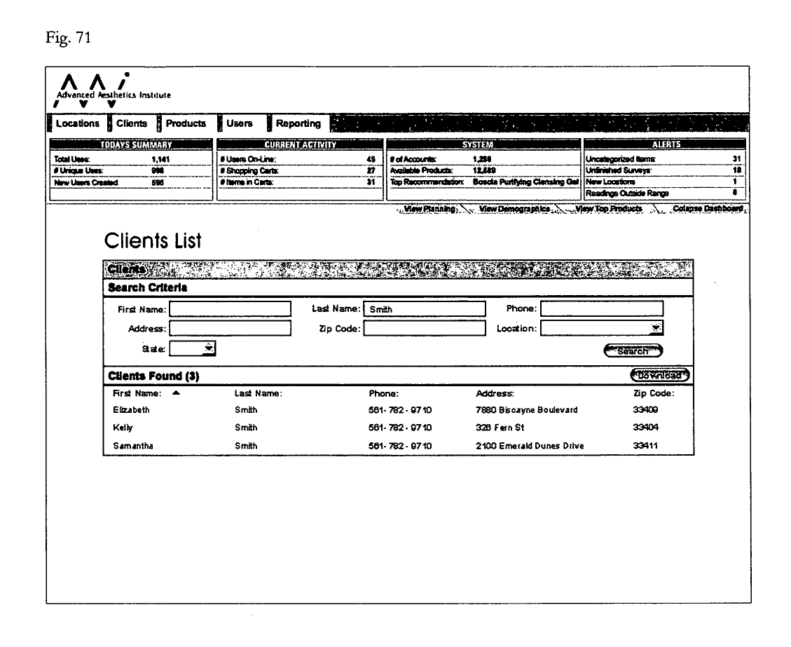

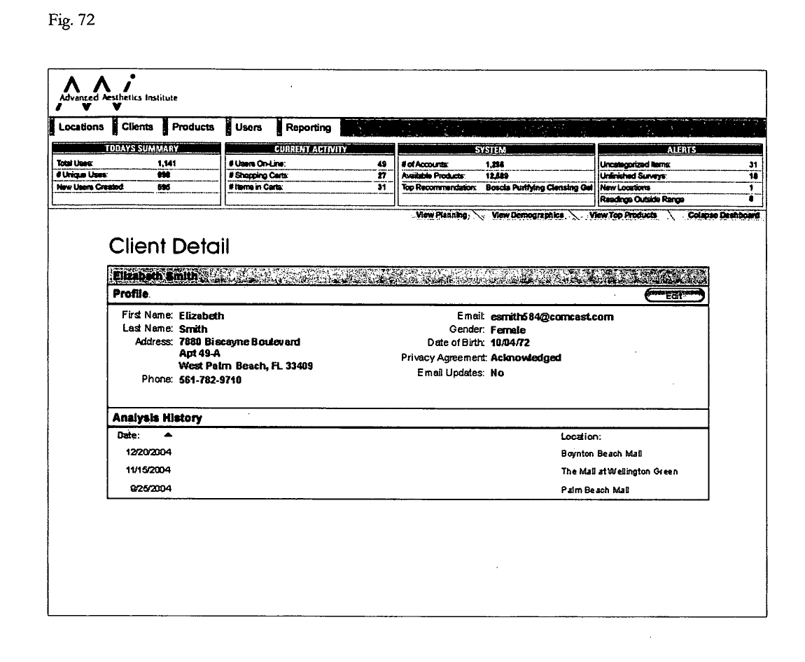

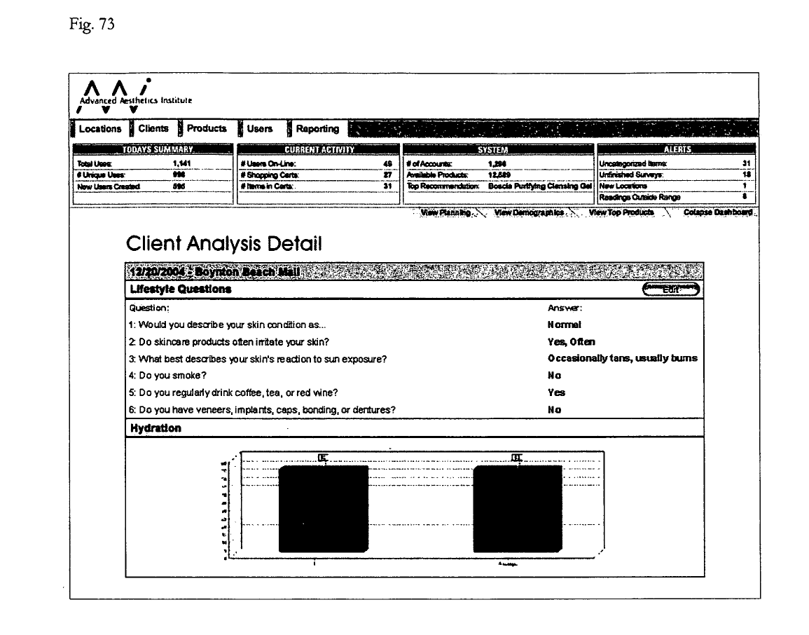

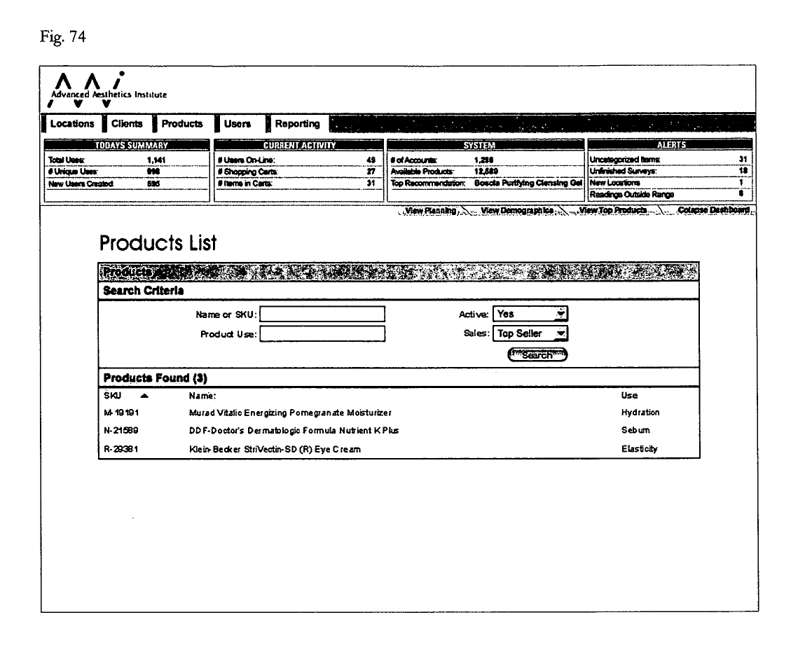

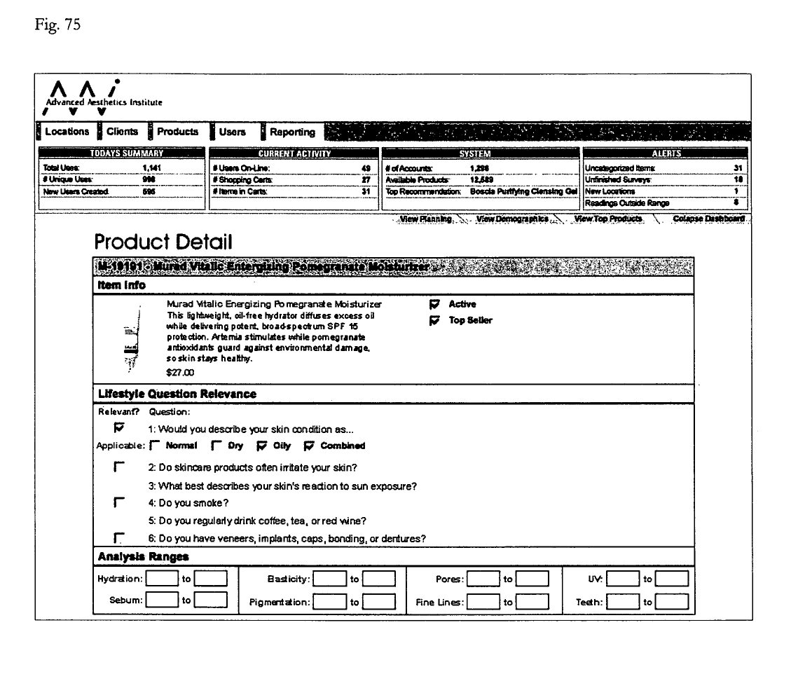

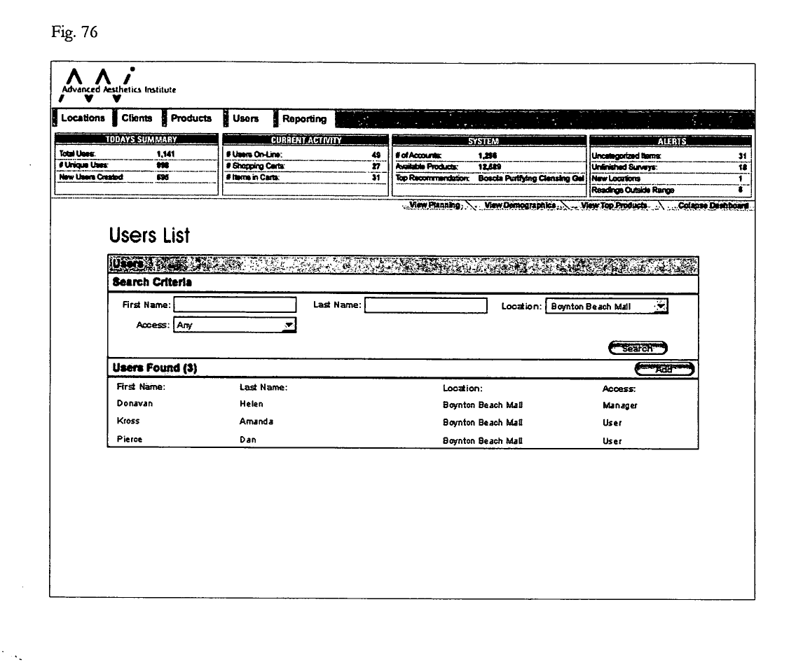

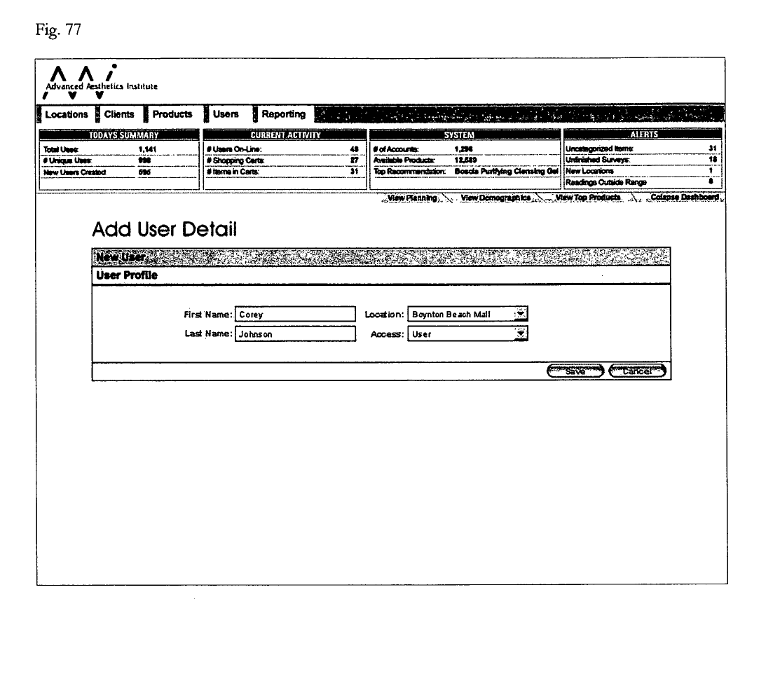

Examples of possible report functions/screenshots are shown in FIGS. 68-77. FIG. 68 shows a screenshot of an admin home screen. FIG. 69 shows a screenshot of a location search list that may include store number, district, region and state location details to search under. FIG. 70 shows a screen shot of a location detail. Details may also include store email addresses. Users may need a security profile, user ID, and user password. FIG. 71 shows a screenshot of a client search list. FIG. 72 shows a screenshot of a client detail page. FIG. 73 shows a screenshot of a client analysis detail. FIG. 74 shows a screenshot of a product search list. FIG. 75 shows a screenshot of a product detail. FIG. 76 shows a screenshot of a user search list. FIG. 77 shows a screenshot of a user detail.

Hardware may be required for the process of the invention. In general, the design of a housing reflect branding, i.e. color or a graphic overlay, and should integrate with a desired look and feel. The housing typically encompasses a computer and electronic needs for analysis hardware, i.e. probes and cameras.

For a skin state evaluation, the computer is preferably hidden or incorporated in the housing with the monitor. The screen is adjustable to accommodate being eye-level to the user. The primary input device used is a touch screen. A computer keyboard is accessible but has a small footprint. All cords are hidden from view unless in use. Printer may be shared for multiple computer stations.

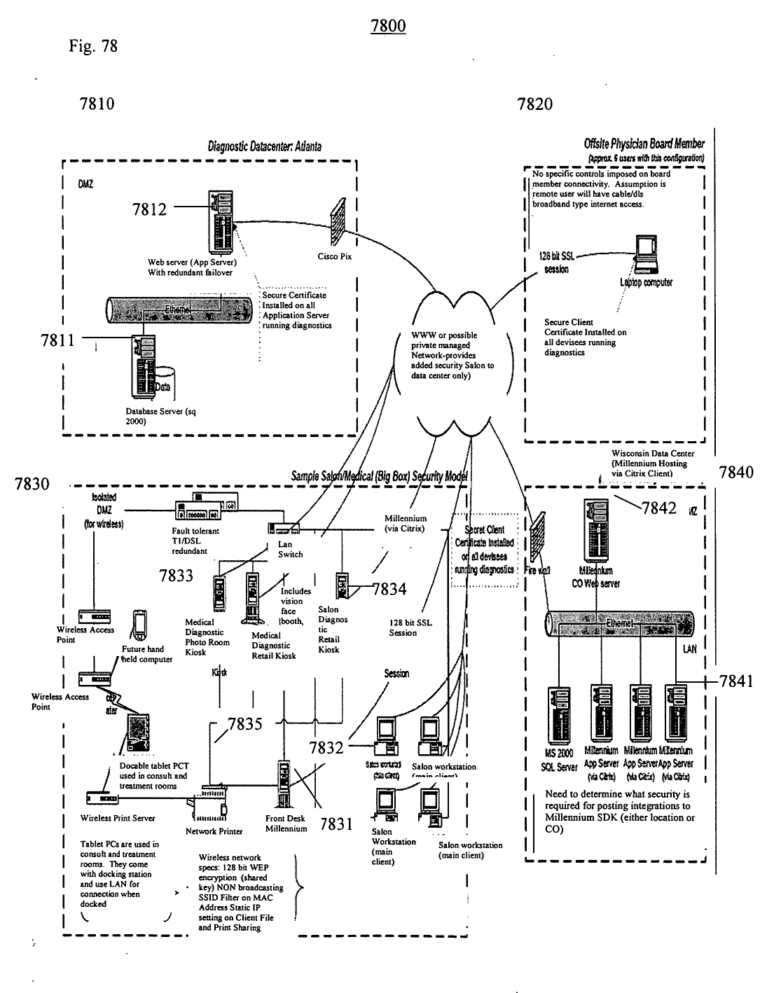

FIG. 78 shows a preferred infrastructure setup.

FIG. 78 illustrates one embodiment of the infrastructure 7800 of the invention. This embodiment includes a diagnostic center 7810, an offsite physician board member 7820, a salon 7830, and a data center 7840. Preferably, the diagnostic center 7810 includes a database server 7811 in which the data is stored and a web server 7812. Preferably, the database server is searchable with SQL software.

Preferably, the offsite board member 7820 can access any part of the infrastructure 7800. Access may be accomplished via the internet or wirelessly. Preferably, communications between the offsite board member 7820 and any other part of the infrastructure 7800 is encrypted.

Preferably, the salon 7830 includes a front desk terminal/computer 7831, multiple salon workstations 7832, medical diagnostic kiosks 7833, salon diagnostic kiosk 7834, and a printer 7835. The front desk terminal/computer 7831 is typically used by the concierge to check in the patient/client, to review the patient/client schedule, and to initiate the patient/client session. The various salon workstations 7832 are preferably monitored by salon employees and associated with particular treatment areas, e.g., facial, body scrub, etc. Preferably, when the patient/client is checked in by the concierge, the appropriate salon workstations 7832 are notified of the patient/client pending treatment. In this way, the salon employee can prepare for the treatment, e.g., locating desired creams or oils.

The medical kiosks 7833 may include, for example, a photo room kiosk and retail kiosk. Typically, photographs of the client/patient are taken in the photo room with assistance of photo room kiosk while various skin measurements appropriate for medical procedures are made in retail room with assistance of the retail kiosk. Preferably, skin measurements appropriate for salon procedures are made in a salon room with the assistance of the salon diagnostic kiosk 7834. Preferably, the salon 7830 also has a printer 7835 so that instructions product purchase and use may be printed out for the client.

The data center 7840 preferably includes several application servers 7841. In one embodiment of the invention, each server 7841 is dedicated to a particular application. In another embodiment of the invention, each server 7841 includes more than one application. In this way, if any of the severs fail, all applications are still available.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A method of providing a patient with an aesthetic improvement procedure comprising:
obtaining information from the patient regarding the aesthetic improvements desired by the patient;
performing first consultations with individual providers of aesthetic improvements for recommendations;
performing at least one second consultation with a plurality of the individual providers; and
developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another.

2. The method of claim 1, further comprising performing the recommended aesthetic improvement procedures, and assessing the outcome of the aesthetic improvements in an integrated and objective manner.

3. The method of claim 2, wherein the results of the aesthetic improvement procedure are analyzed and added to a database.

4. The method of claim 2, wherein the objective manner is a quantifiable assessment of the patient's aesthetic improvement.

5. The method of claim 2, wherein the integrated manner comprises an assessment of a plurality of methods a patient's aesthetics can be improved.

6. The method of claim 1, further comprising a concierge performing diagnostic tests on the patient.

7. The method of claim 6, wherein the concierge is a nurse practitioner.

8. The method of claim 6, wherein a database is consulted by the concierge in formulating the aesthetic improvement plan.

9. The method of claim 8, wherein the database is a dynamic database.

10. The method of claim 8, wherein the database comprises the outcome of the aesthetic improvement procedures performed on the patient in the past.

11. The method of claim 8, wherein the database comprises part of an expert system.

12. The method of claim 8, wherein the concierge consults the database through a web portal.

13. The method of claim 6, wherein the diagnostic test comprises use of digital photography, film photography, medical probe, x-ray, MRI, diagnostic skin probe, laser scan, or a mix thereof.

14. The method of claim 13, wherein the diagnostic test is digital photography and wherein the diagnostic test comprises analyzing the digital photography by use of an electronic mask that breaks a photograph into zones.

15. The method of claim 6, wherein the diagnostic test is selected from the group comprising: skin moisture testing, skin elasticity testing, skin sebum testing, skin texture testing, pore testing, fine line testing, visible spot testing, UV damage testing, or a mix thereof.

16. The method of claim 1, further comprising recommending cosmetic products for the patient.

17. The method of claim 1, further comprising recommending cosmedical products for the patient.

18. The method of claim 1, wherein the aesthetic improvement plan comprises: plastic surgery, cosmetic dermatology, cosmetic dentistry, hair styling, hair coloring, aesthetics, makeup artistry, fashion consultation, eyewear consultation, nail care, or a mixture thereof.

19. The method of claim 1, wherein the aesthetic improvement procedure comprises: hair styling, hair coloring, eyebrow shaping, eyebrow coloring, dental whitening, skin bleaching, treating wrinkles, treating age spots, foundation matching, skin abrasion, skin moisturizing, laser skin treatment or a mix thereof.

20. The method of claim 1, further comprising keeping an electronic medical record.

21. The method of claim 20, wherein the electronic medical record is HIPAA compliant.

22. The method of claim 1, wherein all of the individual providers consulted in the first consultations are consulted in the at least one second consultation.

23. A method of aesthetic improvement comprising:
obtaining patient information regarding desired aesthetic improvements;
performing first consultations with individual providers of aesthetic improvements for recommendations;
performing at least one-second consultation with a plurality of the individual providers;
developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another;
consulting an aesthetic improvement provider for recommendations;
performing diagnostic tests on the patient;
choosing at least one aesthetic improvement procedure;
performing the aesthetic improvement procedure;
assessing the results of the aesthetic improvements in an integrated and objective manner; and
adding the assessment and the results to a dynamic database, wherein the dynamic database is updated as new data is generated.

24. The method of claim 23, wherein the database comprises part of an expert system.

25. The method of claim 23, further comprising keeping an electronic medical record.

26. The method of claim 25, wherein the electronic medical record comprises standardized tables and/or documents.

27. The method of claim 23, wherein the diagnostic test comprises digital photography.

28. The method of claim 27, wherein the diagnostic test comprises analyzing the digital photography by use of an electronic mask that breaks a photograph into zones.

29. The method of claim 23, wherein a software system connected to the dynamic database updates accordingly and automatically without human intervention.

30. A method of improving the aesthetics of a patient comprising:
obtaining patient information from a patient survey;
performing first diagnostic tests on the aesthetics of the patient;
performing a first consultation with at least one individual provider of aesthetic improvement;
performing at least one second consultation with a plurality of the individual providers;
developing an aesthetic improvement plan based on the patient information and the consultations with the individual providers of aesthetic improvements, wherein individual recommendations from the individual providers are reconciled in the at least one second consultation so that recommendations in the aesthetic improvement plan are compatible with one another;
consulting a database that analyzes the results of the first diagnostic test in an integrated and objective manner;
providing at least one aesthetic improvement procedure;
performing the aesthetic improvement procedure;
performing second diagnostic tests on the aesthetics of the patient after performing the aesthetic improvement procedure;
performing a third consultation with the individual provider, the individual provider supplying an assessment of the results of the improvement procedure; and
adding the assessment and the results to a dynamic database, wherein the dynamic database is updated as new data is generated.

31. The method of claim 30, wherein the results of the second diagnostic test are analyzed and added to a database.

32. The method of claim 30, wherein the database comprises a dynamic database.

33. The method of claim 30, wherein the database comprises the results of past diagnostic tests.

34. The method of claim 30, wherein the database comprises part of an expert system.

35. The method of claim 30, wherein the database is consulted through a web portal.

36. The method of claim 30, where the database comprises the results of other patient's diagnostic tests.

37. The method of claim 36, further comprising comparing the first diagnostic test to the diagnostic test of other patient's.

38. The method of claim 30, further comprising comparing the first diagnostic test to the second diagnostic test to find if the aesthetics are improved.

39. The method of claim 30, wherein the database further comprises the patient electronic medical record.

40. The method of claim 30, wherein the diagnostic test is digital photography.

41. The method of claim 40, wherein the diagnostic test comprises analyzing the digital photography by use of an electronic mask that breaks a photograph into zones.

42. A method of improving the aesthetics of a patient comprising:
obtaining patient information from a patient survey,
performing first diagnostic tests on the aesthetics of the patient,
wherein the diagnostic tests comprises use of digital photography and medical probes,
performing a first consultation with an individual provider of aesthetic improvement, using a web portal to consult a dynamic database,
wherein the dynamic database contains the results of other patients,
wherein the dynamic database contains the patient electronic medical records,
wherein experts review the dynamic database results, and
wherein the dynamic database analyzes the results of the first diagnostic test in an integrated and objective manner by comparing the first diagnostic test to the results of other patients,
providing at least one aesthetic improvement procedure,
performing the aesthetic improvement procedure,
performing second diagnostic tests on the aesthetics of the patient after performing the aesthetic improvement procedure,
wherein the first diagnostic test and the second diagnostic test are compared to find if the aesthetics are improved,
adding the results of the second diagnostic test to the database, and
performing a second consultation with the individual provider.
